(19) United States
(12) Patent Application Publication
(10) Pub. No.: US 2014/0052490 A1
(43) Pub. Date: Feb. 20, 2014

(54) PHILANTHROPY MANAGEMENT AND METRICS SYSTEM

(71) Applicant: Newdea, Inc., Englewood, CO (US)

(72) Inventors: John Robert Barr, Louisville, CO (US); Greg Dale Klinkel, Boulder, CO (US); Gordon Shannon, Boulder, CO (US); Glenn Altemose, JR., Windsor, CO (US); Troy Stremler, Englewood, CO (US)

(73) Assignee: Newdea, Inc., Englewood, CO (US)

(21) Appl. No.: 13/947,948

(22) Filed: Jul. 22, 2013

Related U.S. Application Data
(63) Continuation of application No. 11/542,929, filed on Oct. 2, 2006, now abandoned.
(60) Provisional application No. 60/722,659, filed on Sep. 30, 2005.

(51) Int. Cl. G06Q 30/02

(52) U.S. Cl. CPC G06Q 30/0279
USPC 705/7.23

(57) ABSTRACT

Organizations, which may be charitable organizations, may plan, implement, and report to interested on the impact their projects. Users may create and modify components, which demonstrate a relationship between, for example, a donor donation, and an effect of that donation. Users can set up, modify and allowing reporting on, for example, activities sponsored by a charitable organization, inputs into that activity which may be sponsored by donors, and results of the activity. Results can be tracked over time producing a moving picture of the impact of the activity.

### CROSS REFERENCE TO RELATED APPLICATIONS

This application claims the benefit of U.S. Provisional Application No. 60/722,659, filed Sep. 30, 2005. This application is incorporated herein in its entirety. This application hereby expressly incorporates by reference, the common applicant's prior U.S. patent application Ser. No. 10/290,556, filed Nov. 8, 2002, entitled PHILANTHROPY MANAGEMENT SYSTEM AND METHODS OF USE AND DOING BUSINESS. This application expressly incorporates by reference, the common application's prior U.S. patent application Ser. No. 10/873,995, filed Jun. 21, 2004, entitled PHILANTHROPY MANAGEMENT SYSTEM AND METHODS OF USE AND DOING BUSINESS. This application also expressly incorporates by reference, the applicants' prior U.S. provisional patent application Ser. No. 60/480,190, filed Jun. 20, 2003, entitled PHILANTHROPY MANAGEMENT SYSTEM AND METHODS OF USE AND DOING BUSINESS.

### COPYRIGHT AUTHORIZATION

A portion of the disclosure of this patent document contains material which is subject to copyright protection. The copyright owner has no objection to the facsimile reproduction by any one of the patent disclosure, as it appears in the United States Patent and Trademark Office patent files or records, but otherwise reserves all copyright rights whatsoever.

### TECHNICAL FIELD

The present disclosure relates to apparatus, systems, and methods for providing access to and managing philanthropic donations, resources, and projects. More particularly, the present disclosure provides apparatus, systems, and methods for providing metrics for such donations, resources, and projects.

### BACKGROUND

Philanthropy has been essential to the advancement of society and the betterment of the human condition for hundreds of years. Many of the very finest educational, health care, and religious institutions and activities have long been the direct result of philanthropic donations and activities. The resulting institutions, services, and products not only often fulfill substantial voids that have not been, and often cannot be, met by government, but also expand the range of options and competitive alternatives to institutions, services, and products provided by the government and public activities and entities. The net result of philanthropy is not only more efficient allocation of resources in the market and society as a whole, but also substantial increases in the quality of societal morals, education, human interaction, spiritual accomplishment, and life all across society.

As industrial and other economies have evolved over the past one-hundred years and more, individuals and institutions in them have developed enormous amounts of capital that the individuals and institutions often seek to allocate and donate toward philanthropic causes. The effort involved, however, in actually making and managing donations on behalf of philanthropists or philanthropic institutions owning or controlling the capital is often a sizable, costly, and time consuming challenge. Despite the difficulties described above, the amount of funds available for philanthropic use has been growing rapidly over the past few decades.

Those individuals or entities with abundant resources for philanthropic activities may establish their own foundations to identify charitable projects and manage their philanthropic donations. Each foundation then may conduct investigations into a large number of potential recipients, such as charities, educational institutions, and religious entities, to determine who will receive donations from the foundation. Depending on the nature of the donation and the level of interest of the donors in ensuring proper use of the donated funds, the foundation may conduct its own oversight and management. Each philanthropic foundation generally might need to individually conduct these types of activities and establish customized management and accounting systems and functions. These management and accounting systems often result in substantial expense to the philanthropic foundations. This substantial effort and expense consume resources that would otherwise be available for actual philanthropic or other uses and can delay the disbursement of resources to recipients. The effort involved in identifying potential philanthropic projects reduces the ability of donors to learn of all the philanthropic projects in which the donors might be interested.

For those individuals or entities seeking to engage in philanthropic activities without the use of a foundation, the challenges are often even greater. These challenges can greatly reduce both the quantity and the quality of philanthropic activities. Despite tools and features described in prior systems, charitable foundations, both large and small, generally have not provided a real-time reporting process whereby charities can set up a reporting process to determine how well various projects are meeting charitable and/or donor goals. Such systems also have not provided secure communications, which could be used by qualified users to update progress, such as milestones, towards such charitable goals. Similarly, prior systems have not provided a centralized meeting place for those with interest in a charity or a charitable project to review the goals of a project, and up-to-date milestones achieved towards meeting those goals.

Furthermore, prior systems have not provided a way for charities and the like to provide a methodical process for project management that will, for example, be of use in determining what resources are available for a specific goal or goals, and how such resources can be utilized to reach the goal. Such systems have also not provided a methodical way to break down goals into short-term, medium-term, and long term outcomes, which can be used to determine, and to report on progress towards a goal or goals. Similarly, existing systems have not provided a way for the project information to be easily gathered and presented in a report format to be presented to donors or potential donors.

Moreover, as there is no overall goal structure, it is difficult for donor to evaluate the relative effectiveness of a given charitable project, especially with respect to other projects without much work on the donor's part. Additionally, as there is no centralized location for multiple charities each with potentially multiple projects and goals, there is no simple way for a donor to go to one location and there evaluate many charities based on actual progress toward actual goals. Additionally, even if such information could be gathered, it is currently difficult to present the information in an appropriate setting.

The problems described are merely representative of problems that may be solved by some and not necessarily all embodiments described herein, and other problems not discussed, in interests of brevity, may also be addressed by described embodiments.

### SUMMARY

The present disclosure provides apparatus, systems, and methods for managing and/or assessing philanthropic activities. In one aspect, the present disclosure provides systems and methods for managing or reporting the status or needs of one or more charitable or philanthropic projects or portfolios of such projects. In certain embodiments, status or needs can be tracked over particular time periods, which can be further subdivided, such as into various milestones. Tracking of status and needs can be used to chart the progress of philanthropic projects towards a goal. In certain embodiments, tracking can be used by a philanthropic organization to manage for results, track efficiency, manage resources, develop strategies, provide a vision of why a particular project exists, show a cause and effect relationship between funding and results, and provide accountability reports to donors. In some embodiments, tracking can be used by donors to evaluate the efficacy of their donations and help the donors evaluate potential projects the donor may wish to fund.

In certain embodiments, the present disclosure provides a system for assessing or qualifying philanthropic projects and organizations according to one or more criteria. In certain embodiments, criteria can be the value of metrics (measurements of various values associated with a project or program). In certain embodiments, the qualified projects and organizations are then searchable or otherwise accessible to users through other management and/or reporting functions in the system. In some embodiments, the qualified projects and organizations are also accessible through managing and reporting functions.

In certain embodiments, metrics can be created which allow an organization to initially create a unified charitable plan, the Impact Reporting Process, or IRP, which will allow donors to see the impact their gift will have not only upon completion of the charitable project, but as the project is ongoing. This is performed, at least in part, in certain embodiments, by allowing a charity to determine activities which will lead to the desired goal. For example, in certain embodiments, if a goal is to increase literacy in a community, an activity may be “teach 25 adults basic literacy.” Setting up activities separately allows, for example, a specific gift to be used to fund a specific activity, and for that activity to be separately tracked.

Metrics may be implemented in a hierarchical manner such that their underlying components, about which the metrics report, can be connected into “results chains”, with lower order metrics associated with higher order metrics to show, and report on, their cause and effect relationship, in some embodiments. As an example, a project may have inputs—the lowest level of the hierarchy. These inputs themselves may implement activities, which may have outputs. Outputs, in turn can create outcomes, and ultimately impacts—the highest level. A metric used for an item in the hierarchy may, thus, be tied to all of the family members, allowing reports and the like to be generated. Such reports may show the progress toward ultimate goals (which may be impacts).

In some embodiments, other hierarchical groupings can be created, such as activity groups, which can be used to, among other things, to group, view, and report metrics. For example, one or more activities can be grouped together in “activity groups.” Activity groups can themselves be grouped into activity programs, allowing for an even broader association of activities, in some embodiments.

This allows, among other benefits, for specific money given for an activity to be tracked to results associated with that activity, in some embodiments. Results (which can be referred to as a “results node”) and which may be outputs, outcomes, and/or impacts, can be recorded at defined times, in some embodiments. Milestones can be created for the results, such that if the milestones fall outside a specified range, special alerts are activated indicating that results greater or poorer than expected have been achieved, in some embodiments. If, for example, similar activities in different locations are grouped into an activity group, then information can be gathered easily which allows the impact of the activity at various locations to be determined, in some embodiments.

Inputs can be associated with activities in some embodiments. For example, if an activity is “vaccinate 5000 children against polio”, several vaccinators (inputs) will most likely be required. Furthermore, the vaccination itself can be acquired (another input), as well as vehicles to drive the vaccinators (another input), as well as community contacts to locate the unvaccinated children (yet another input). These inputs can be created and associated with the activity, allowing a charitable organization to determine the requirements (monetary, etc) for a given activity, allowing the organization to track how many requirements have been funded, and allowing the organization to provide specific reports to donors, potential donors, etc., detailing how donor's money has been or will be spent, in some embodiments.

Furthermore, metrics associated with indicators (e.g., outputs, outcomes, and impacts) can be used to allow an individual donor to determine the impact their donation had, in some embodiments. If the short-term result is “increasing the overall vaccination rate in the targeted area by 10%” with a medium-term goal of “decreasing the cases of polio by 10%” and a long-term goal of “zero polio cases” the actual results as embodied in metrics (percentage of children vaccinated, number of cases of polio, and so forth) can be tied through a given activity to the inputs funded by a specific donor, in some embodiments. Thus, in some embodiments, an individual donor who, for example, provided a vehicle for the vaccinators, (an input) can receive a report which reveals the activities funded, and the actual results obtained as a result of the input.

As mentioned, components (which may be activities) may associated with one or more results (e.g., outcomes, outputs, or impacts), in some embodiments. The results can have one or more metrics associated with them. If desired, each result can be associated with one or more indicators. These indicators may have values (a metric) associated with them. The indicators can provide measures for evaluating the result. These indicators may be qualitative or quantitative. Metrics associated with, for example, components, results, inputs, simple indicators, and indicators (items) may be associated with predefined templates (which can be stored and accessed through a library), to aid philanthropic organizations in working with the system, in some embodiments. However, in certain embodiments, items may also be defined ad hoc, so that the items can be tailored to the specific needs of a particular organization (or subunit thereof).

In some embodiments, metrics associated with items may be associated with a number of descriptive features. For example, a description may be provided to summarize the nature of the metric, result, or indicator. If desired, one or more time periods can be defined over which the metric, result, or indicator is valid. To aid in report generation, a project type may be associated with a particular measure, in some embodiments. One or more metrics, or components thereof, may be associated with one or more organizational units, such as an organization, group, team, or project, in some embodiments. In certain embodiments, he metric or component may be valid for all or a portion of the organizational units at a particular level.

Disclosed donor management systems are described which allow for the creation, management, and reporting of metrics, in some embodiments. In some embodiments, the donor management system can allow organizations to enter recorded values that are reflective of a particular measure at a particular date. Predetermined goals, such as milestones, can be created or recorded for one or more periods, such as a time period. The recorded values can be compared to predetermined goals, including milestones, in some embodiments. In some embodiments, if a recorded value falls outside of a given range for a specific metric or grouping of metrics, an alarm can be set to identify the value. This alarm may be in the form of an icon associated with a component, a message that appears in a report associated with the component, and so forth, in some embodiments.

In certain embodiments, metrics and items associated with metrics may be subject to an approval process. Changes made before or after the approval process may be subject to identical or differing limitations or requirements. For example, changes may require approval or be subject to an audit process, which, in certain implementations, is viewable by potential interested parties, such as donors, in some embodiments. In other embodiments, the audit trail is not viewable by interested parties but may be viewable by another user of the donor management system, such as an authorized user associated with a particular organizational unit.

Certain embodiments of disclosed donor management systems allow users, such as donors or philanthropic organizations, to generate one or more reports. Reports may be generated that provide detailed or summary views of metrics associated with a particular organization, group, team, or project, in some embodiments. In some embodiments, the reports are able to compute totals from sub-metrics. In addition to reports based on one or more particular organizational units, reports may be generated based on other criteria, such as a particular project type, time period, metric, or metric component, in some embodiments.

It should be noted that many features of the present disclosure can have applicability in systems or methods outside of philanthropic activities or could be implemented in systems other than those specifically disclosed herein.

It can thus be seen that there are many aspects of the various embodiments described herein. It is therefore understood that the scope of the described embodiments is to be determined by the claims as issued and not by whether the claimed subject matter solves any particular problem or all of them, provides any particular features or all of them, or meets any particular objective or group of objectives set forth in the Background or Summary above.

In addition, there are other aspects of various embodiments. They will become apparent as the specification proceeds.

### BRIEF DESCRIPTION OF THE DRAWINGS

The preferred embodiments of the present system and methods are shown and described in connection with the attached drawings in which:

FIG. 1 is a schematic diagram of an embodiment of a donor management system that may be used to link a plurality of donors with a plurality of charitable organizations, each of which may be undertaking one or more projects;

FIG. 2 is a page for accessing a donor management over one or more networks, such as intranets or the internet;

FIG. 3 is a flowchart showing the data flow of an implementation of the data management system;

FIG. 4 is a flowchart showing data flow of an implementation of the data management system allowing a user to create and use components, inputs, and indicators and their associated metrics;

FIG. 5 is a flowchart which is a continuation of the flowchart of FIG. 4;

FIG. 6 is a flowchart which is a continuation of the flowchart of FIG. 5;

FIG. 7 is a block diagram illustrating a possible relationship between various components of the data management system;

FIG. 8 is a flowchart showing data flow of an implementation of a data management system, such as the data management system shown in FIG. 1 allowing a user to input simple indicators and their corresponding metrics, targets, milestones, and alerts;

FIG. 9 is a flowchart which is a continuation of the flowchart in FIG. 4;

FIG. 10 is a block diagram illustrating a system which can be used to track a charitable project metric using a donor management system, such as the donor management system of FIG. 1;

FIG. 11 is a flowchart illustrating a method which can be used to track a charitable project metric using a donor management system, such as the donor management system of FIG. 1;

FIG. 12 is a system for using a donor management system, such as the donor management system of FIG. 1, to create and store a charitable metric, such as one associated with a component (which may be a result node result), an input, an indicator, a simple indicator, or one associated with a goal;

FIG. 13 is a method for using a donor management system, such as the donor management system of FIG. 1, to create and use a charitable metric;

FIG. 14 is an interface screen showing a startup screen for an impact reporting process, to create and store charitable metrics, such as the result node of FIG. 12;

FIG. 15 is an interface screen produced by a donor management system, such as the donor management system of FIG. 1, for listing multiple projects;

FIGS. 16A-C are block diagrams of relationships between items that can be used to track charitable projects;

FIG. 17 is a flow chart of a method to produce a results chain which can be used to show the relationship between inputs and results in a charitable project associated with a charitable project, such as the donor management system of FIG. 1;

FIG. 18 is an interface screen produced by a donor management system, such as the donor management system of FIG. 1, that allows a user to set up components, indicators, activity groups, and inputs;

FIG. 19 is a block diagram of possible components, such as the components shown in FIG. 17;

FIG. 20 is a block diagram of a component, such as the component in FIG. 19, showing the individual fields therein;

FIG. 21 is an interface screen produced by the donor management system of FIG. 3 that provides an overview of the component creation process;

FIG. 22 is an interface screen produced by a donor management system, such as the donor management system of FIG. 1, that allows a user to create a component;

FIG. 23 is an interface screen produced by a donor management system, such as the donor management system of FIG. 1, that allows a user to use a library to create a component when no library is present;

FIG. 24 is an interface screen produced by a donor management system, such as the donor management system of FIG. 1, that allows a user to view and modify impacts;

FIG. 25 is an interface screen produced by a donor management system, such as the donor management system of FIG. 1, that allows a user to view and modify activities;

FIG. 26 is an interface screen similar to the one of FIG. 25, which allows viewing of activity groups, among other activities;

FIG. 27 is an interface screen produced by the donor management system of FIG. 1 to allow a user to input details about activities which have been previously created by, for example the interface screen of FIG. 22;

FIG. 28 is an interface screen produced by a donor management system, such as the donor management system of FIG. 1, to allow a user to view details about activities which have been previously created by, for example, the interface screen of FIG. 27;

FIG. 29 an interface screen produced by a donor management system, such as the donor management system of FIG. 1, to allow a user to edit components which have been previously created by, for example, by the interface screen of FIG. 22;

FIG. 30 is an interface screen produced by a donor management system, such as the donor management system of FIG. 1, that gives an overview of activity groups;

FIG. 31 is an interface screen produced by a donor management system, such as the donor management system of FIG. 1, to allow a user to create activity groups;

FIG. 32 is a block diagram of a system to create and use indicators which extends a donor management system, such as the donor management system of FIG. 1;

FIG. 33 is a flowchart showing a method for using a donor management system, such as the donor management system of FIG. 1, to add indicators associated with various results;

FIG. 34 is an interface screen produced by a donor management system, such as the donor management system of FIG. 1, to provide an overview of the indicator creation process;

FIG. 35 is an interface screen produced by a donor management system, such as the donor management system of FIG. 1, to allow a user to create an indicator;

FIG. 36 is an interface screen produced by a donor management system, such as the donor management system of FIG. 1, to allow a user to view impacts and their associated indicators;

FIG. 37 is an interface screen produced by a donor management system, such as the donor management system of FIG. 1, to view indicator details;

FIG. 38 is an interface screen produced by a donor management system, such as the donor management system of FIG. 1, to allow a user to input details about outcomes which have been previously created by, for example, the interface screen of FIG. 22;

FIG. 39 is an interface screen produced by a donor management system, such as the donor management system of FIG. 1, to provide an overview of the input creation process;

FIG. 40 is an interface screen produced by a donor management system, such as the donor management system of FIG. 1, to allow a user to create and manage inputs;

FIG. 41 is an interface screen produced by the donor management system of FIG. 3 to allow a user to create an input and to define its attributes;

FIG. 42 is an interface screen produced by a donor management system, such as the donor management system of FIG. 1, to allow a user to add custom inputs to their impact reporting process, and to add such custom inputs to a library of inputs;

FIG. 43 is an interface screen produced by a donor management system, such as the donor management system of FIG. 1, to allow a user to access a specific input type, such as one initially created using the input screen of FIG. 40;

FIG. 44 is an interface screen produced by a donor management system, such as the donor management system of FIG. 1, to allow a user to input details about a personnel record initially accessed by the interface screen of FIG. 43;

FIG. 45 is an interface screen produced a donor management system, such as the donor management system of FIG. 1, to allow a user to view an input category overview comprising the personnel records input using the interface screen of FIG. 44;

FIG. 46 is an interface screen produced by a donor management system, such as the donor management system of FIG. 1, to allow a user to input more details about the input category record initially accessed by the interface screen of FIG. 44;

FIG. 47 is an interface screen produced by a donor management system, such as the donor management system of FIG. 1, to allow a user to view details of an input category list including information about the personnel records input using the interface screens of FIG. 44 and FIG. 46;

FIG. 48 is an interface screen produced by a donor management system, such as the donor management system of FIG. 1, to allow a user to associate activity programs with activity groups, such as activity groups created using the interface screen of FIG. 31;

FIG. 49 is an interface screen produced by a donor management system, such as the donor management system of FIG. 1, that is an alternate method to allow a user to record values for indicators, such as those created using the input screen of FIG. 35;

FIG. 50 is an interface screen produced by a donor management system, such as the donor management system of FIG. 1, to allow a user to display summary budget details by activity group such as those created using the interface screen of FIG. 31;

FIG. 51 is an alternate interface screen produced by a donor management system, such as the donor management system of FIG. 1, to allow a user to create a new output;

FIG. 52 is an alternate interface screen produced by a donor management system, such as the donor management system of FIG. 1, to allow a user to tie an output, such as one created by the interface screen of FIG. 51 to an indicator, such as an indicator created by the interface screen of FIG. 35;

FIG. 53 is an interface screen produced by a donor management system, such as the donor management system of FIG. 1, which gives an overview of a process used for reporting on metrics;

FIG. 54 is an interface screen produced by a donor management system such as the donor management system of FIG. 1, which allows a user to produce a report on metrics and other information associated with a charitable project;

FIG. 55 is an interface screen produced by a donor management system such as the donor management system of FIG. 1, which allows a user to preview a report, such as the report generated using the input screen of FIG. 54;

FIG. 56 is an interface overview screen produced by a donor management system such as the donor management system of FIG. 1, which gives an overview of simple indicator creation and use process;

FIG. 57 is an interface overview screen produced by a donor management system such as the donor management system of FIG. 1, which is a continuation of the simple indicator overview screen of FIG. 56;

FIG. 58 is an interface screen produced by a donor management system such as the donor management system of FIG. 1, which reveals details (such as the values) of a simple indicator; and

FIG. 59 is an interface screen produced by a donor management system such as the donor management system of FIG. 1, which allows a user to update the values of a simple indicator.

It is to be understood that the term “screen” as utilized in this Brief Description includes a “screen portion” for providing the described feature.

### DETAILED DESCRIPTION

In certain embodiments, the present disclosure provides methods and systems for allowing a plurality of donors to view information regarding a plurality of charitable organizations and to make a donation such charitable organizations. Donors may be, without limitation, individuals, businesses, philanthropic organizations, or wealth managers. Charitable organization, as used herein, includes, without limitation, nonprofit organizations, public charities, private foundations, private operating foundations, religious organizations, secular charities, aid organizations, health organizations, environmental groups, educational institutions, and other philanthropic organizations.

### 1. Donor Management System

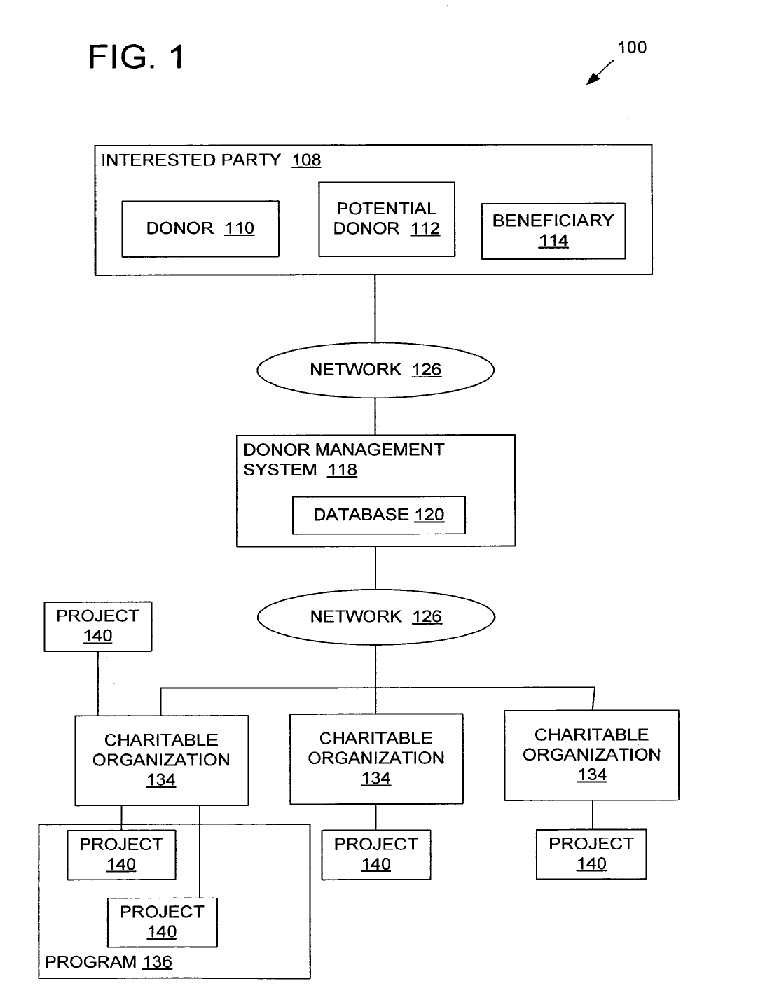

With reference to FIG. 1, a donor management system 118 allows a plurality of interested parties 108 and a plurality of charitable organizations 134 to interact using the donor management system 118. The interested party 108 may comprise one or more donors 110, potential donors 112, beneficiaries 114, businesses with interest in the charitable organization (not shown), advertisers, and so on. The donor management system 118 may have one or a plurality of components. For example, the donor managements system 118 may have a first portion (not shown) accessible to the donors 110 and a second portion (not shown) accessible to the charitable organizations 134. In this embodiment, the donor management system 118 integrates the first and second portions. In other embodiments, the donor management system 118 may be unitary in structure, accessible to both the donors 110 and the charitable organizations 134. In yet other embodiments, different interested parties 108 may have different portions of the donor management system available to them, such that certain information is blocked or allowed. Of course, certain features and/or functions of the donor management system 118 may be limited to either the donors 110 or the charitable organizations 134.

The donors 110 may be in communication with the donor management system 118, or a portion thereof, over a network 126, such as the internet. Similarly, in at least certain embodiments, the charitable organizations 134 are able to access the donor management system 118, or a portion thereof, over a network, such as the internet, which may also be the network 126. Additionally or alternatively, the charitable organizations 134 may access the donor management system 118 directly.

The donor management system 118 maintains information regarding the charitable organizations 134. This information may be stored in a database 120. Charitable organizations 134 may have one or more projects or endeavors 140 that they are undertaking and wish to obtain donations to support. A project 140 is a series of activities undertaken by a philanthropically funded organization with the intention of improving the wellbeing of the participants and/or beneficiaries of these Activities. It may be conceived of as having a “charitable goal.” These projects 140 may be associated with one charitable organization 134, or may be associated with several, charitable organizations.

Projects 140 may be grouped into programs 136. A program is a group of projects related by intent, geographic location, or ideology. Projects within a program may share features but are not required to be identical. Other groupings of charitable organization activities are also envisioned.

Charitable organizations 134 may use the donor management system 118 to input a variety of information, all or a portion of which can be displayed to the donors 110. This information may include anything related to the charitable organization 134 or its projects 140. For example, the information may include information regarding the nature of the charitable organization 134, ongoing or past activities or projects 140 of the charitable organization 134, the level of funding of the charitable organization 134 or projects 140, or financial data. In certain embodiments, the charitable organizations 134 may add or remove projects 140 from the donor management system 118 and update the information in the donor management system 118, such as providing progress reports on projects 140 and providing updated financial data.

The donors 110 may review all or a portion of the information on the charitable organizations 134 and projects 140. In certain embodiments, an interactive brochure, such as one or more web pages, for example, may be created for one or more charitable organizations 134, providing a convenient way for donors 110 to gather information about the charitable organizations 134. Similarly, in certain embodiments, the donor management system 118 presents information related to the projects 140 to the donors 110 in the form of an interactive brochure.

A set of search keys may be created for each charitable organization 134 and/or project 140. The search keys may contain a number of elements related to the charitable organization 134 or project 140. For example, the search keys may include elements such as keywords, categories, budget, secularity, location, management, media coverage, number of projects, and similar factors.

Similarly, a donor profile may be created for each donor 110. The donor profile may contain information regarding the types of charitable organizations 134 or projects 140 the donor 110 is interested in finding. For example, the donor 110 may be interested in funding a particular religious, educational, or environmental cause, such as protecting Lake Tahoe, for example. Each of the donors 110 may have a number of types of charitable organizations 134 or projects 140 they are interested in, each of these preferences may be stored in the profile of the donor 110.

Certain embodiments allow the donors 110 to find charitable organizations 134 or projects 140 of interest by searching one or more elements of the search keys. For example, a donor 110 could perform a keyword search to find matching charitable organizations 134 or charitable projects 140. Alternatively, a donor 110 could choose to sort or view all charitable organizations 134 or projects 140 within a particular category, such as all environmental charitable organizations 134 or all charitable projects 140 involving Lake Tahoe. This process may be reversed, allowing the charitable organizations 134 to locate donors 110 based on donor preferences stored in the donor profiles.

The selection process may be automated, with the donor management system 118 automatically comparing donor profiles to search keys using various schemes to provide the donors 110 with a list of the charitable organizations 134 or the projects 140 most likely to interest them or providing the charitable organization 134 with a list of the donors 110 most likely to make a donation. These searches may be updated periodically, may be updated when new information is received, may be updated when an event occurs, etc., to call recently added or modified charitable organizations 134 or projects 140 to the attention of matching donors 110, or to call recently added or updated donors 110 to the attention of the charitable organizations 134.

A donor 110 may choose to donate to a particular charitable organization 134. In certain embodiments, a donor may choose to donate to a particular project 140 of a charitable organization 134. The donation may be made directly to the charitable organization 134 or through an intermediary (not shown). The donor 110 may choose to be anonymous or make his or her identity known to the charitable organization 134. If the donor 110 desires to remain anonymous, the donation may first pass to the intermediary, who then remits the donation to the charitable organization 134. The donor management system 118 may provide the donor 110 with a donation account. The donor 110 may place funds in the donation account for storage until the donor 110 desires to donate to a charitable organization 134 or project 140. While the funds are in the donation account, they may be invested by the donor management system 118 for the benefit of the donor 110 or a third party, such as a charitable organization 134 or project 140 designated by the donor 110.

### 2—Donor Management System Platform

The disclosed donor management system 118 may be implemented on any suitable platform. For example, the donor management system 118 may be implemented on a Microsoft-centric server platform, running Windows Server 2003. The system can be built on the Microsoft ASP.NET 2.0 development platform and can supports cross-platform and dynamically compiled and optimized code. Furthermore it may be implemented, at least partially, using a computer programming language such as C#, Java, C, C++, or another programming language. In other embodiments, the donor management system 118 may be implemented on an apple-centric platform, one running Linux, or UNIX, or any other appropriate operating system platform.

The ASP.NET compiler is supported by a framework supporting a large number of objects and functions. These technologies can support rapid development and a flexible testing and deployment environment. Additionally, ASP.NET and related framework technologies can run on Linux/Unix if desired.

In this implementation, the donor management system 118 may also use a Microsoft SQL Server 2000 database. Other implementations may use a different database. SQL Server 2000 integrates with the other platform technologies and provides online transaction processing (OLTP) database functionality. The donor management system 118 may thus maintain a real-time online processing database. For more demanding online application processing (OLAP), Oracle database products can be supported by the platform via a system-wide data abstraction layer.

### 3—Donor Management System Interface Screen

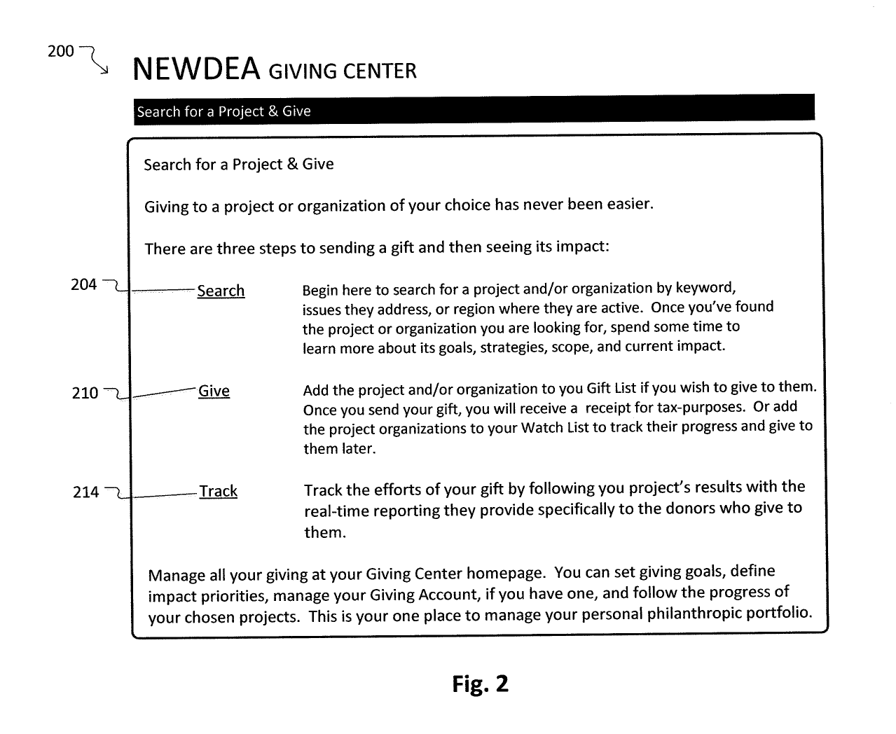

An example of an interface screen 200 of a web-based donor management system 118 is shown in FIG. 2. The interface screen 200 provides hyperlinks that bring up pages that perform various activities. For example, search links 204 allow a user to search for organizations or projects to which he or she may wish to donate. A sign up link (not shown) may be provided to allow a user to sign up for an account with the donor management system 118. A give link 210 allows the user to fund a project or organization, or to add a project to a watch list to track the project's progress. A track link 214 allows a donor to track the efforts of his or her gift using real-time reporting of, for example, metrics.

### 4—Computing Environment

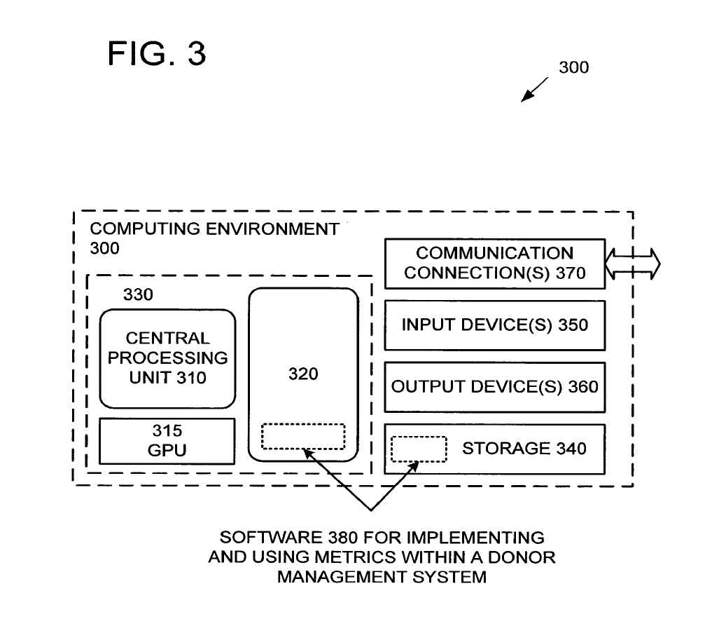

FIG. 3 and the following discussion are intended to provide a brief, general description of a computing environment in which the disclosed technology may be implemented. Although not required, the disclosed technology including the donor management system 118 (FIG. 1) is described in the general context of computer-executable instructions, such as program modules, being executed by a computer. Generally, program modules include routines, programs, objects, components, data structures, etc., that perform particular tasks or implement particular abstract data types. Moreover, the disclosed technology or portions thereof may be implemented with other computer system configurations, including mainframes, networked PC's, hand-held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

FIG. 3 illustrates a generalized example of a suitable computing environment 300 in which described embodiments may be implemented. The computing environment 300 is not intended to suggest any limitation as to scope of use or functionality of the technology, as the present technology may be implemented in diverse general-purpose or special-purpose computing environments.

With reference to FIG. 3, the computing environment 300 includes at least one central processing unit 310 and memory 320. In FIG. 3, this most basic configuration 330 is included within a dashed line. The central processing unit 310 executes computer-executable instructions and may be a real or a virtual processor. In a multi-processing system, multiple processing units execute computer-executable instructions to increase processing power and as such, multiple processors can be running simultaneously. The computing environment 300 may also include a graphics processing unit (GPU) 315, which assists in creating or speeding up graphics processing and display. Memory 320 may be volatile memory (e.g., registers, cache, RAM), non-volatile memory (e.g., ROM, EEPROM, flash memory, etc.), or some combination of the two. The memory 320 stores software 380 implementing the described methods for implementing and using metrics in a donor management system. A computing environment may have additional features. For example, the computing environment 300 includes storage 340, one or more input devices 350, one or more output devices 360, and one or more communication connections 370. An interconnection mechanism (not shown) such as a bus, a controller, or a network, interconnects the components of the computing environment 300. Operating system software (not shown) can provide an operating environment for other software executing in the computing environment 300, and coordinates activities of the components of the computing environment 300.

The storage 340 may be removable or non-removable, and includes magnetic disks, magnetic tapes or cassettes, CD-ROMs, CD-RWs, DVDs, or any other medium which can be used to store information and which can be accessed within the computing environment 300. The storage 340 stores instructions for the software 380 implementing methods for measuring quality of software modularization.

The input device(s) 350 may be a touch input device, such as a keyboard, mouse, pen, or trackball, a voice input device, a scanning device, or another device, that provides input to the computing environment 300. For audio, the input device(s) 350 may be a sound card or similar device that accepts audio input in analog or digital form, or a CD-ROM reader that provides audio samples to the computing environment 300. The output device(s) 360 may be a display, printer, speaker, CD-writer, or another device that provides output from the computing environment 300.

The communication connection(s) 370 enable communication over a communication medium to another computing entity. The communication medium conveys information such as computer-executable instructions, compressed graphics information, or other data in a modulated data signal.

Computer-readable media are any available media that can be accessed within a computing environment 300. By way of example, and not limitation, with the computing environment 300, computer-readable media include memory 320, storage 340, communication media (not shown), and combinations of any of the above.

### 5—Data Processing

Data processing for the donor management system 118 of FIG. 1 can be accomplished by a variety of schemes designed to provide a balance between performance, platform independence, development speed, ease of use, and non-programmer (designer, marketer, etc) maintainability and configuration. The system design can, if desired, seek to provide one or more among: minimal effort for creating development, test, and/or deployment environments and reducing the time required to complete such tasks; or reducing the number of human steps (and potential mistakes). In a particular embodiment, a SQL or similar database can be used for data storage and manipulation. In other embodiments, different databases are used.

### 6—Charitable Metric Flowchart

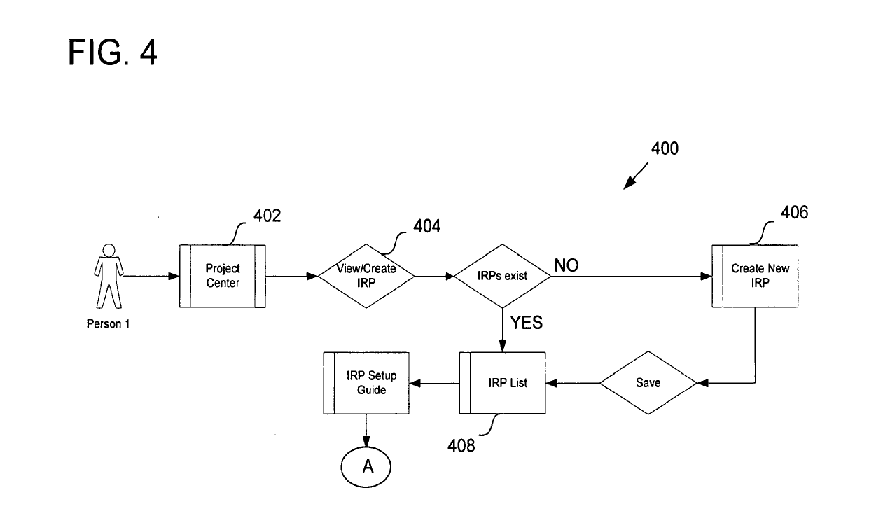

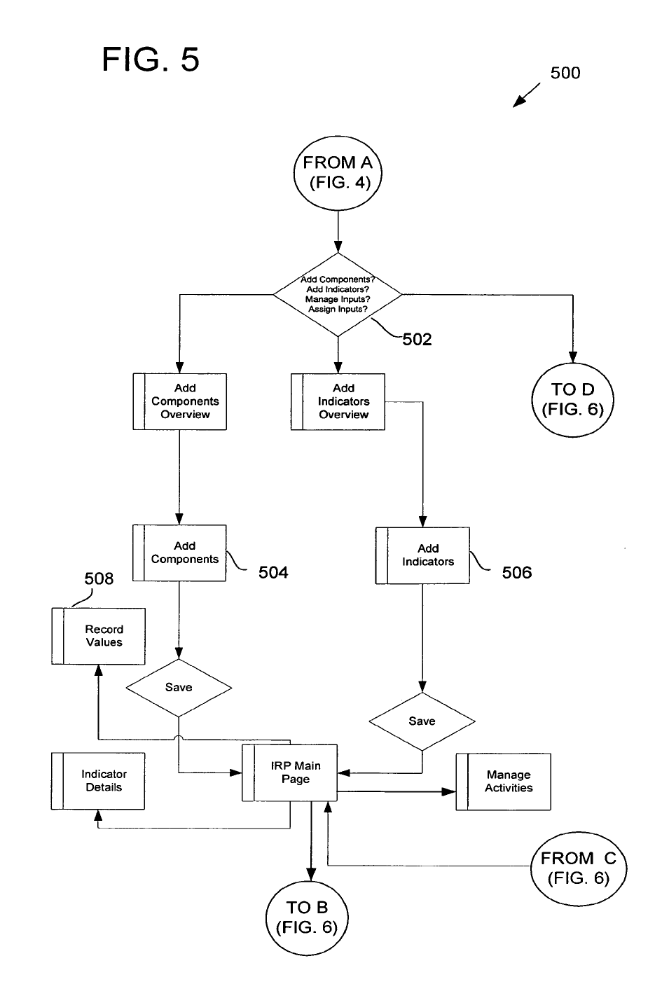

FIGS. 4, 5, and 6 shows a flowchart 400, 500, 600 (which extends over three figures) which is an embodiment that may be used for producing one or more charitable metrics used to measure progress toward a charitable goal. At 402, a user enters a project center. This project center may be associated with a donor management system, such as the donor management system 118 of FIG. 1, and may be accessed through a network, such as the internet. The project center furthermore, may be a series of web pages which require authorization (such as a password) to enter. A project can be a series of activities undertaken by a philanthropically funded organization. Projects may be thought of as having a charitable goal. Projects may be grouped into programs. A program is a group of projects related by, for example, intent, geographic location, ideology, shared donors, organizations which participate, the beneficiaries involved, and so on. A user may enter the project center 402 to set up a reporting process for a project, to modify metrics reporting on the progress toward the charitable goal, to produce or read reports reporting on the metric, and so on.

At 406, the user creates a new impact reporting process (IRP). An IRP is a software tool by with organizations (including philanthropically funded organizations) may plan, implement, and report on the impact the projects, and/or programs are having. The IRP can be set up to order components (logical groupings of cause and effect) to demonstrate such cause and effect relationship between the project activities undertaken and the ultimate impact such activities have. If there are existing IRPs, a user can display a list of the IRPs which he or she can have access to at 408.

With reference to FIG. 5, at 502, the user can choose to add features to the IRP. Such features may comprise components, indicators and so on. At 504, components can be added to the IRP. Components may have associated metrics, that is, values associated with the component. Each of these will be discussed in turn.

There are, in certain embodiments, several types of components: inputs, and activities, results (outputs, outcomes, impacts, etc). There may be other items, as well, such as, for example, indicators, and simple indicators. Inputs and activities are means of a project's implementation, while results, which may be result node results (outputs, outcomes, and impacts) are the results of the works associated with a project. Any of these components, indicators, simple indicators, etc., may have values/measurements associated with them. These values/measurements can be considered metrics.

Activities may be performed by Project/Program staff or others in conjunction with Participants/Beneficiaries to produce a desired effect leading to, for example the betterment of the lives of the Participants/Beneficiaries, the betterment of some aspect of the environment, the achievement of a political goal, and so forth. Activity components may be directly associated with results, such as the outputs they produce. One activity may be associated with multiple results. Similarly, one result may be associated with multiple activities. Inputs may be associated with Activities to determine the cost of an Activity. One activity may be associated with multiple inputs. Similarly, one input may be associated with multiple activities.

Activity-based costing can be set up using the various components using metrics reported for various items. Activity-based costing, relative to an IRP, can be thought of as denoting three things: 1) the ability to know how much each proposed activity will cost (by assigning inputs with and associated costs) 2) the ability to manage the cost of activities (Planned vs. Actual) and 3) the ability to compare the actual activity cost with the outputs produced in order to determine return on investment for an activity or activity group, a useful monitoring and evaluation tool.

Outputs can be the products—the immediate results of the implementation of activities. A single output can be associated with more than one activity, likewise, multiple outputs can be associated with a single activity.

Outcomes can be results (such as results node results) that are the implied or direct effect(s) of outputs. Outcomes can be short-term or medium-term and are often monitored by means of indicators associated with them. Outcomes are often reported to donors or other interested parties as they may represent (with outputs and impacts, for example) quantifiable results of the project/program in question. Outcomes can be thought of as answering the question: “So what?” when referring to the previously performed activities and outputs.

Impact components can be results (such as results node results) that are the implied effects of outcomes. Impacts may be thought of as long-term results relative to the short-term and medium-term results of outcomes. Impacts are also monitored by means of indicators and reported to interested parties, such as donors, as the ultimate success or failure of a project/program. Impacts can answer the question: “Why are we undertaking the Project/Program?”

At 506, indicators can be added to the IRP. An indicator may be a quantitative or qualitative measurement/value (a metric) that can be tracked as evidence for the status (success or failure) of any result, such as an output, outcome, or impact. An indicator may also be used as a qualitative or quantitative measurement of a goal. Indicators can be represented graphically as well as numerically, and can be used for internal evaluation of a Project's/Program's status. Indicators can also be selected and published in reports to interested parties. In an IRP, indicator values (which are a metric value) may be recorded at any time. In a Goals & Objectives module, values may be recorded at intervals, such as monthly, quarterly, bi-yearly, and so forth. Indicators may have interval milestones: values that are expected if the output, outcome, impact or goal is to be considered “on track”. Indicators may also have alerts: values above or below which an Alert Icon displays on the appropriate Component. Alerts do not only reflect “bad news” but can be configured to alert users when goals have been met or exceeded. In certain embodiments, indicators can be created which are not associated with a specific IRP. At 508, values or measurements (metrics) can be recorded for any of the components, indicators, or inputs.

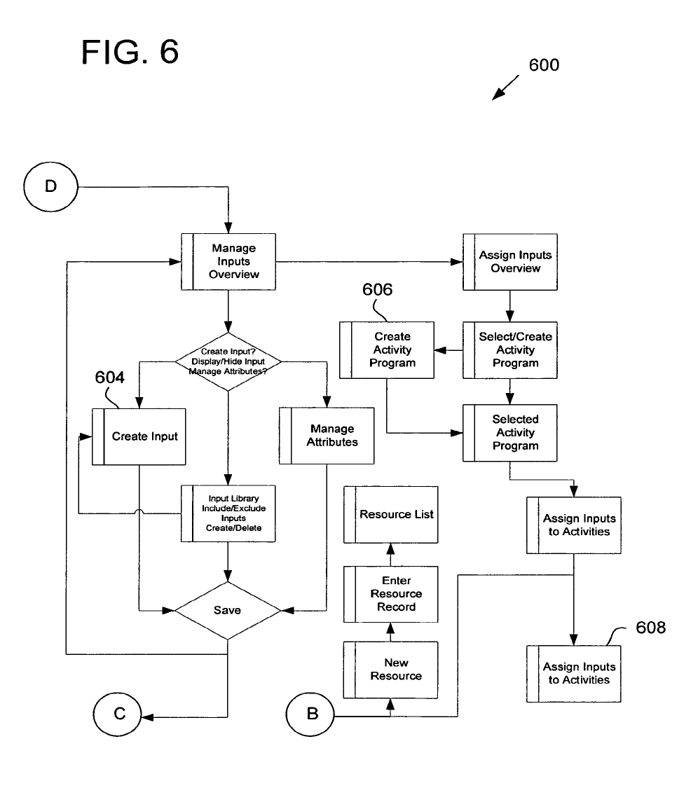

With reference to FIG. 6, at 604, an input can be created. Inputs can be components which contain information used for implementation of activities, such as Personnel, Equipment, Facilities, Materials, Partners, Budget or other areas. Inputs can be associated with a cost and assigned to activities to determine both the cost of an activity and its return on investment, in some embodiments. Inputs may be associated with more than one activity, or a single activity.

At 606, an activity program can be created. Among other uses, activity groups can be used to address the fact that in practice inputs are often assigned to more than one related activity. For example, an M.D. may be assigned to “prenatal care” as well as “birthing” in a project. To avoid placing unreal expectations on users of the system—requiring them to define how much time the M.D. spent on “prenatal care” vs. “birthing”—activities can be grouped, allowing, for example, a user to indicate with one number how much time the M.D. spent doing all activities associated with the activity group. Activity groups can also be used to address the fact that multiple activities may be associated with a single output. Moreover, activity groups can be used to group activities that will be reported on as a group. Activity groups can be added to a library, assisting to make setup of an IRP quick and easy, for example.

### 7—Metric Overview

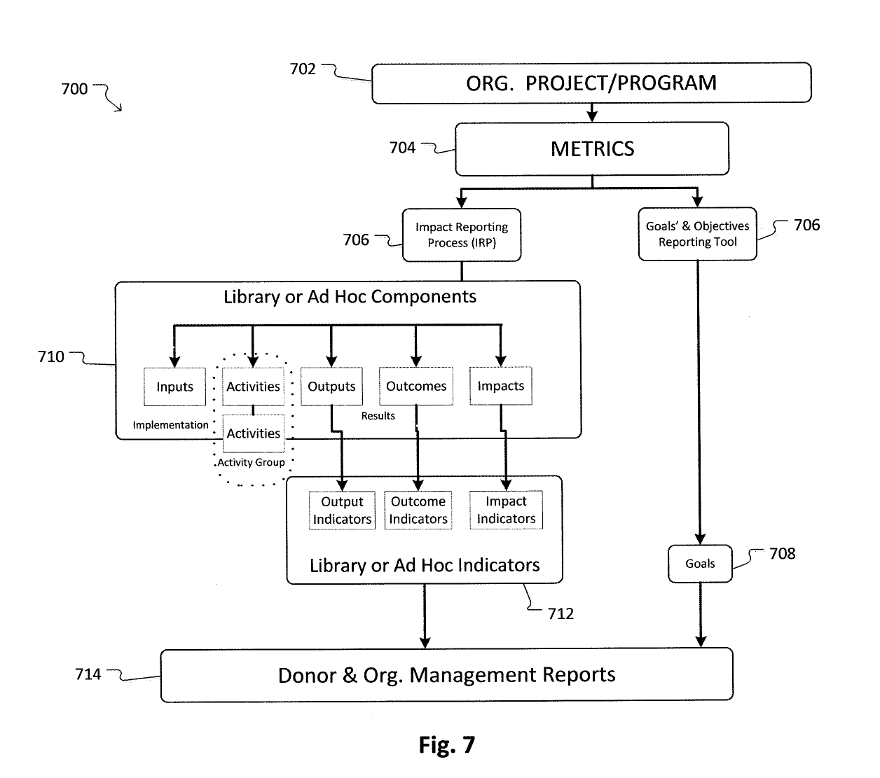

FIG. 7 shows a block diagram which shows the relationships between the various charitable metrics. The project or program 702 has a number of metrics 704 associated with it. Some of these metrics 704 may be created using the impact reporting process 706, while others may be created using the goals and objectives reporting tool 706.

The goals and objectives reporter 706 can enable users to set goals 708, enter periodic values (such as monthly or quarterly values) as evidence of progress toward these goals, report on these to interested parties, and other activities. The goals and objectives reporter 706 may not relate goals and their measurements to specific activities, outputs, etc., in certain embodiments. It may also not create a “Results Chain” in that the goals may not relate to each other causally. This less structured representation of a Project's/Program's progress may provide reports to interested parties without the additional context provided by an IRP. The measurements in the goals and objectives reporter 706 may be considered as “snapshots” or “still photographs,” for example, compared to the relationships of cause and effect implied or directly seen in the “moving pictures” of an impact reporting process, as metric values can be entered as often as desired by a program/project manager, etc.

### 8—Simple Indicator Flowchart

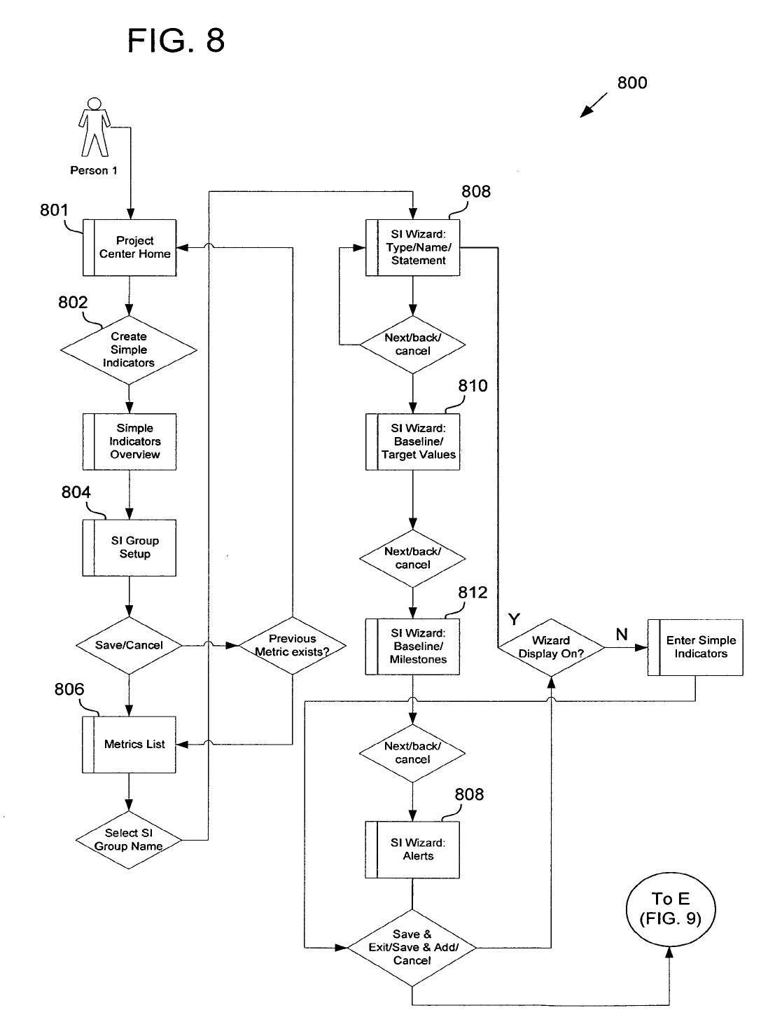

FIG. 8 shows a flowchart 800 which is an embodiment of the donor management system 118 (FIG. 1) that may be used for producing one or more simple indicators which may have metrics used to measure progress toward a charitable goal. At 801, a user accesses a project center home, which may be associated with a donor management system, such as the donor management system 118 of FIG. 1. The user may be a philanthropic organization, or an interested party, such as the interested parties 108 (FIG. 1).

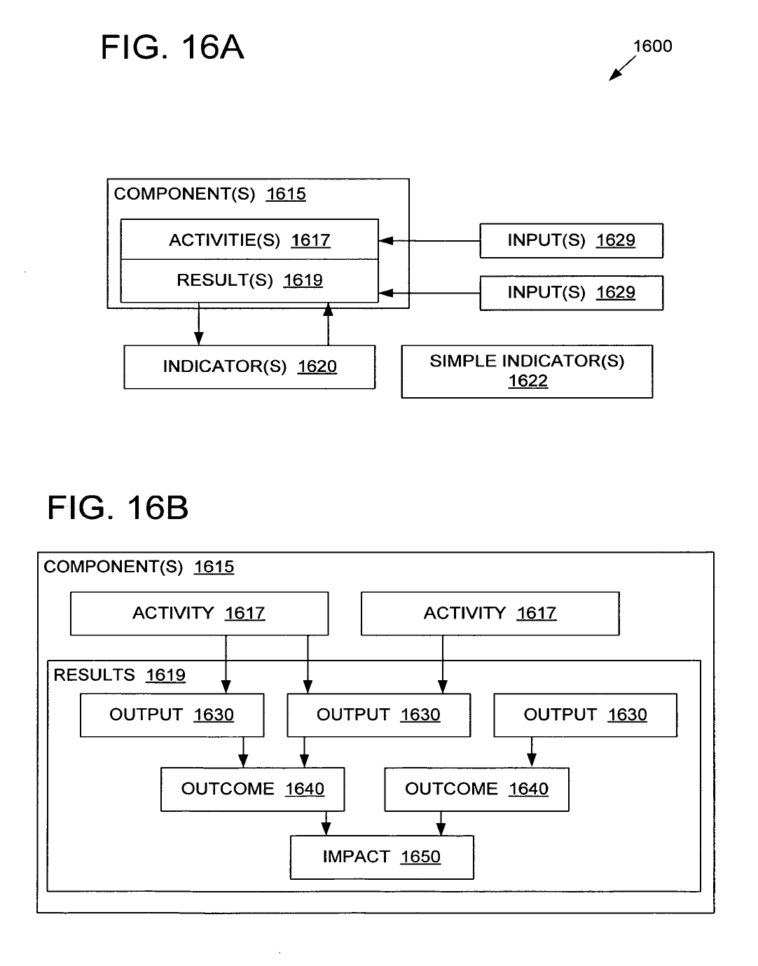

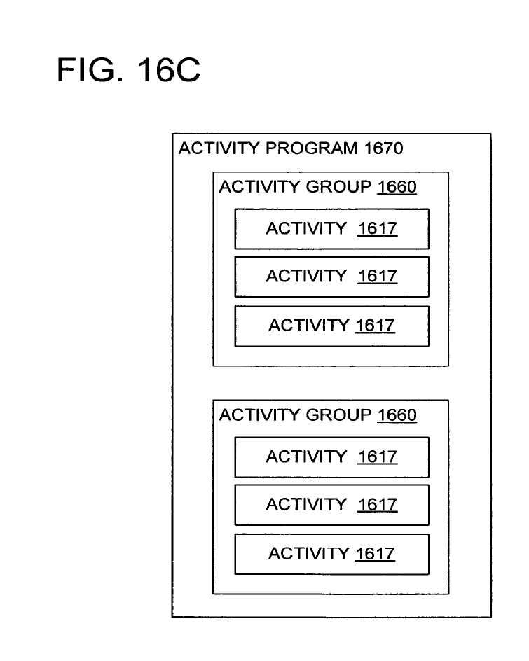

At 802 a simple indicator is created. Unlike the indicators associated with components, such as the indicator 1620 of FIG. 16, simple indicators are not otherwise associated with components. At 804, a simple indicator group can be setup. At 806, a metrics list (a list of values or measurements that can be associated with the indicator—a metric—that can be used to create reports, etc.) can be accessed. At 808, a wizard (a computer program that can assist a user to perform a task) can be accessed to assist a user in building a simple indicator. The wizard can be implemented using commercially available wizard components, or a specialized wizard can be built for an implementation. At 810, the wizard can assist the user in setting up target values for the indicator. At 812, the wizard can assist the user in setting up milestones for the indicator.

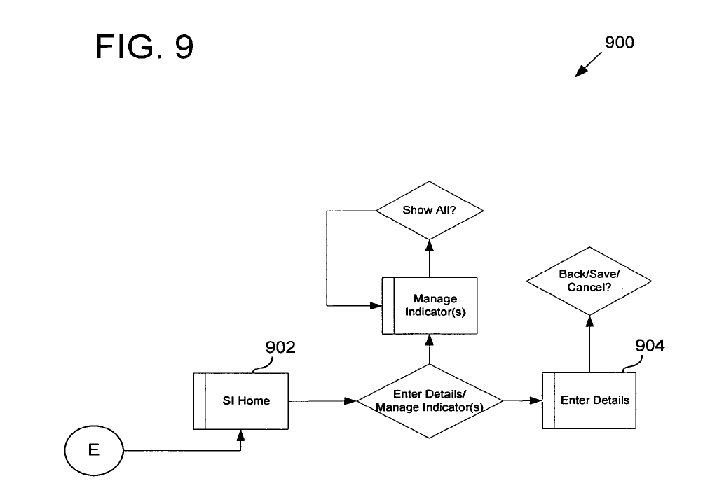

With reference to FIG. 9, at 902, the simple indicator home (which can be reached, in certain embodiments, from the project center home 801 (not shown), details about the simple indicators, such as milestone values, target values, and the like, can be entered.

### 9—Donor Management System to Track Charitable Project Metrics

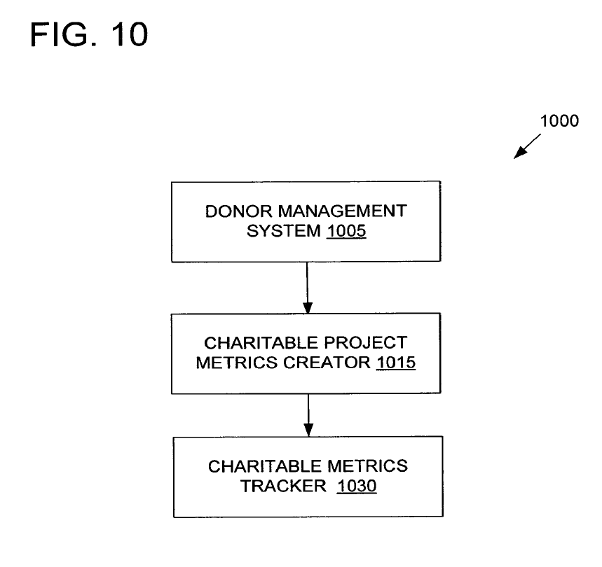

FIG. 10 shows a donor management system, such as the disclosed donor management system 118 (FIG. 1), which can be used to track charitable project metrics. A donor management system 1005 can have a charitable project metrics creator 1015 which can be used to create charitable project metrics and components, inputs, indicators, etc. associated with the charitable project. The method shown in FIGS. 4-6, and/or the method shown in FIGS. 8-9 can be used to create the charitable project metrics. The metrics may be any of the metrics shown with respect to FIG. 7, FIGS. 16A-C, or different metrics may be used. A charitable project tracker 1030 can then be used to access, modify, report on, etc, metrics associated with the charitable project to, among other things, aid users in determining how well goals for the charitable project are being met.

### 10—Donor Management Method to Track Charitable Project Metrics

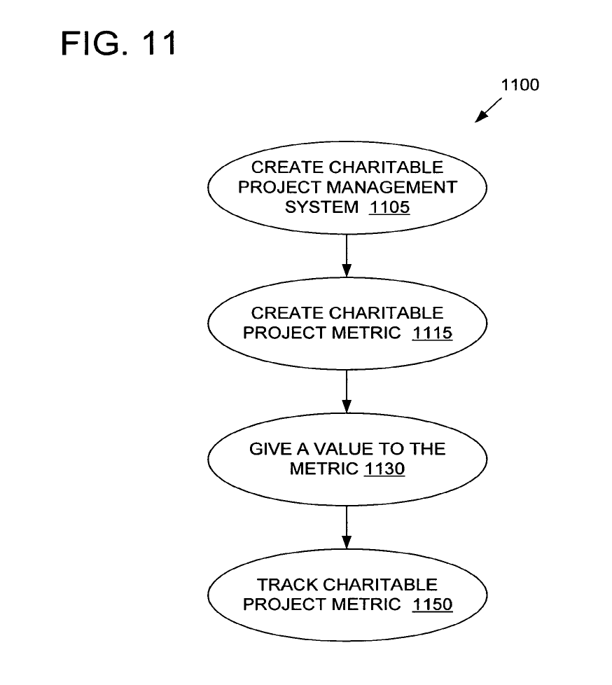

FIG. 11 shows a method which can be used to track charitable project metrics. At process block 1105, a charitable management system is created. This can be a donor management system, such as the donor management system 118 of FIG. 1. At process block 1115, a charitable project metric is created. This metric may be associated with a measurement used for measuring charitable contributions, or the effectiveness thereof. For example, any of the items discussed herein with reference to donor management systems, such as any of the components, an input, an indicator, a simple indicator, and so forth may have metrics—measurement values (such as number of teachers for a literacy project, amount of donations to date, number of children vaccinated, milestone values, target values, and so forth), associated with them. Any of these metrics may be created at this process block.

At process block 1130, a value is given to the metric. At process block 1150, the metric is tracked. This tracking may be done to produce a report, to determine the effectiveness of a charitable project, to determine the amount of donations that have been made to date, and so forth.

### 11—Donor Management System Metric Overview

In certain embodiments, the disclosed donor management system 118 provides the advantage of being able to track and report various data or metrics. For example, at least certain metrics measure the performance of a project or a portion of a project and may be compared to a predetermined objective or criteria. These metrics may be values or measurements about items such as components, indicators, inputs, simple indicators, etc, in some embodiments. Metrics can be defined and measured for various units, such as organizations, groups, teams, or projects, in some embodiments.

The measured metrics can be used by various parties for different purposes. The organization can use the metrics to track efficiency, chart progress to a goal, manage resources, and develop strategies. Metrics may also enable clients to issue public reports, or reports to all of a group of their donors, or to provide accountability to their supporters. Donors or other interested parties can use the metrics to evaluate the achievements of their philanthropy and help them determine those organizations and projects to which they will donate.

In certain embodiments, metrics may be available to donors or they may be kept private, so that only specified organizations, teams, or projects may have access to the metrics. Further, the system may include the ability to alter the level of metric access granted to differing system users.

Metrics may be implemented as a configurable multi-level results chain that provides a person or organization (collectively referred to herein as “the client”) seeking to solicit charitable contributions with a mechanism to define a clear vision of why a project, group, or organization exists, and what it intends to achieve. With defined metrics, how well stated goals are being achieved can be recorded and reported. Metrics can provide the client with a tool to help them manage for results, as well as showing cause and effect between funding and results.

The client can use metrics to create one or more multi-level results chains for any project, group, or organization of the client. The client can then record and report on its progress using, for each metric, a comparison of actual results to predetermined objectives as a measure of success.

Various types of metrics can be established. For example, metrics may be quantitative or qualitative. Quantitative metrics may include measures of how much product or service was provided by a unit. Qualitative metrics may include measures of how good or effective a product or service was.

Metrics may have one or more components. For example, a metric may be associated with one or more results. There are various types of results that can be used to evaluate a particular metric. Generally, results can be thought of, in a broad sense, as referring to outcomes that convey benefits to a community (such as offering education for everyone in the community). Additional results may be generated in reaching these outcomes, such as service outputs that make the outcomes possible. In the example of providing education for all members of a community, results include trained students and trained teachers. The term “results” is broad enough to also embrace internal outputs, such as services provided by one part of an organization for use by another. However, results can differ from ‘activities’ or ‘functions’. For example, when asking people what they produce (services) many still respond by describing what they do (activities). A feature of results is that they are quantifiable, including being measurable, monitorable, and relevant. Metrics may be organized as a configurable, multi-level results chain of results nodes. A result is the embodiment of a result within the system, such as an output, an outcome, or an impact. A different set of results may be used, in certain embodiments. A result can be implemented as one or more web pages.

### 12—System for Producing Charitable Tracking Metrics

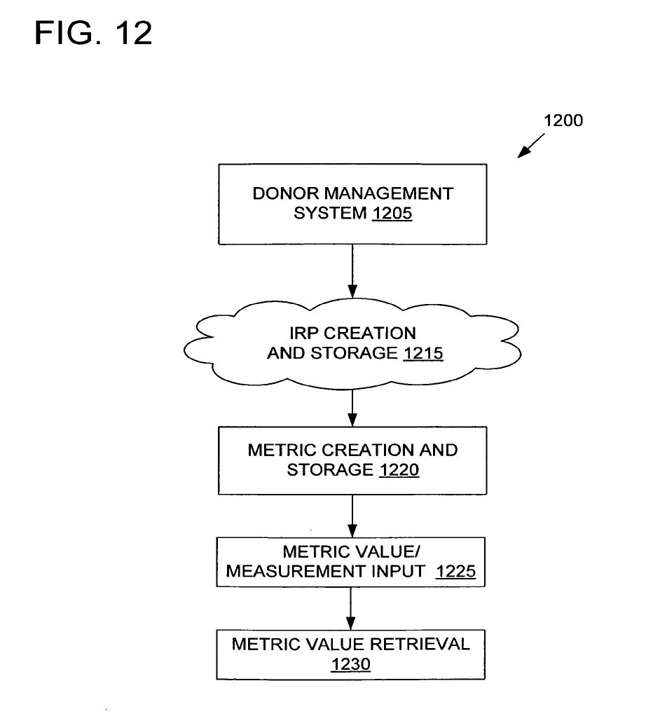

FIG. 12 shows a system 1200 for producing one or more charitable metrics used, for example, to measure progress toward a charitable goal. Metrics may also be used to determine the degree that a project is on (or off) budget, satisfaction of donors and beneficiaries with the project, and so on. A donor management system 1205, such as the donor management system 118 of FIG. 1, can have, as one of its many components, an IRP creator and storer 1215. The node creator and storer 1215 can be used to initially create items associated with tracking philanthropic projects and their metrics, such as those discussed herein. Charitable metrics 1220 can then be set up, such metrics used to track the progress of a charitable goal.

The metrics are updated 1225 with the stored, updated values kept within the donor management system 118 or within another system accessible by the donor management system 118. Charitable metrics 1220 can then be retrieved 1230 and used for graphs, reports, evaluations, etc. Any of the metrics shown in any of the sections may be associated with a particular organization, group within the organization, team within the group, or project. Furthermore, organizational units can be grouped to allow a metric or metrics to be associated with a predefined grouping of organizational units.

### 13—Method for Producing Charitable Tracking Metrics

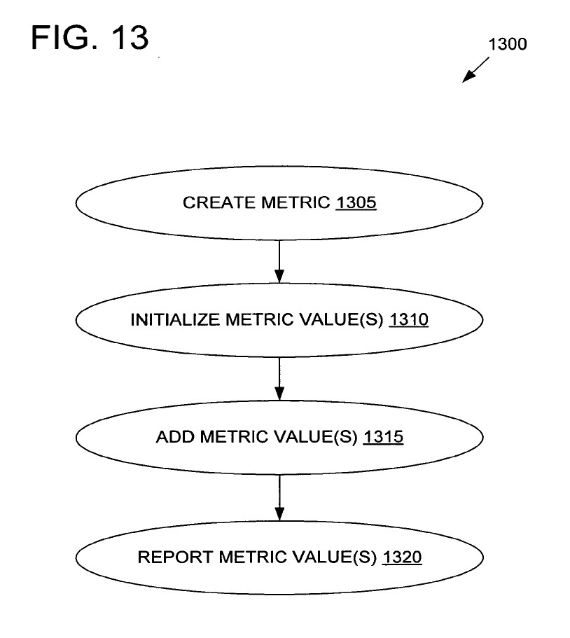

FIG. 13 shows a method 1300 for producing charitable tracking metrics. The method can be performed, for example, by the system 100 of FIG. 1. The method 1300 and any of the other methods described herein can be performed by computer-executable instructions stored on one or more computer-readable media.

At 1305, a charitable project metric is created. Any of the metrics discussed in any of the examples herein may be created. At optional process block 1310, the metric is initialized with starting values. At 1315, the metric has a value added to it. Depending on the metric, the metric may store a single value (such as the amount of money available for a project) or a series of values, such that the metric may be able to show how the metric has varied over time. Such metrics, such as indicators and results node results (such as outputs, outcomes, and impacts) and so forth, may have graphs associated with them that show how the metric value has changed over time. The storage may be in any suitable database, such as an SQL database. At 1320, the metric value or a portion thereof is reported. The report format may have a graph which charts the values of a metric over time, it may be in printed form; it may be displayed on a webpage, it may be emailed, it may be sent as a audio value to a phone, it may be posted to a community bulletin board or chat room, and so on.

### 14—Interface Screen Features

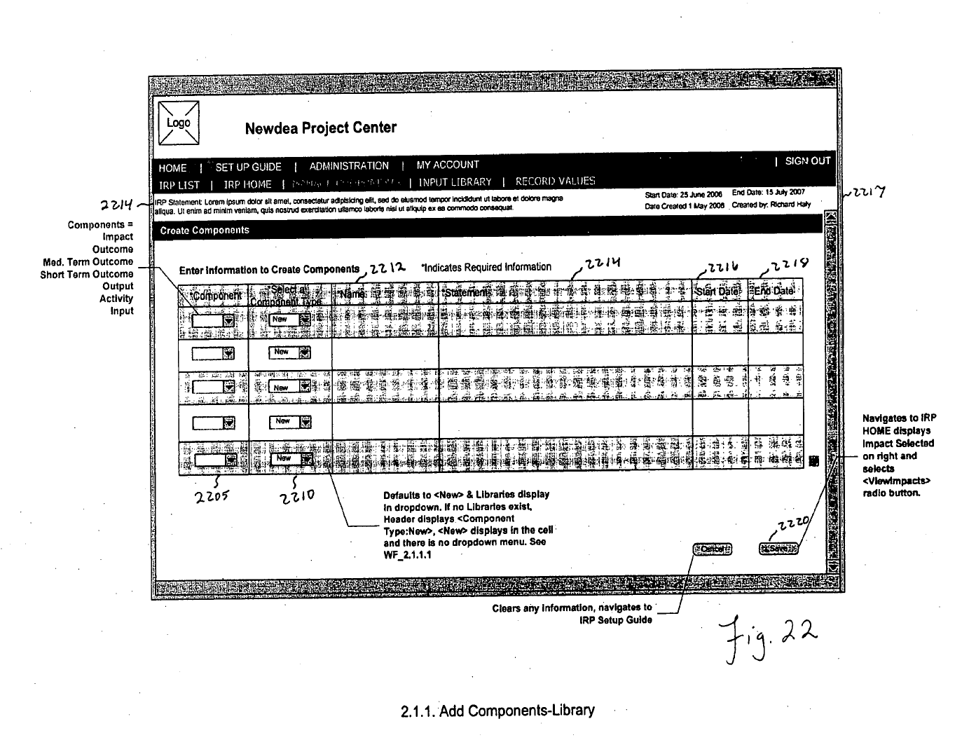

In any of the examples herein with reference to input screens, mousing over or otherwise selecting an icon such as the Medical Activities Icon 2512 shown with reference to FIG. 25, can result in a display of more information about the metric associated with that icon, such as displaying a metric statement, such as the component statement 2214, shown with reference to FIG. 22. Similarly, selecting a metric name, such as the activity group name “birthing” 2545, shown with reference to FIG. 25, can show a statement associated with that metric.

Each metric, or a group of metrics, can be limited to being modified by a single person or a group of people. In such a case, a sign-on procedure may be required (such as requiring a name and password) which identifies the person or group as allowed.

### 15—Startup Screen

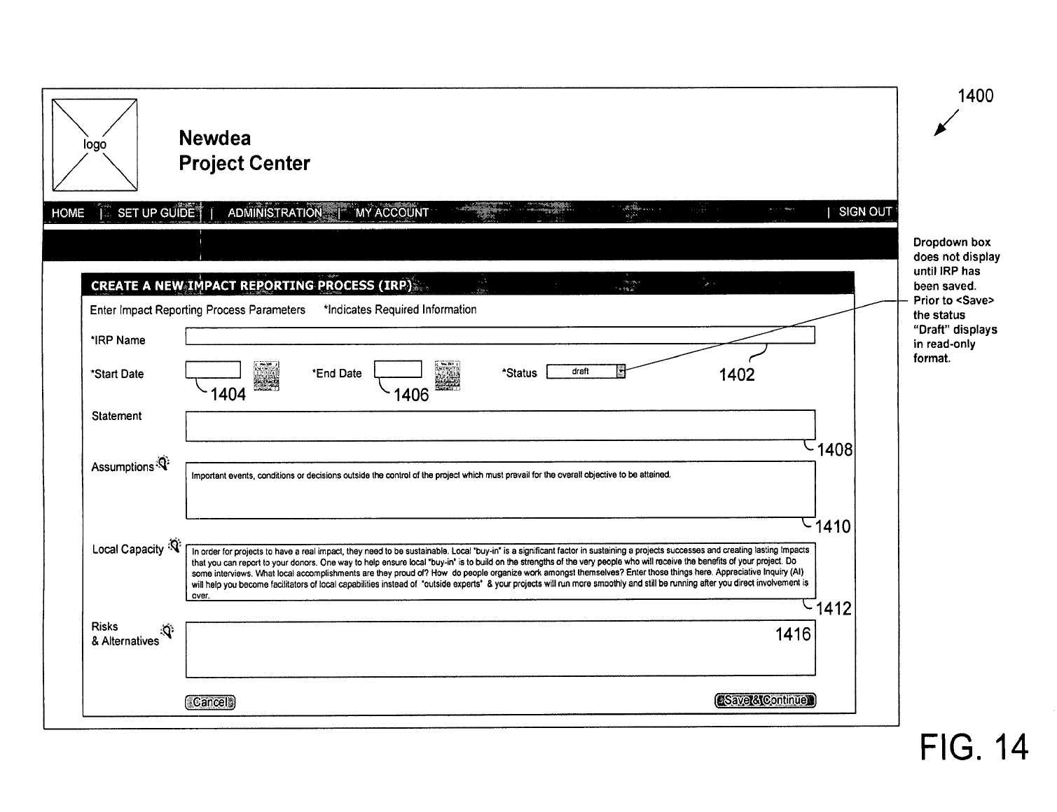

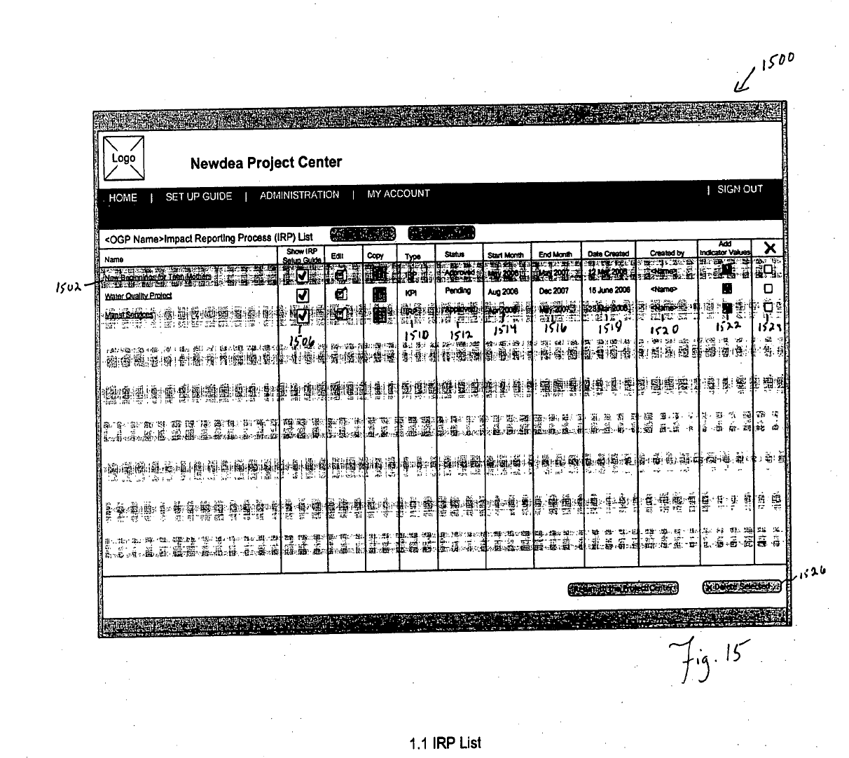

FIG. 14 shows a input screen 1400, which can be used to create an IRP, such as the IRP created at process block 404 of FIG. 4. IRPs 1400 may be altered by a client and/or user after the IRP 1400 is created. However, in at least certain implementations, the client is not allowed to modify the IRP 1400, or components thereof, once the IRP 1400 has been approved by the donor management system 118 (FIG. 1). In other implementations, the client may alter the IRP 1400 after it has been approved; however, such changes may require prior approval. In further implementations, any changes to IRP 1400 are recorded as part of an audit trail. However, such an audit trail may not be viewable by potential donors or other interested parties, but may optionally be available for viewing by the client. In some embodiments, the audit trail is viewable by some potential donors and/or interested parties.

The IRP input screen 1400, may have a name 1402, which may be implemented as a free text descriptor that can be used to briefly describe the result. Additionally, a time period, defined by a start date 1404 and end data 1406 can be included. In some embodiments the time period 1404, 1406 is required. In other implementations it is optional. The time period may comprise a month and a year, a day, month, and a year, or a different time entry, such as hour, day, month, and year. A variety of formats for entering a time period are envisioned. For example, a time period may be typed in using a MM/DD/YYYY format; dates may be chosen using a calendar or a pull-down list, and so on. The time period can be used to track a time period 1404, 1406 over which a particular result node 1400 is relevant.

A description 1408 can also be provided, for example, as a free-text descriptor.

This can be used to provide a brief description of an intended result. For example, a results description 1408 for a client whose goal is to make education available for a wide variety of individuals in a community might be “Increased literacy rate among adults.” The results description 1408 can be required by the donor management system 118 (FIG. 1) if desired, or can be left to the client's discretion. To be particularly effective in achieving the benefits of using metrics, as stated in examples above, the results statement may be defined at the same time as the IRP 1400 itself is defined.

The IRP 1400 can also include an assumptions field 1410, implemented, for example, using a free text descriptor. This assumptions field 1410 can be used to state important events, conditions or decisions outside the control of the project which must (or should) prevail for the overall objective to be attained. This field, and a portion or all of the text fields described here, can be a fixed size, such as is shown at 1408, where only as much text as can be placed within a defined window can be placed, or a window with scroll bars can be provided, which allows much more text to be entered. Even windows with scroll bars may have a limit on the amount of text that is allowed to be input, but some systems may allow the text fields to be very large.

A local capacity text field 1412 can also be included. This field may be used to note facts about the locale that might be of bearing on a given charitable project, such as the names and locations of clinics which might be used to provide pre-natal exams to those in a target group. A risks and alternatives text field 1416 can also be included. This field may be used to note problems that may be encountered, and strategies to avoid or ameliorate such difficulties.

The IRP 1400 optionally includes a result narrative (not shown) in a result narrative field (not shown). The result narrative can be implemented as a free text field and may serve as a place to store running comments. The result narrative could, alternatively, be implemented in other ways, such as selecting an entry from a predefined list. Entries in the result narrative field may be recorded at the time an IRP is created, or may be recorded at later times. In certain implementations, each result narrative in the result narrative field is independently recorded and treated as a separate entry from any previous or future entries. In such embodiments, a result narrative, once saved, is no longer editable. In other embodiments, only the most recent result narratives, or result narratives entered during a particular time period, are displayed. In yet further embodiments, the client may select which result narratives to display, optionally with approval or auditing requirements. The result narratives may be added, edited, or deleted. Each of these user-defined fields can be a metric which can be tracked, audited, and reported (in some embodiments).

In some embodiments, if there are no indicators or simple indicators previously set up for a given IRP, a “create metrics” button, menu item, etc., will be visible, (not shown) which will allow a user to create indicators and/or simple indicators. In other systems, such a button, menu item, etc. is always visible.

### 16—Result Node List Screen

FIG. 15 shows an IRP list screen 1500, which lists, and optionally, provides access to, IRPs which have been previously created, such as the IRP 1400 of FIG. 14. The IRP list screen 1500 may be implemented as a web page. A list of IRPs 1502, may display the name 1402 (FIG. 14) of the IRP 1400, and may allow access to, and modification of IRPs. An edit field 1506 allows a client or an administrator to access a specific IRP 1400. In an embodiment, selecting the edit field 1506 of a specific IRP 1502, presents the user with the IRP 1400.

Generally, information related to the overall metric is shown. This information may include a time period associated with the metric, including a start date 1514 and an end date 1516, (which may be defined by month and year, month, day and year, year alone or some other date description) and the date the metric was created 1518. Additionally, the person or organization that created the metric 1520, the type 1510 and the status 1512 (which may comprise whether the metric has been approved, is pending, the step of the status approval process, etc) may also be shown. For example, the status 1512 may be “approved” for metrics accepted by the donor management system 118 (FIG. 1) or “pending” for metrics awaiting such approval. Additionally, the status marker “denied” may be used for metrics which have been reviewed and not accepted. An indicator addition box 1522 for adding indicators (as discussed with reference to section 30) may be included in some implementations. A metric deletion selection box 1524 and link 1526 (which may allow an entire result node 1502 to be deleted) may also be included.

### 17—Component Relationships

FIGS. 16A-C shows details about component relationships. An IRP can have a series of metrics associated with it which can be used to plan, monitor, and evaluate charitable projects. Judicious use of such metrics can be used to ensure that projects have the intended impact. Broadly speaking, such metrics may comprise zero, one, or more components 1615; zero, one, or more indicators 1620; zero, one, or more inputs 1630, and zero, one, or more simple indicators 1622.

Components 1615 are metrics that can be broadly grouped under the categories activities 1617 and results 1619. Results 1619 can be outputs 1630, outcomes 1640, and impacts 1650. Inputs 1619 can be associated with activities 1617 or results 1619. Multiple inputs 1619 can be associated with a single activity 1617. Similarly, multiple activities 1617 can be associated with a single input 1619. Simple indicators 1622 are stand-alone indicators (in a certain embodiment).

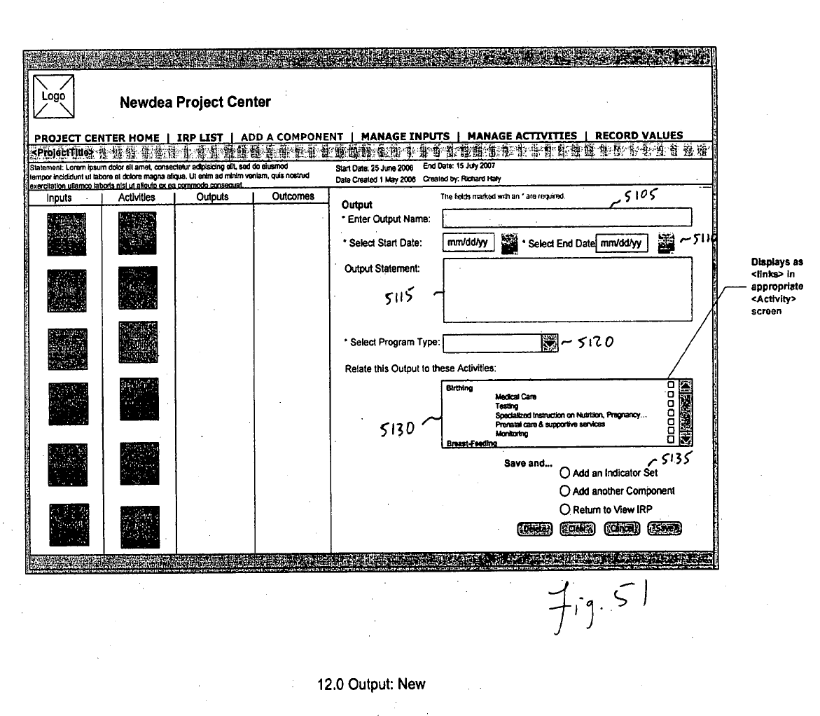

In an embodiment, outputs 1630 can be associated with activities 1617. For example, as shown in FIG. 25 at 2550, the output 1630 “13 pre-natal examinations per participant” can be linked to the activity 1617 “Medical Care.” Outputs 1630 can be linked to activities 1617 using, for example, the input screen shown at FIG. 51.

Briefly, activities are the tasks associated with a project in order to achieve desired results. For example, an activity could be “giving 100 prenatal tests to woman between the ages of 17 and 19.” Results are metrics that can be tracked for a given project as reflected in a result node (such as the result node 1605 of FIG. 16) to determine whether the activities have had their desired effect. For example, a result might be “lessening the percentage of premature birth in the target population.”

In order to determine whether the criteria set forth by a particular result 1619 are met, the client can provide one or more indicators 1620. The indicators 1620 are associated with a particular result. The indicators 1620 may be defined at the time the result node 1605 is defined, or at a different time. In an embodiment, indicators are associated with metrics other than results.

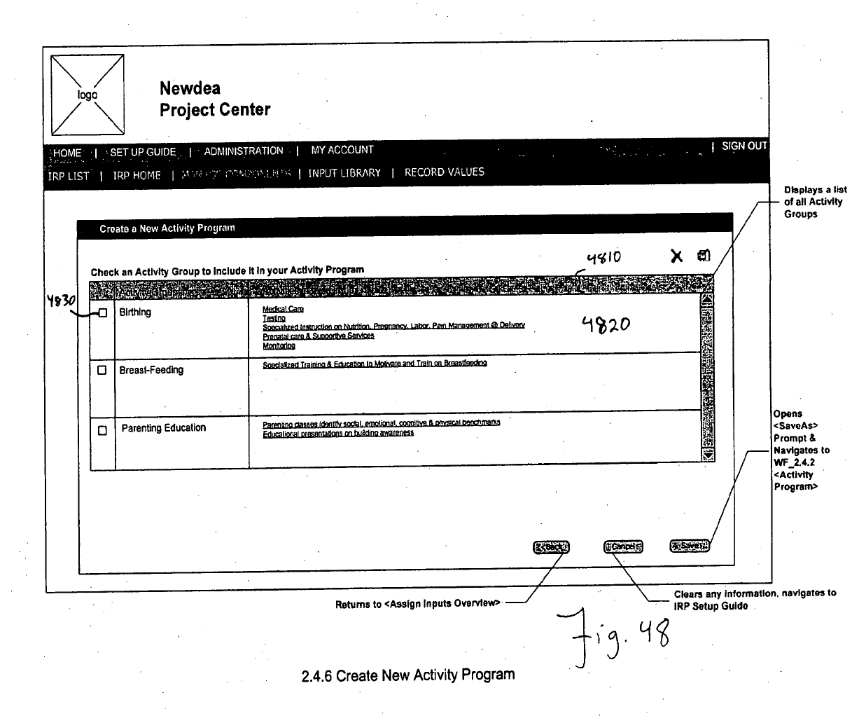

Individual components 1615 can themselves be grouped. For example, with reference to FIG. 16C, a plurality of activities 1617 can be grouped into activity groups 1660. By judiciously grouping activities, for example, by associating all activities connected to a specific output, the cause and effect relationship between various portions of an IRP can be more closely established. Similarly, other component types, such as inputs, outputs, outcomes, impacts, and indicators can also be grouped, in certain embodiments. Activity groups 1660 themselves, in certain embodiments, can be themselves grouped into activity programs 1670, such as is shown with reference to FIG. 48.

Inputs 1630 are the resources, facilities, equipment, materials, information, and so forth, that are used to carry out project activities. It is often crucial to the success of a project being tracked by a result node/IRP that the inputs can be tracked and evaluated. Inputs 1630 can be related to activities 1617.

### 18—Method to Create a Result Node and Corresponding Metrics

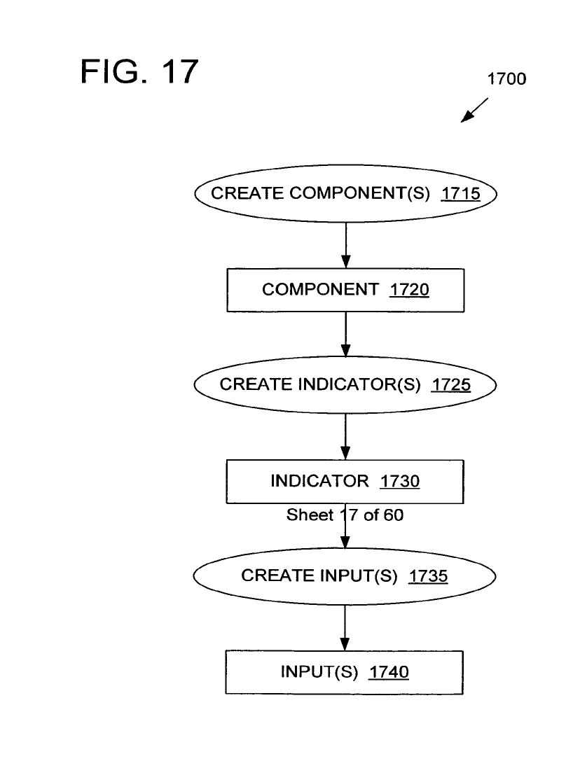

FIG. 17 shows a method 1700 of creating a result node and corresponding metrics. The method can be performed, for example, by the donor management system 118 of FIG. 1. At 1715, one or more components 1720 are created. At 1725, one or more impacts 1730 are created. At 1735, one or more inputs 1740 are created. In other embodiments, the order is different, such that, for example, inputs are created directly after components, etc.

### 19—Input Screen to Allow a User to Create and Manage an IRP and its Features

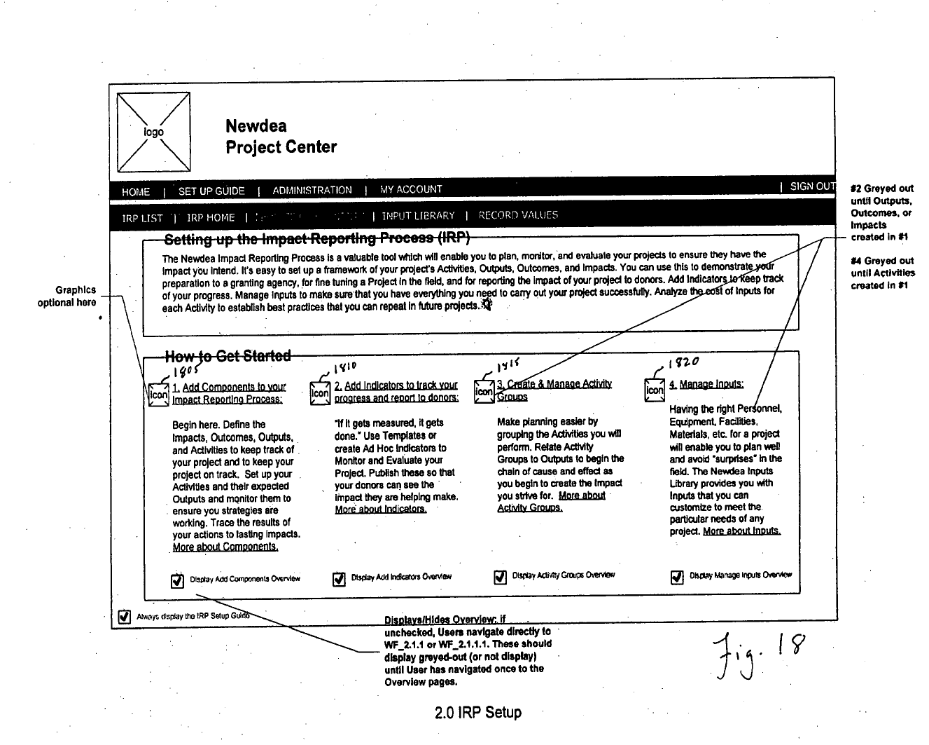

FIG. 18 is an input screen used for IRP setup. At 1805, one or more components, such as the component 1720 (FIG. 17) can be added to an IRP. At 1810, one or more indicators, such as the indicator 1730 (FIG. 17), can be added to the IRP. At 1815, one or more activities can be grouped into an activity group.

At 1820, one or more inputs, such as the input 1740 (FIG. 17), can be. Examples of inputs include personnel which will be used for the project, equipment needed for the project, facilities available for the project, and so on.

### 20—Component Types

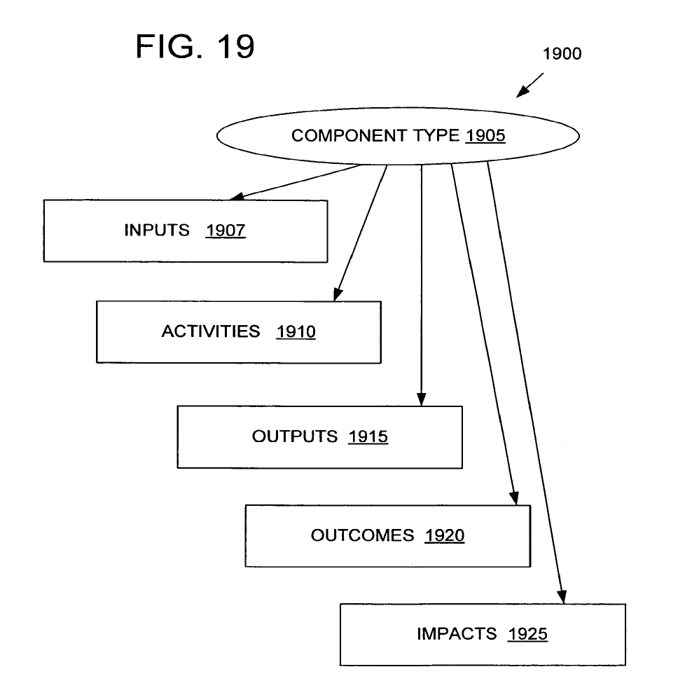

FIG. 19 shows a block diagram 1900 of component types 1905 that can be used to produce metrics for evaluation of the progress, effectiveness, success or failure, etc., of a charitable program. In any of the examples herein, any of the component types shown can be used as a component. Inputs 1907, activities 1910, outputs 1915, outcomes 1920, and impacts 1925 can all be created, managed, and used as metrics. These component types 1905 can be used to define more complex metrics, and they can be used to print reports, and so on. In some embodiments, other components, such as medium term outcomes (not shown), short term outcomes (not shown), and so forth, can also be used as component types.

Impacts 1925 can be longer term results; outcomes 1920 can be medium term results; and outputs 1915 can be short term results. Activities 1910 can be those actions taken by the client that aggregate to produce more substantial results, such as the outputs 1915, outcomes 1920 and impacts 1925.

It can be difficult to achieve a long term impact 1925 without first achieving some level of short term and medium term or intermediate results. Thus, there may be fewer long term results (impacts 1925) than medium term results (outputs 1915); fewer medium term results (outputs 1915) than short term results (impacts 1920), and so on. Some embodiments may have more long term results than short term results, and so on. Within a particular metric, the results at a particular level aggregate to contribute to the results at the next higher level.

The relationship between activities 1910, outputs 1915, outcomes 1920, and impacts 1925 can be illustrated by the example of a project designed to increase basic literacy. Activities 1910 that might be undertaken in such a project might include:
Select and train literacy instructors.
Assess literacy levels of women and men.
Produce and distribute literacy materials.
Provide basic literacy, post-literacy and numeracy training for (f/m) community members and groups.
Coordinate with Government to provide certification of learner achievement, stipends for facilitators, curriculum assistance and testing of learners (f/m).
Establish key components to promote continuing education that will maintain and strengthen literacy skills such as creating box libraries, book clubs, rural lending libraries, and refresher workshops; and ensuring the key population has access to local newspapers.
Conduct accounting and financial literacy classes.
Assure follow-up and monitoring

These activities 1910 might lead to the following outputs 1915, shown in the table below, with their associated indicators, and a list of countries (which may correspond to organizational sub-units) for which the indicator is valid:

TABLE 1
Example Outputs

| Basic Education (Literacy) | Basic Education (Literacy) | Countries that can report |
|---|---|---|
| Output Results | Output Indicators | against this indicator |
| Trained literacy instructors | Number of women and men | Malawi, Bangladesh, |
| capable of delivering | trained to serve as literacy | Tanzania, Nicaragua, |
| community level literacy | instructors, as per national | Ecuador, Guatemala, |
| programs | Ministry of Education criteria | Haiti |
| Increased numbers of f/m | Number of f/m participants with | Malawi, Bangladesh, |
| participants with basic | basic literacy (reading and writing) | Tanzania, Nicaragua, |
| literacy (reading and | comprehension, as per nationally- | Ecuador, Guatemala, |
| writing) comprehension | used criteria | Haiti |
| Post-basic literacy materials | Number of communities where | Malawi, Bangladesh, |
| available for the community | members can access/borrow post- | Tanzania, Ecuador, |
| members and partner | basic literacy materials | Guatemala |
| organizations | (newspapers, books, other printed | |
| | materials) | |

These outputs might aggregate to produce the following sample outcomes (shown with sample indicators and countries for which each indicator is valid):

TABLE 2
Example Outcomes

| Basic Education (Literacy) | Basic Education (Literacy) | Countries that can report |
|---|---|---|
| Outcomes | Outcome Indicators | against this indicator |
| Increased numbers of f/m | Number of f/m participants | Malawi, Bangladesh, |
| participants with post-basic | who have used/borrowed | Tanzania, Guatemala |
| literacy (reading and writing) | post-basic literacy materials | |
| comprehension | (newspapers, books, other | |
| | printed materials) at least | |
| | twice over the previous six- | |
| | month period | |
| Increased use of post-basic | Number of f/m participants | Malawi, Bangladesh, |
| literacy materials, including | with post-basic literacy | Tanzania, Ecuador, |
| newspapers, by community | (reading and writing) | Guatemala, Haiti |
| members | comprehension, as per | |
| | nationally-used criteria | |
| Increased numbers of f/m | Number of f/m participants | Malawi, Bangladesh, |
| community members who, | who have taken up | Tanzania, Nicaragua, |
| having developed literacy | leadership roles and/or | Guatemala |
| comprehension, take up | participated in political | |
| leadership roles in their | forums | |
| community and/or | | |
| participate in political forums | | |

Example impacts 1925 that are supported by the previous activities, outputs, and outcomes could include:

TABLE 3
Example Impacts

| | Increased literacy rate among adults |
|---|---|
| Basic Education (Literacy) | and wider community involvement by |
| Impact: | newly literate |
| Indicators: | Literacy rate in community, dis- |
| | aggregated by gender |
| | Increased satisfaction by community |
| | members (f/m) with their involvement |
| | in community matters |
| | Increased hope by community members |
| | (f/m) as to their future |

### 21—Component Type Fields

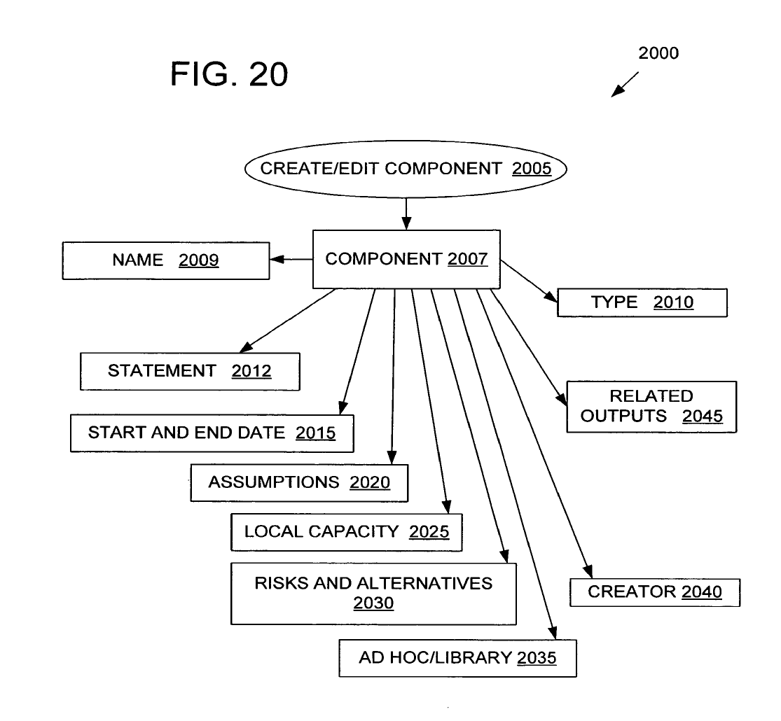

FIG. 20 is a block diagram of a component, such as the component 1900 of FIG. 19, showing optional fields that may be included. At 2005 a component 2007 is created or modified. In some embodiments, each of the fields shown are optional and can be added and deleted either when the component is created or edited. In other embodiments, certain fields, such as “name” 2009 and “type” 2010 are required.

Each component may have a type, such as those defined in section 20. Components also may include a statement 2012, (which may be required to be brief, that is, limited to a number of character strokes) that briefly defines the component. This statement may also be used to define one or more goals of the project, as exemplified by the underlying IRP.

A start and an end date 2015 may also be included. These dates may be entered in a variety of formats. The start and an end date 2015 can be used to track a time period over which a particular component 2007 is relevant. The start and an end date 2015 for the component may be at or after a corresponding IRP begin date (1404, FIG. 14), or after a corresponding metric end date (1406, FIG. 14).

Text fields for assumptions 2020, local capacity 2025, and risks and alternatives 2030 may also be provided. In some embodiments, a pull-down menu, or another method may be used at least partially for input.

To aid clients in establishing the component 2007, a library with predefined templates that may be used, or the component may be set up separately, that is, ad hoc. A Library is a grouping of pre-made and re-usable items: components, indicators, simple indicators, inputs, and so on. Users can create their own Library of items or make use of standard predefined items. Because library items are uniform, they can be reported on across projects/programs and be rolled up into summary reports.

The component creation method may be listed in a pulldown menu 2035, with “new” or “ad hoc” indicating that the component is to be established by the user, and “library” indicating that a predefined template is to be used. Alternatively, the list could include all templates that are available for that component.

For example, there may be multiple organizations trying to achieve a similar or identical result, such as eliminating hunger within a region. Rather than requiring each client to set up a whole series of components 2007 independently, clients may be allowed to choose predefined components from a library. If desired, some or all of the template attributes, such as a statement 2012, could be altered as desired by the client. In other instances, the client may be required to accept all or a portion of a template. For example, for a particular template, if the start and end dates 2015 are predefined, and therefore part of the dictionary, then the start and end dates 2015 are a part of the template and may not be altered or removed by the client. Similarly, in certain embodiments, if a result 1619 (FIG. 16B) is predefined, or templated, and therefore part of a dictionary, then any indicators 1620 (FIG. 16) associated with the result 1619 will be automatically created when the result is created. In at least certain implementations, the client may not alter the indicators or any of their components if they are created using templates from a library.

Items (such components 1607, indicators 1620, inputs 1630, simple indicators 1622) may also be defined ad hoc. The type of indicator, such as “library” or “new” (if defined ad hoc) can be displayed in an ad hoc/library field 2035. Ad hoc items may be altered by the user after creation. However, in at least certain implementations, the client is not allowed to modify the added item after it has been approved by the donor management system 118 (FIG. 1). In other implementations, the client may alter the item after the metric has been approved. However, such changes may require prior approval.

In further implementations, any changes to an item are recorded as part of an audit trail. The audit trail may not be viewable by interested parties, but may optionally be available for viewing by the client.

In some implementations, a component creator field 2040 is also present. This field has the name of the person who initially created the component 2007. Some embodiments include a related output field 2045 which ties components 2007 to related components, allowing events in a causal chain to be planned, tracked, and evaluated. Other fields, such as status (approved/pending/denied, etc) may also be present.

### 22—Component Overview Screen

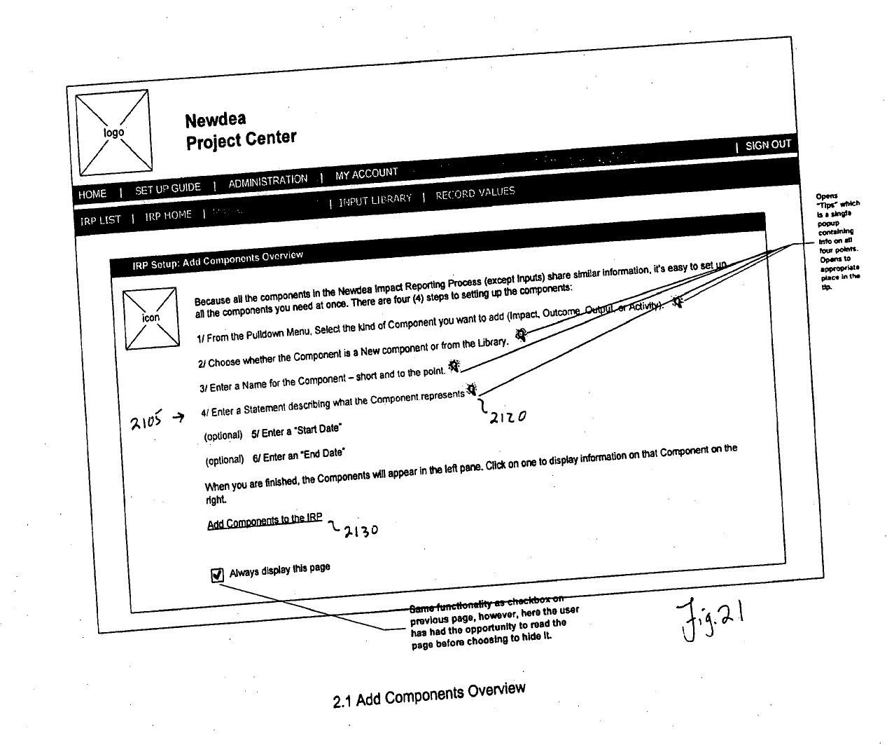

FIG. 21 is an input screen produced by the donor management system 118 (FIG. 1) providing an overview of the component setup process to a user. Components that share similar information can be set up in groups. A description 2105 provides a brief overview of the component entering process, discussing, at 1, selecting a component from a pull-down menu; at 2, choosing a component from the library, or building a new component; at 3, entering a name for the component; and at 4, entering optional start and end dates metrics, as shown with reference to section 18. Help screens can be accessed by clicking on lightbulb icons 2120. A hyperlink 2130 pulls up a create components screen, discussed below with reference to FIG. 22.

### 23—Input Screens to Create Components

FIG. 22 is an input screen allowing a user to establish components for a result node a given impact reporting process. A user may select a component type At 2205, the type of component (impact, outcome, output, or activity) as described with reference to section 20, can be can be chosen using a pulldown menu. In some implementations other components, such as “medium term outcome” and “short term outcome,” can also be chosen. Other embodiments may allow input of type component information using a different method, such as radio buttons, direct text input, and so on.

At 2210, a user can use a pulldown menu (or other input type) to choose whether to build an ad-hoc component (a new component) or to use a component already at least partially predefined by a template—choosing a component from the library. This process was described in more detail in section 15 in connection with the ad hoc/template option 2035 (FIG. 20).

If a user selects a component type from the library, a list of names (already in the library) for that component type may appear in the “name” field 2212. Users may then be required to select a name 2212 for the component type. When a user selects a name 2212 for the component type, the system may display an associated statement for that component type in the Statement field 2214.

If the “Ad Hoc” component type is selected, the user may be required to enter a name in the “name” field 2212, and/or a statement in the “statement” field 2214. This statement can provide a brief description of the impact that this component is to make, such as specific goals that are to be met or enabled.

Users may have the option of entering a Start Date 2216 and an End Date 2218. These two dates may be optional, or may be required, depending on the embodiment. If extra information is required for a given function, a light bulb icon 2220 can be clicked which will display an appropriate help screen.

In some embodiments, users can add components by clicking or otherwise selecting an “Add Component” icon (not shown). Clicking the “Add Component” icon may display a new row at the bottom of the table

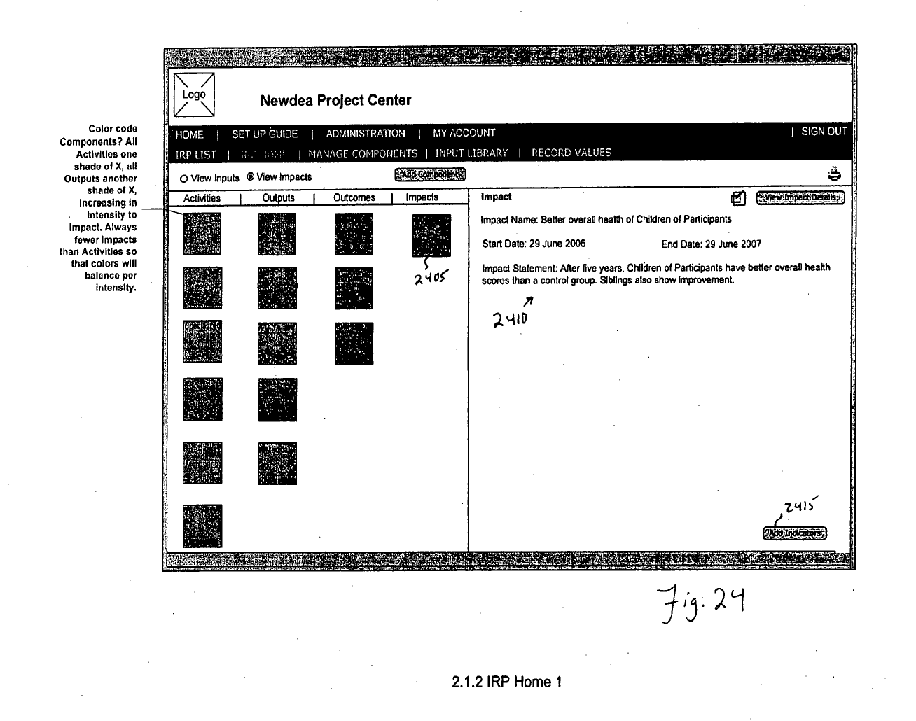

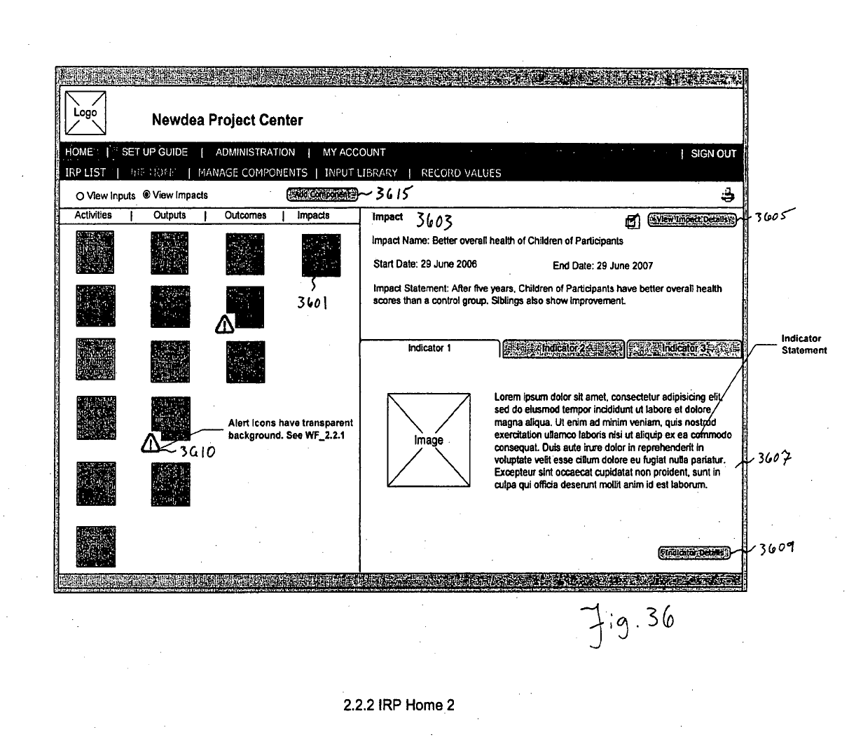

The first few characters of the name can be used to identify icons associated with the components, as can be seen with reference to the icon 3601 (FIG. 36) where the name “Better Overall Health of Children of Participants” is displayed on the icon 3601 as “Better Overall Health of Children.” Some embodiments have the user enter separate names for the icon abbreviation and the name. Selecting a “save” button 2220 may save the component just created and display a home page, such as the IRP home page shown in FIG. 24.

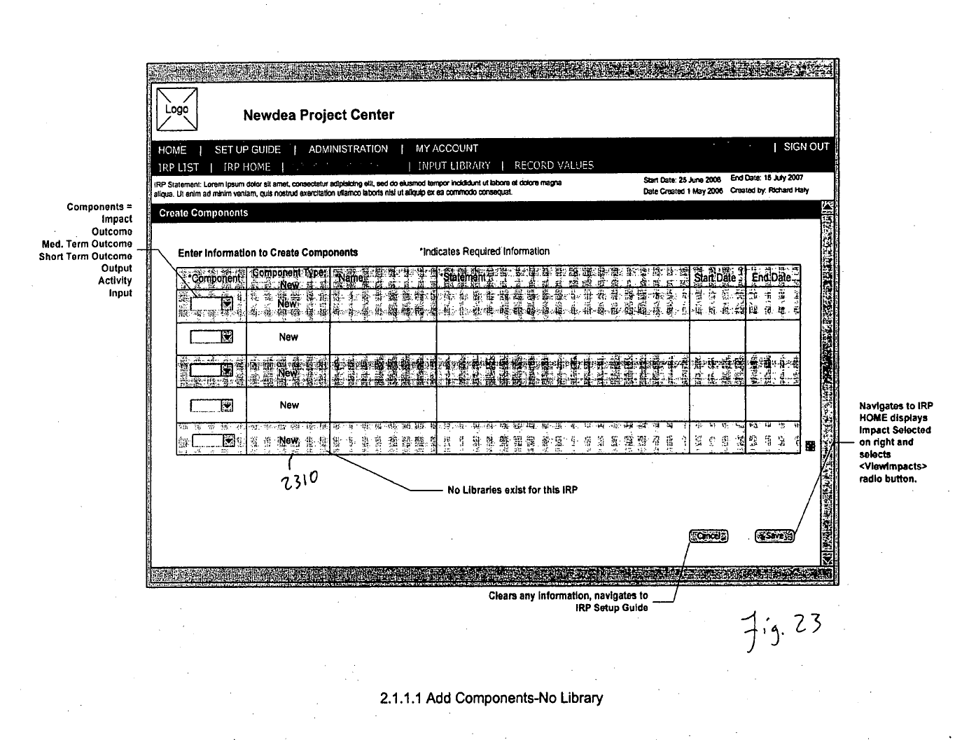

FIG. 23 is an input screen allowing a user to establish components for a a chosen impact reporting process when there is no library available. Setup proceeds substantially similarly as for the input screen shown in FIG. 22, except that the component type field 2310 does not have a pulldown menu allowing a user to choose to use a library. Rather, the type “New” is preselected.

### 24—Component Summary Screens

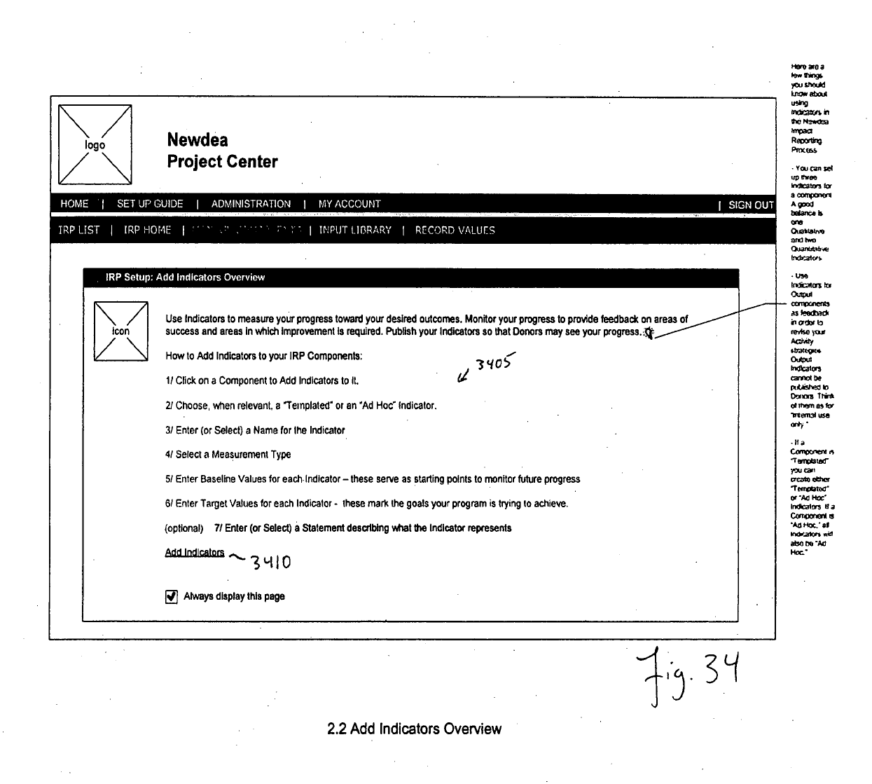

FIG. 24 is a main input screen in the IRP allowing a user to easily view all components that have been input for an IRP, such as a component created the using input screen of FIG. 22 or FIG. 23. Furthermore, users can see the components that have been created for this IRP and navigate from one component to another to view the details of each. This specific screen shot reveals the effect of highlighting an impact (1925 of FIG. 19) that has previously been input. A summary of previously-input information appears on a pane 2410 associated with the impact 2405. As impacts can have associated indicators, an “Add Indicators” button 2415 will bring up an input screen which will allow indicators to be added, such as the input screen shown at FIG. 34. A similar pane 2410 appears if an output or an outcome is highlighted, as well; as outputs, outcomes, and impacts all may have indicators defined for them.

FIG. 25 is another view of the input screen shown in FIG. 24 that appears if an activity is highlighted. An “Add Components” button 2505 may bring up an input screen which allows another component to be added. At 2510, activities which have been defined are listed, along with a thumbnail description of the activities. At 2515, outputs are similarly defined. At 2520, outcomes, with their thumbnail descriptions are defined, and at 2530, impacts, with a thumbnail description, are defined. If there are more items in a category than will comfortably fit on a screen, the associated window may be provided with scroll bars, the window may be divided up into individually selectable pages, or another method may be used to allow a user to easily access all items of interest.

If a user selects a component thumbnail icon, such as the activity icon 2512, a summary of the information about that specific component can be displayed on a separate panel 2540. Selecting a “view details” button 2450 can bring up a screen that allows substantially all of the details about a specific component to be viewed. For example, selecting the “view activity details” button 2550 may bring up an “Activity Details” screen similar to the one shown at FIG. 27. When an activity icon 2512 is selected, then a subset of activity details, such as any activity groups that the activity belongs to, and any related outputs 2550 belonging to the activity, may also be displayed. If a hotlink associated with an activity group, such as the hotlink “birthing” 2545, is selected by a user, a summary screen associated with the activity group selected may be displayed, such as a summary screen similar to the one shown at FIG. 26. In other embodiments, the text associated with an activity group is not a hotlink, but rather, informative text.

### 25—Component Summary Screen Showing Activity Groups

FIG. 26 is an interface screen similar to the one of FIG. 25, allowing viewing of and interaction with activity groups, among other activities. The activity group icons, such as the icon 2610, appear on the interface screen alongside the activity icons, such as the activity icon 2512. However, the activity group icons are marked indicating that this icon is an activity group.

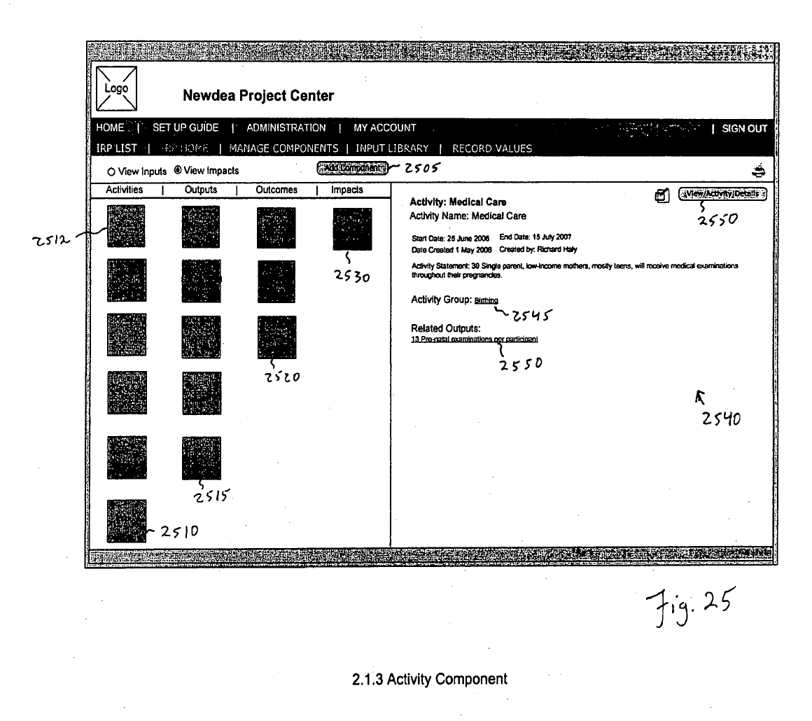

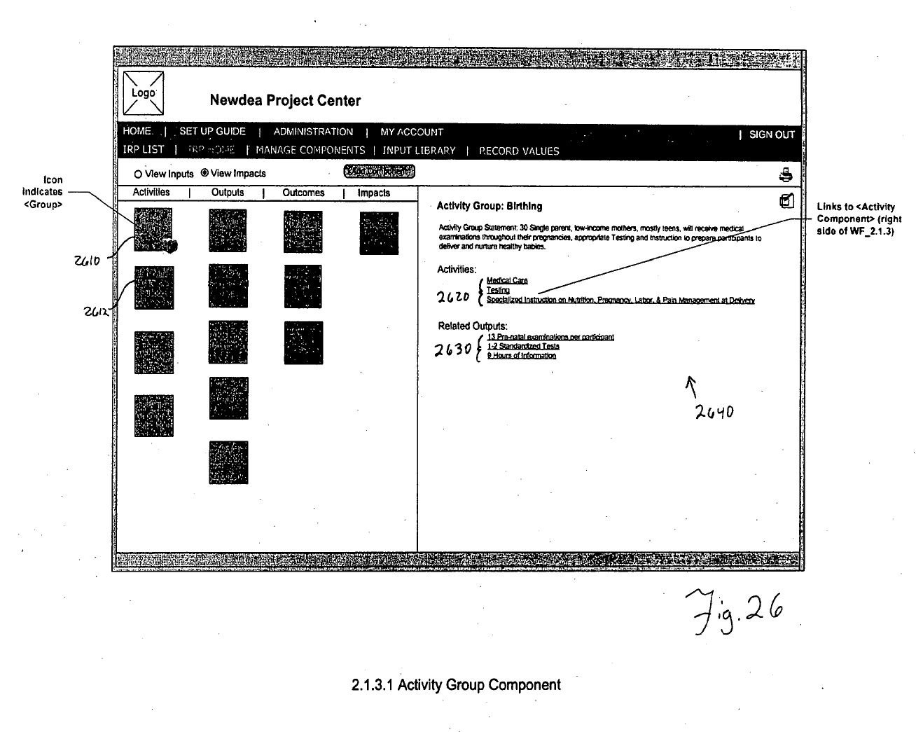

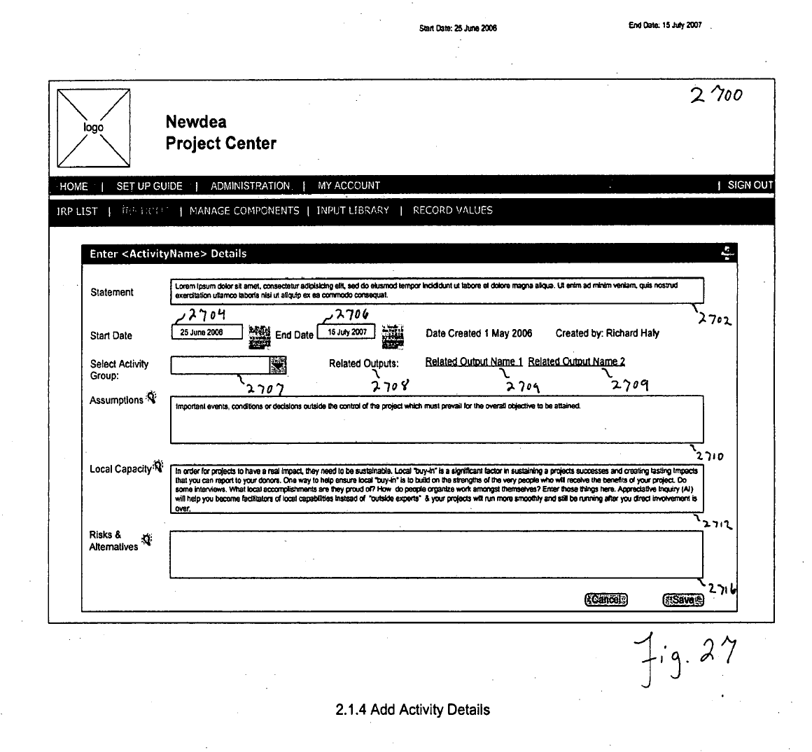

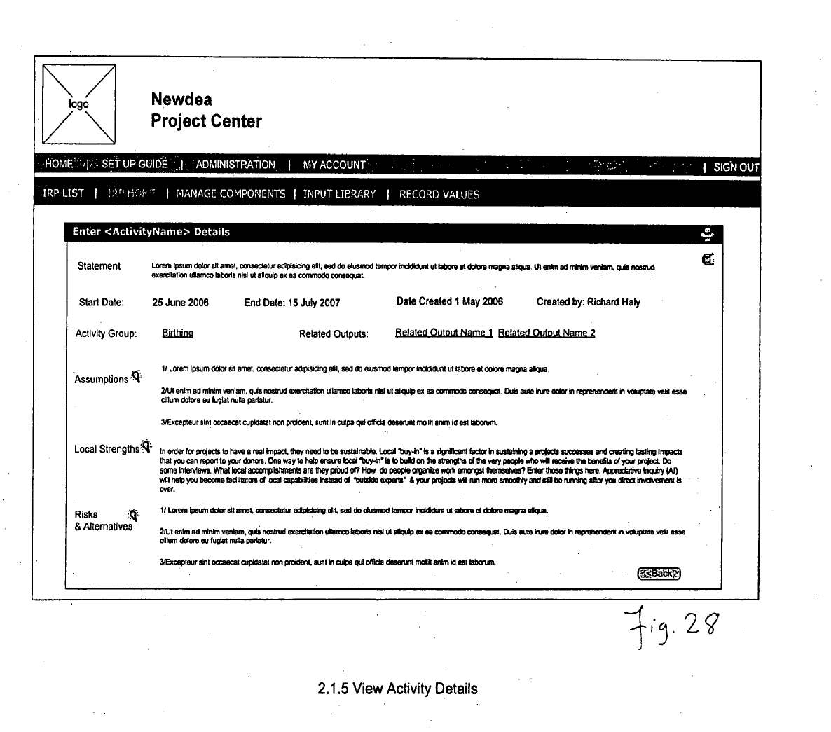

When an activity group is selected, general information about the activity group appears, in some embodiments, on a separate pane; in other embodiments on the same pane. Other, more specific, information about the activity group, such as associated activities 2520, and related outputs 2530 may also appear. The listed activities 2610 can be implemented as hyperlinks, which, when selected, display an interface page which presents more information about the activity, such as the activity details interface screen page shown at FIG. 28. Similarly, the related outputs 2630 can be implemented as hyperlinks, which, when selected, display an output view page.

### 26—Component Summary Screen to Edit Components

FIG. 27 is an interface screen allowing a user to input details about components, such as activities which have been previously created by, for example, the interface screen of FIG. 22. The input screen, 2700, in the illustrated embodiment, is an activity, but in other embodiments can also be an output, an outcome, an impact, etc. A statement 2702, which may be implemented as a free text descriptor, can be used to briefly describe the result. In some embodiments, the statement 2702 is required, while in others it is optional.

Additionally, a time period, defined by a start date 2704 and end date 2706, can be included. In some embodiments the time period 2704, 2706 is required. In other embodiments, it is optional.

The time period may comprise a month and a year, a day, month, and a year, or a different time entry, such as hour, day, month, and year. A variety of formats for entering a time period are envisioned. For example, a time period may be typed in using a MM/DD/YYYY format; dates may be chosen using a calendar or a pull-down list, and so on. The time period can be used to track a time period 2704, 2706 over which a particular component 2700 is relevant. In an embodiment, the time period 2704, 2706 is automatically entered as the corresponding time period 1404, 1406 (FIG. 14) for the underlying IRP.

This component, if an activity, can also be defined as belonging to an activity group, such as the activity group 2640 of FIG. 26. This grouping can be implemented as a pulldown menu which has all (or substantially all) the currently defined activities within. The user then chooses which activities will be in the activity group, by for example, selecting check boxes associated with the desired activities. In some embodiments, an activity can be assigned to only one activity group, in other embodiments, an activity may be assigned to multiple activity groups.

Outputs, such as the output 1915 of FIG. 19, can also be related to the activity shown. If so, the related outputs can be described by their name 2709, which may be a hyperlink providing more information about the specific output.

A statement 2702 can also be provided, for example, as a free-text descriptor. This can be used to provide a brief description of an intended result. The statement 2702 can be required by the donor management system 118 (FIG. 1) if desired, or can be left to the client's discretion.

The activity 2700 can also include an assumptions field 2710, implemented, for example, using a free text descriptor. This assumptions field 2710 can be used to state important events, conditions, or decisions outside the control of the project, that must (or should) prevail for the overall objective to be attained. This field, and a portion or all of the text fields described here, can be a fixed size, such as is shown at 1408, where a limited amount of text may be placed, defined by the size of the window. Alternatively, a window with scroll bars can be provided for text entry, which may allow much more text to be entered. Even windows with scroll bars have a limit on the amount of text that can be input, but some systems may allow the text fields to be very large. A local capacity text field 2712, a risks and alternatives text filed 2716, and/or a local strengths field (not shown), can also be included, which may be implemented as free text fields.

### 27—Component Summary Screens

FIG. 28 is an interface screen which can be produced by the donor management system of FIG. 3, allowing a user to view details about activities which have been previously created by, for example, the interface screen of FIG. 22. This input screen may be similar to the component input screen 2700 with the difference that activity detail text may, optionally, be able to be read but not edited. This interface screen may be used, for example, by users who do not have permission to make modifications.

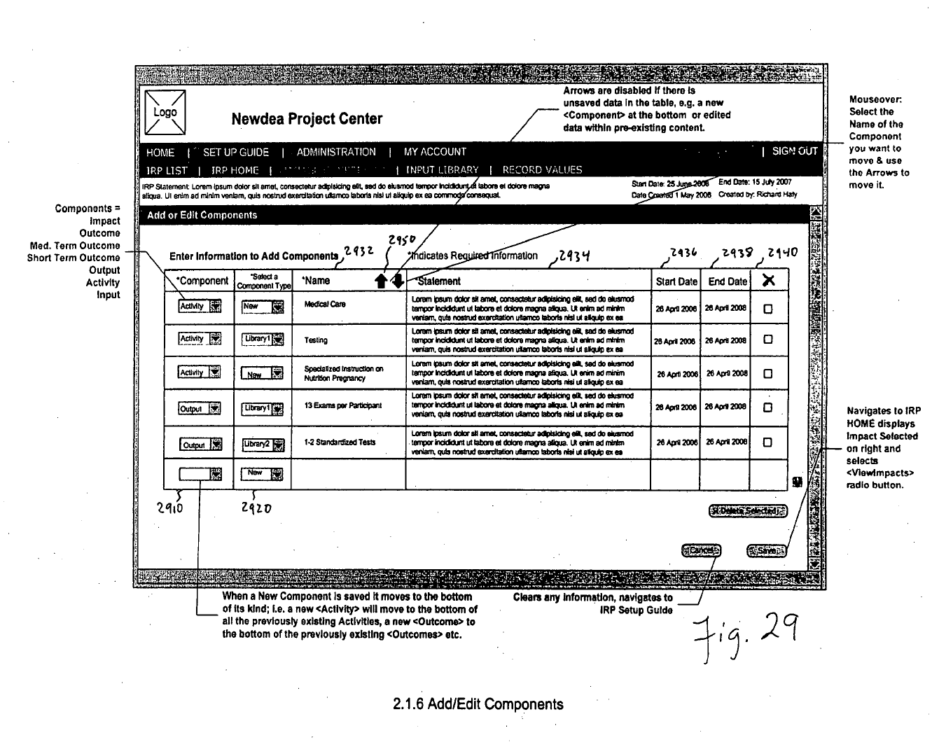

FIG. 29 is an interface screen which can be produced by the donor management system of FIG. 3, to allow a user to edit components which have previously been created by, for example, the interface screen of FIG. 22. The component column 2910, which may be required, allows users to see the type of components, for existing components, or to assign a type to a new component. The select a component type column 2920, which may be required, allows a user to determine if the component is created from an existing template library, or is created independently (ad hoc). In an embodiment, a user can select a component template from a pulldown menu. This menu can contain the names of existing library templates used to create components, as well as an indicator (“new” in the illustrated embodiment) which indicates that the component will be constructed without a template.

In an embodiment, all of the components of a specific type are grouped; that is, all of the activities appear together, and so forth. When a new component is saved, it will move automatically to the bottom of all of the existing components of its type—for example, a new output component will move to the bottom of the outputs.

Information which was already input about the components and cannot be modified, such as the name 2932, a statement 2934, a start date 2936 and an end date 2938, may also be shown, as it is in the illustrated embodiment. Other embodiments may choose to display a different set of known information. Alternate embodiments may allow such information (e.g., the name 2932, a statement 2934, a start date 2936 and an end date 2938) to be modified. Arrows 2950 allow components to be rearranged. The arrows 2950 are disabled if there is unsaved data; that is, if a new component has been entered that has yet to be saved. To move a component, select the component to move (by double-clicking on the name, by mousing over a portion of the row associated with the component, etc) and then select the arrows to move; selecting (e.g., clicking on) the right up arrow will move the component up one row, etc.

### 28—Activity Group Overview Screen

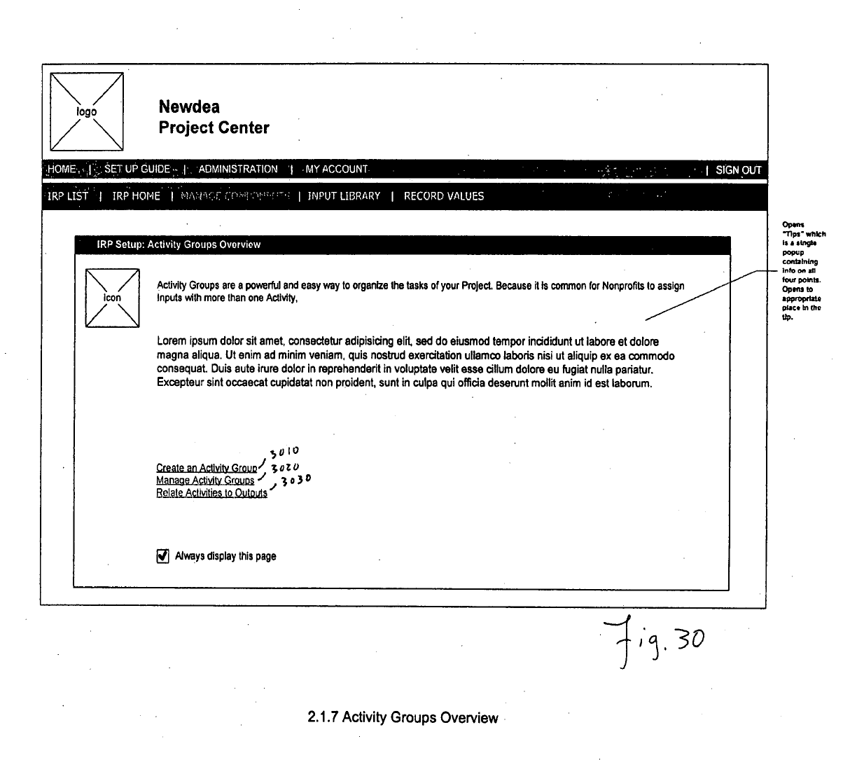

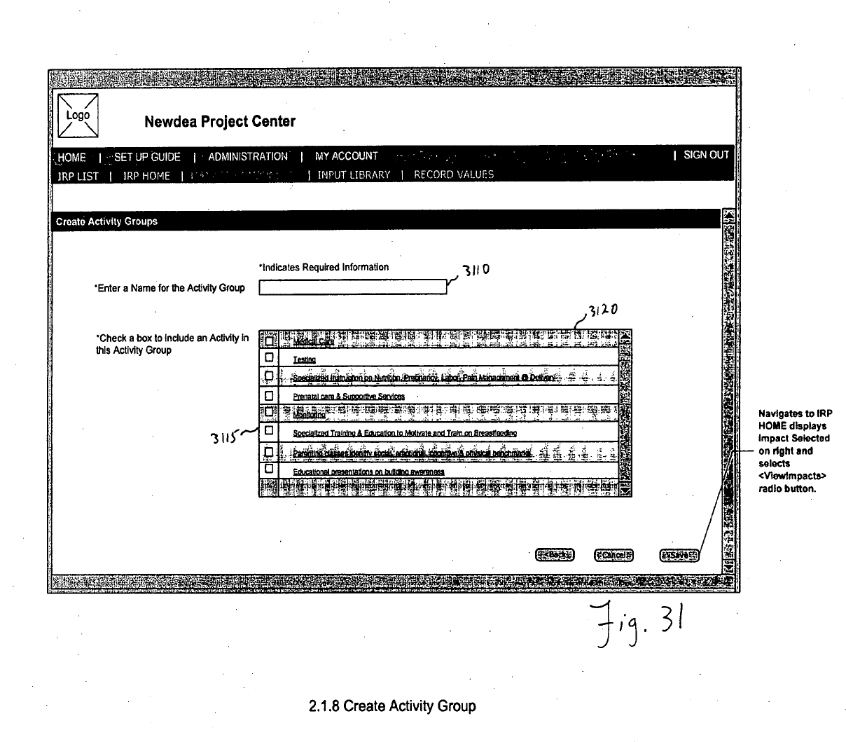

FIG. 30 is an interface screen which can be produced by the donor management system of FIG. 3, to present an activity group overview for a user. This screen allows a user to create an activity group 3010, described with greater detail with reference to FIG. 31; to manage activity groups 3020, and to relate activities to outputs 3030.

### 29—Activity Group Creation Screen

FIG. 31 is an interface screen which can be produced by the donor management system of FIG. 3, to allow a user to create activity groups, and to associate those groups with activities. An activity group name 3110 can be entered by a user. A check box list 3120 can contain the activities previously defined for this IRP (result node). A user can associate the newly created activity group 3110 with activities by selecting the check boxes associated with desired activities. In an alternate embodiment, users select activities to associate with an activity group using a pulldown menu.

### 30—System and Method to Use Indicators

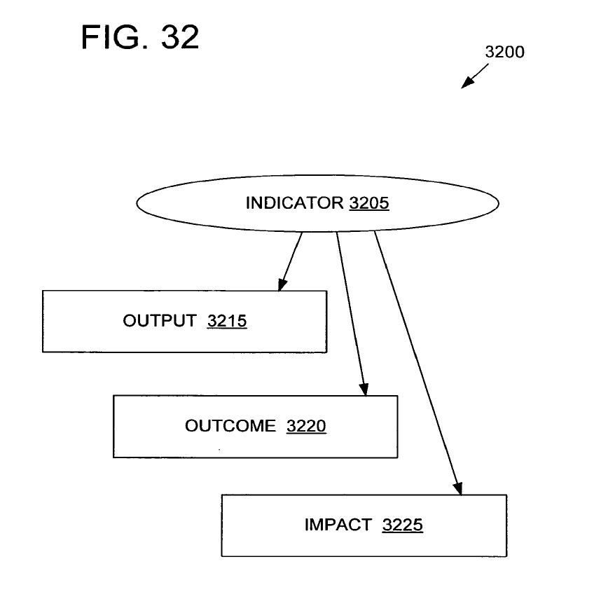

FIG. 32 shows a block diagram 3200 of an indicator 3205 (such as the indicator 1620 of FIG. 16) which can be created, used, and reported for the results component types outputs 3215, outcomes 3220, and impacts 3225. These indicators 3205 can be used to produce metrics that will be used to evaluate the progress, effectiveness, success or failure, etc., of a charitable program.

An indicator (a value or series of values, i.e., a metric) can be provided for a particular result, such as an output 3215, outcome 3220, or impact 3225. Optionally, no indicators 3205 need to be defined for a result. Indicators can be used to monitor progress and to provide feedback on areas of success and areas in which improvement is required. Indicators can be private. Such indicators may be available to be seen only by members within the charitable organization, or may be more restrictive—available to be seen only by a subset of those within the charitable organization. Indicators may also be public—available to be seen by people outside a charitable organization, such as, for example, donors. Such indicators may also be published the viewing public by, for example, a donor management system, such as the Donor Managements system 118 of FIG. 1. In an embodiment, indicators for outputs 3215 cannot be published to donors or others outside an organization without permission. In other embodiments, all indicators are public; yet other embodiments make all indicators private, and so on. In the illustrated embodiment, a maximum of three indicators can be established for a given output 3215, outcome 3220, or impact 3225. Other embodiments have different or no maximum number of indicators.

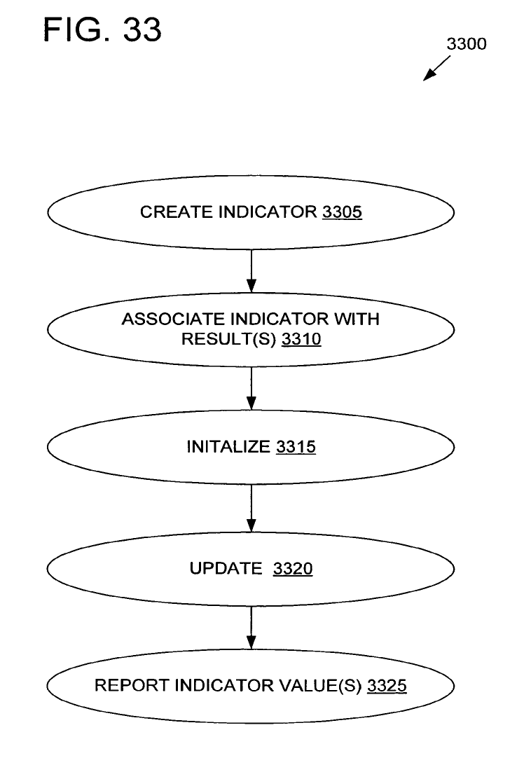

FIG. 33 shows a flow diagram of a method to create and use indicators, such as the indicator 3205 of FIG. 32. At 3305, the indicator is created. The indicator can be created by the Donor Management system 118 of FIG. 1. At 3310, the indicator is associated with a component type, such as the component types shown in FIG. 32. At 3315, the indicator is initialized with starting values, such as measurement type, milestone values, and the like, as will be discussed with reference to section 31. At 3320, at least one indicator value is updated. At 3325, at least one indicator value is reported. Such report use may comprise printing the value to a summary report about a given component, indicator, project, etc., displaying the value on a report screen, sending the report value via email to a remote user, and so forth.

### 31—Indicator Overview Screen

FIG. 34 is an interface screen that can be produced by the donor management system of FIG. 3, to provide a user an overview of the indicator setup process. A description 3405 provides a brief overview of the component entering process, discussing, at 1, selecting a component that will have indicators added; at 2, choosing a component from the library (templated), or building a new component (ad hoc); at 3, entering a name for the component; at 4, entering a measurement type; at 5, entering baseline values for each indicator which will serve as starting points to monitor future progress; and at 6, entering target values for each indicator to mark the goals the program, represented at least in part by a result node, is trying to achieve. A hyperlink 3410 pulls up a screen which allows creation and optional initialization of indicators, discussed with reference to section 32.

### 32—Indicator Input Screen

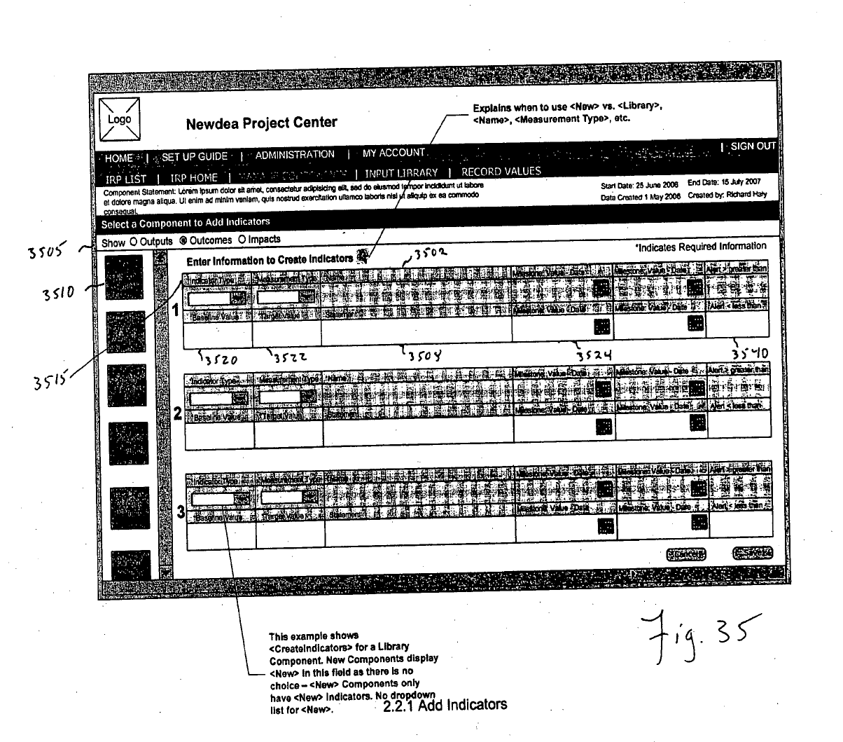

FIG. 35 is an interface screen which can be produced by the donor management system of FIG. 3, to allow a user to input indicators for components, such as outputs, outcomes, or impacts, which have been previously created by, for example, the interface screen of FIG. 22. In an embodiment, each indicator is tied to a specific output 3215 (FIG. 32), outcome 3220 (FIG. 32), or impact 3225 (FIG. 32). A radio button bar 3505 allows a user to choose which of outputs, inputs, or impacts to view. The chosen component 3510 (outcomes, in the illustrated embodiment) is then displayed. A user can then choose one of the components to tie to a new indicator, using a variety of techniques known to those of skill in the art.

An indicator type 3515 can be chosen, indicating if the indicator will be chosen from a library or created ad-hoc. A measurement type 3522 may be declared. Sample measurement Types are List (a list of possible values), Numeric, Percentage, Dollars, and Text (implemented as a free text field, in some implementations.) Sample measurement types are: List (a list of possible values), Numeric, Percentage, Dollars, and Text (implemented as a free text field, in some implementations.)

A variety of indicator values can then be input, including a name 3502. A statement 3508 can also be provided, for example, as a free-text descriptor. This can be used to provide a brief description of the actual result. The statement 3508 can be required by the donor management system 118 (FIG. 1) if desired, or can be left to the client's discretion. If an indicator is selected from the library, then name 3502 and statement 3508 may be automatically pulled from the library.

Additionally, a baseline value 3520 can be included. This is the beginning value of the indicator. The target value 3522, (the desired value for this indicator) can also be specified, as well as various milestone values 3524, which are values that can be achieved by a certain date, which can also be entered, using a calendar, in an embodiment. These milestone values 3522 can be used to track how well a specific project is going, to keep donors appraised of the efficacy of their donations, and the like. In some embodiments, milestone dates must fall within dates associated with the corresponding result. In other embodiments, milestone dates should fall within dates associated with the corresponding IRP. Other embodiments choose different allowable date values for milestones. Reports may be generated based on the milestone values 3522 entered here.

The milestones 3522 can be defined by a date, a date and time, etc. Alerts 3540 can also be added. If a value (such as a milestone value 3522) falls below or above a value given for the alert, then than this information can be noted and used, for example, to determine which projects are doing the best or worst, which aspects of a project are failing or succeeding, and so forth. In an embodiment, when an alert belonging to a component is triggered by the indicator value falling outside the allowable range, an icon, such as one shown at 3610 (FIG. 36) appears overlaid on the component when viewed in one of the screens associated with the donor management system of FIG. 1.

### 33—Indicator Overview Screen

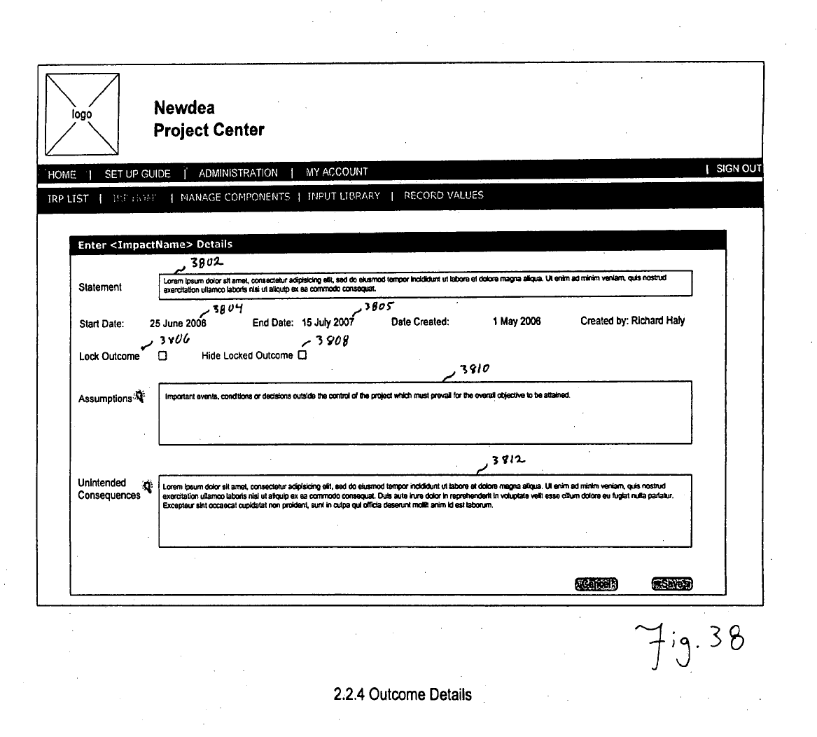

FIG. 36 is an interface screen produced by the donor management system of FIG. 1 that allows a user to view impacts previously created by, for example, the component creation screen of FIG. 22. When an impact is selected, such as the impact 3601, details about that impact can be displayed on a separate pane 3603. A hyperlink 3605 can be included which pulls up an input screen (such as the input screen show in FIG. 38) where more details about the impact 3601 can be viewed, and in some embodiments, edited.

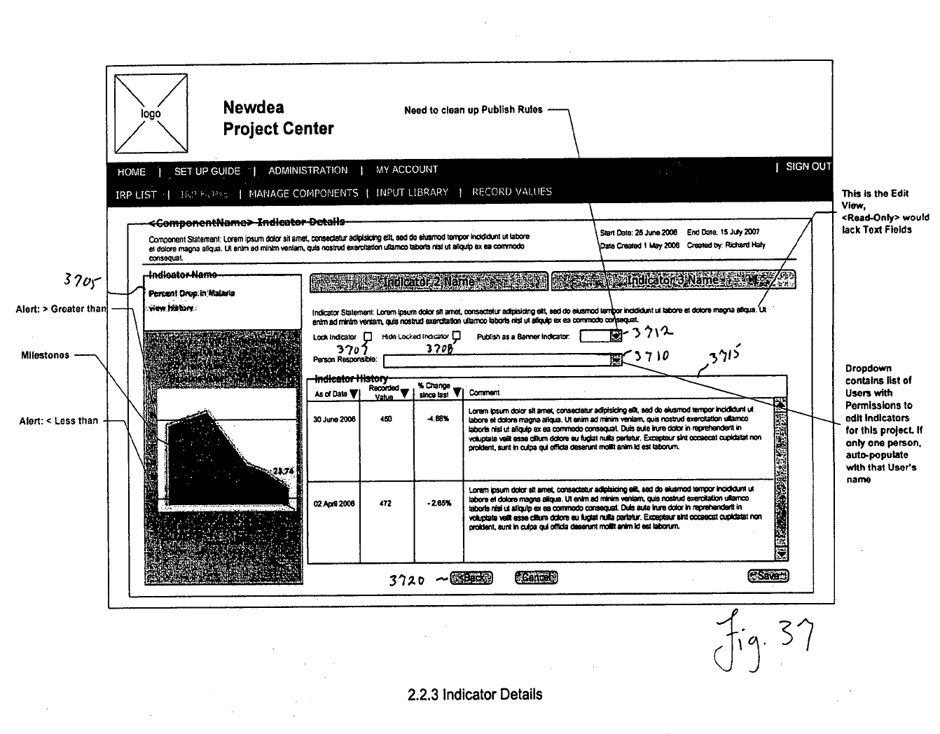

Indicators 3607 associated with this selected impact can also be viewed in this screen. Similarly, a button 3609 (in some embodiments, in other embodiments, a hyperlink, etc.) can bring up an indicator view screen, such as the indicator screen shown at FIG. 37. If a component has an alert whose value is outside of an allowed range, such as shown at 3540 (FIG. 35), then an alert notification can be displayed. This alert notification can be an alert icon 3610, as shown in the illustrated embodiment, or can be another method of notification. Components can be added by selecting an “add component” button 3615, which can bring up an add component interface screen such as the one shown at FIG. 22.

### 34—Indicator Overview Screen

FIG. 37 is an interface screen produced by the donor management system of FIG. 1 that allows a user to view indicators for a component, the indicator previously created by, for example, the indicator creation screen of FIG. 35. When a user selects an “indicator details” button, or a similar object associated with a component, such as shown at 3609 (FIG. 36) then the user can be taken to this screen that allows indicators for that component to be viewed. In an embodiment, a graph which charts the indicator data (such as baseline value 3520, target value 3522, milestones 3524, and alerts 3540, all of FIG. 35) is associated with the indicator. This graph may also be provided as a portion of a report, the report associated with the indicator, a result containing the indicator, and so on.

An indicator can be locked, which will not allow the values to be modified. This can be specified using a checkbox, such as the checkbox 3707. Furthermore, such indicators can be hidden, either from donors, or from those who do not have the proper permissions to view, for example. The hide function can be implemented using a checkbox 3708, as is seen in the illustrated embodiment, or using a different method.

A single person, or a group of people responsible for this indicator, can be noted at 3710. This person may be chosen from a dropdown list which contains the users with permission to edit indicators for this project. In an embodiment, if only one person has permission, the field is auto-populated with that name.

An indicator history 3715 can also be provided, which reveals, in the illustrated embodiment, the date an indicator was measured, the value recorded, the percentage change, and comments. In other embodiments, a different selection of data is chosen for the indicator history 3715. A method to view the other indicators, such as a back button 3720, is also provided, in some embodiments. In certain embodiments, this screen is available in a read-only mode, where none of the fields are editable.

### 35—Component Summary Screen to Edit Components

FIG. 38 is an alternate interface screen which can be produced by the donor management system of FIG. 1, to allow a user to input details about results (that is, outcomes, outputs, and/or impacts), such as those which have been previously created by, for example, the interface screen of FIG. 22. In an embodiment, a statement 3802, which may be implemented as a free text descriptor, can be used to briefly describe the outcome. In some embodiments the statement 3802 is required; in other implementations, optional.

Additionally, a time period, defined by a start date 3804 and/or end date 3805, can be input here. In other embodiments, the start and/or end date are input when the outcome is initially created, and are listed here, but cannot be changed. This outcome can be declared to be locked 3806, which indicates that the outcome values cannot be changed after input, in some implementations. In other implementations, locked outputs can be changed by those with appropriate authority. When a User locks an indicator, in some implementations, the user will have the option of hiding that indicator. indicators that are locked may display greyed-out with a “Locked” icon in their name tab in the component screen in the IRP Home, as shown, for example, with reference to FIG. 36.

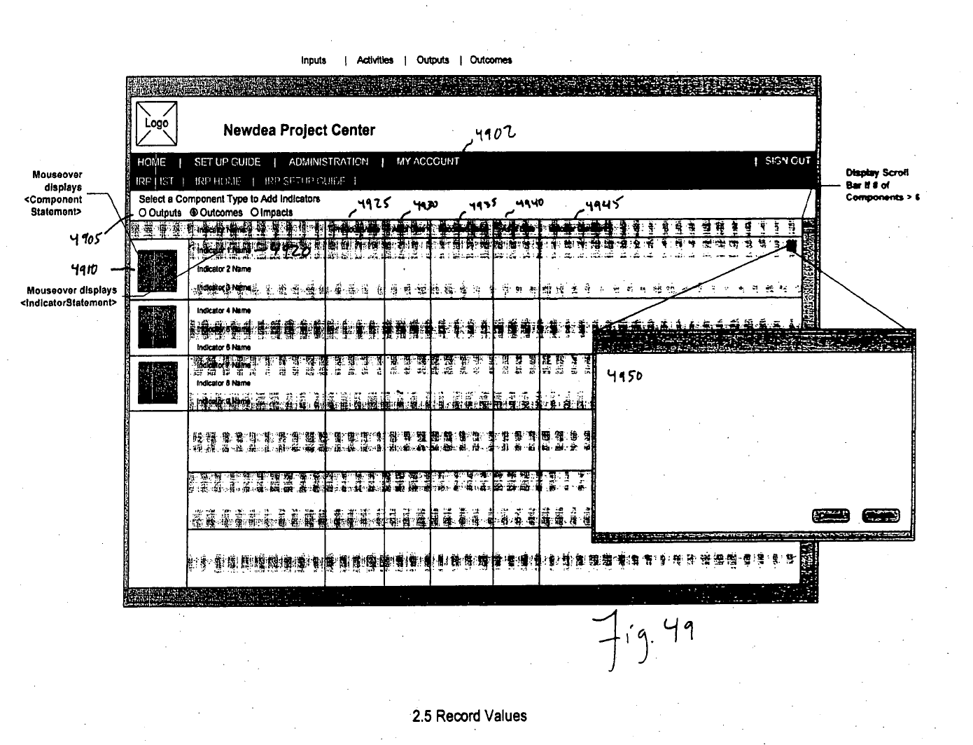

Locked Indicators may not display in a screen which allows users to record indicator values, such as the screen shown with reference to FIG. 49. Locked Indicators may have the same navigation (to Details, etc.) as unlocked Indicators. Indicators that are locked may not be edited, in some implementations, until the indicator is unlocked. In an embodiment, indicators that are “Locked” and/or “Hidden” may not display on the component screen on a home screen, such as the IRP home page, for example, shown on FIG. 24.

The outcome can also include an assumptions field 3810, implemented, for example, using a free text descriptor. This assumptions field 3810 can be used to state important events, conditions or decisions outside the control of the project which must (or should) prevail for the overall objective to be attained. This field, and a portion or all of the text fields described here, can be a fixed size, such as is shown at 3810, where only as much text as can be placed within a defined window can be placed, or a window with scroll bars can be provided, which allows much more text to be entered. Even windows with scroll bars have a limit on the amount of text that is allowed to be input, but some systems may allow the text fields to be very large.

An unintended consequences text field 3812 can also be included. Even the most well-meaning project may have consequences, both for good and ill, that were not intended by its creators. This field can be used to keep track of such consequences, which can then be used to modify this project or aid in the design of other similar projects.

Even though the illustrated embodiment is for an outcome, other components, such as outputs and/or impacts, can have similar screens used to create, view and/or modify the indicator.

### 36—Indicator Input Screens

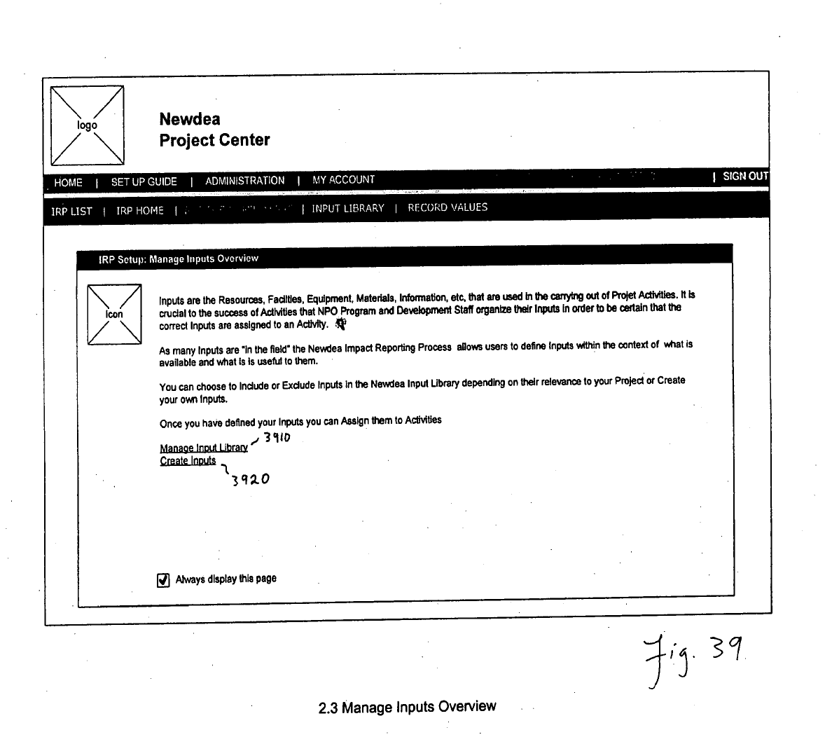

FIG. 39 is an interface screen which can be produced by the donor management system of FIG. 1, to provide an overview of the input setup process. Inputs are, for example, the Personnel, Facilities, Equipment, Materials, Partners, Budget, etc., that are employed in the carrying out of an activity. Inputs, generally, are assigned to an activity. This can be a many-many relationship, such that a single input may be assigned to multiple activities, and vice-versa. Some implementations restrict an input to assignation to one activity.

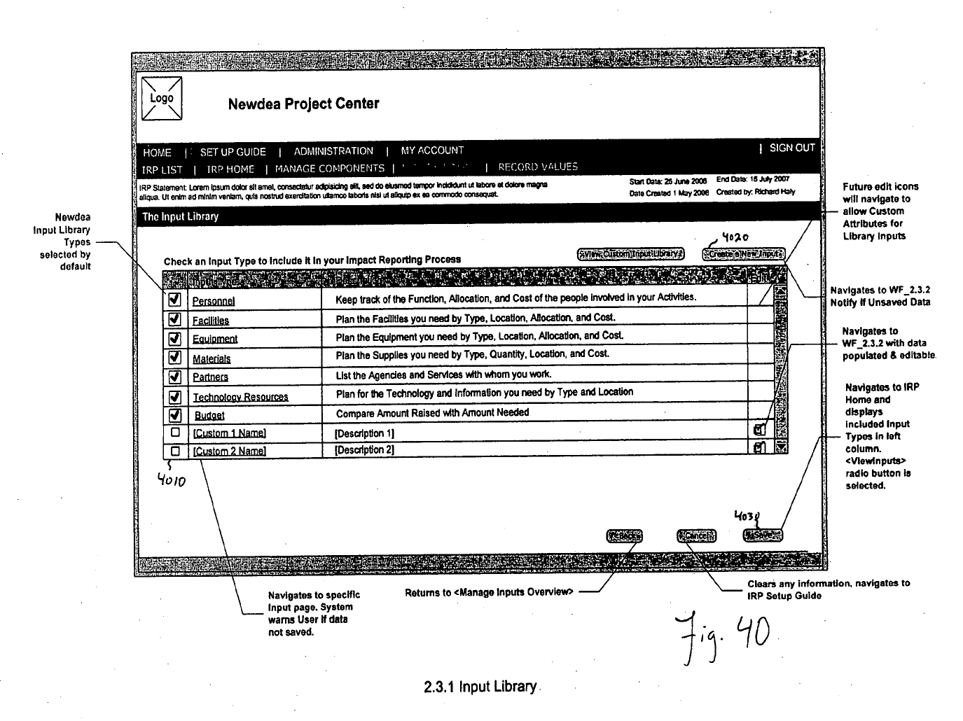

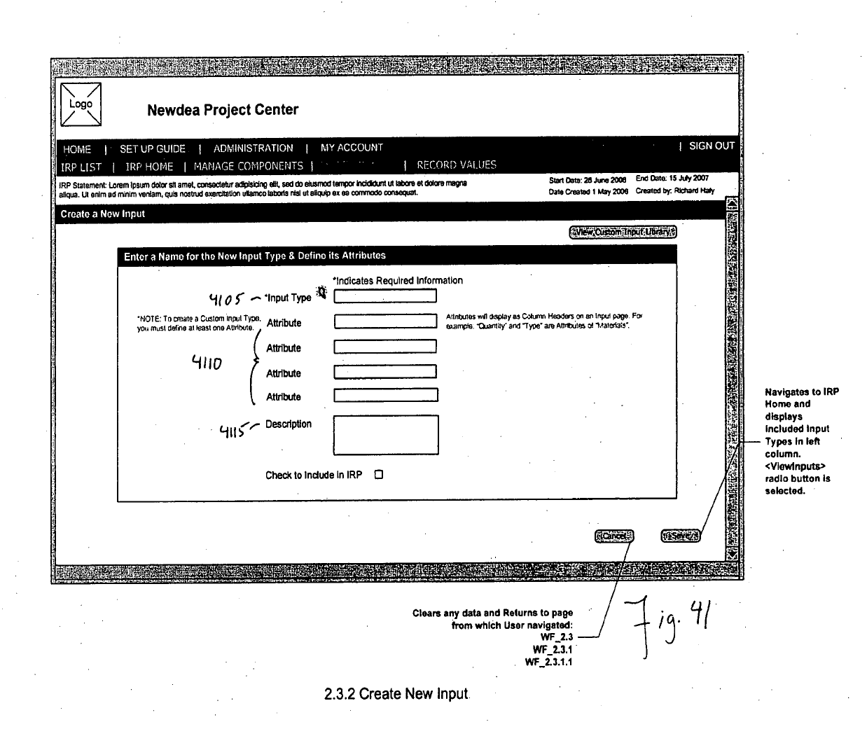

In some embodiments, a hyperlink 3910, (as shown in the illustrated embodiment), pulls up a screen which allows an input library to be managed, such as the input library management screen of FIG. 40. Another hyperlink 3920, can pull up a screen which allows inputs to be created, such as the input creation screen of FIG. 41.

FIG. 40 is an interface screen which can be produced by the donor management system of FIG. 3, as a starting place to create at least some of the inputs that may be used for an activity, an IRP, a project, etc. In an embodiment, some (or substantially all) library inputs available to a user are listed 4010, along with a brief description. In an embodiment, the following library inputs may be available: Personnel, Facilities, Equipment, Materials, Partners, and/or Budget, to name some options. Furthermore, a library may include both default library types and/or custom types.

A “create a new input” button 4020 may direct a user to a create input screen, such as the creation screen of FIG. 41. A “save” button (or hyperlink) 4030 can be used to save all information entered, and also, in some embodiments to return the user to a home page, such as the IRP home page shown with reference to FIG. 36.

### 37—Input Type Screen

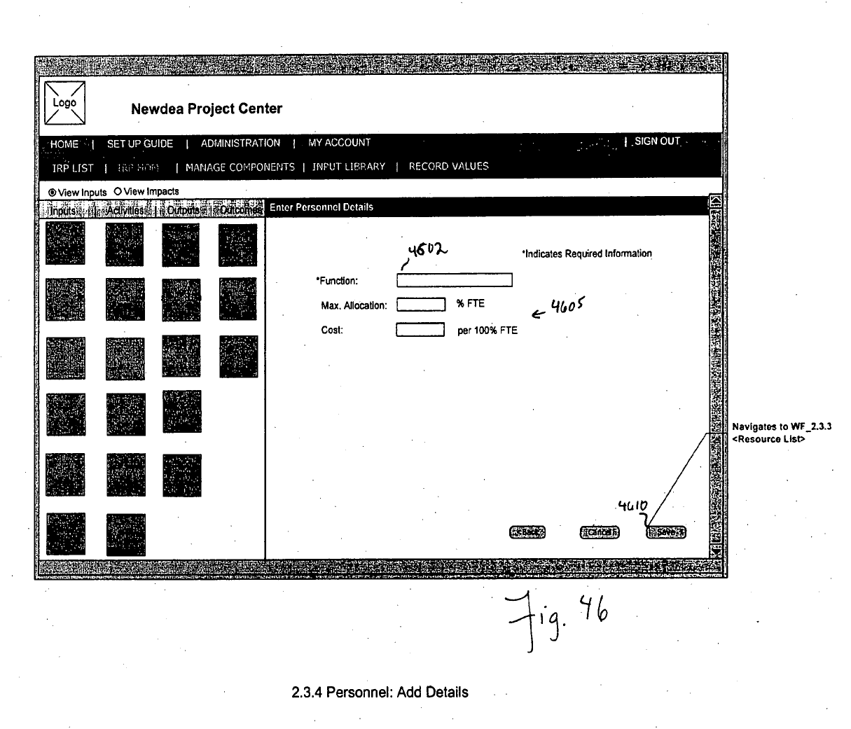

FIG. 41 is an interface screen which can be produced by the donor management system of FIG. 1, to allow a user to create input types which will be used, for example, by an IRP. At 4105, an input type name can be entered. At 4110, attributes for this input type can be entered. Each of these attributes can have data fields associated with them. The attribute names can be displayed as input fields on an input page, such as the enter record page shown with reference to FIG. 46. For example, the type “materials” may have the attributes “quantity” and “type.” In some embodiments, a minimum of one and a maximum of four attributes may be entered for an input type. A description field 4115 can optionally be included which can be used to provide more information about a specific input.

### 38—Input Entry Screens

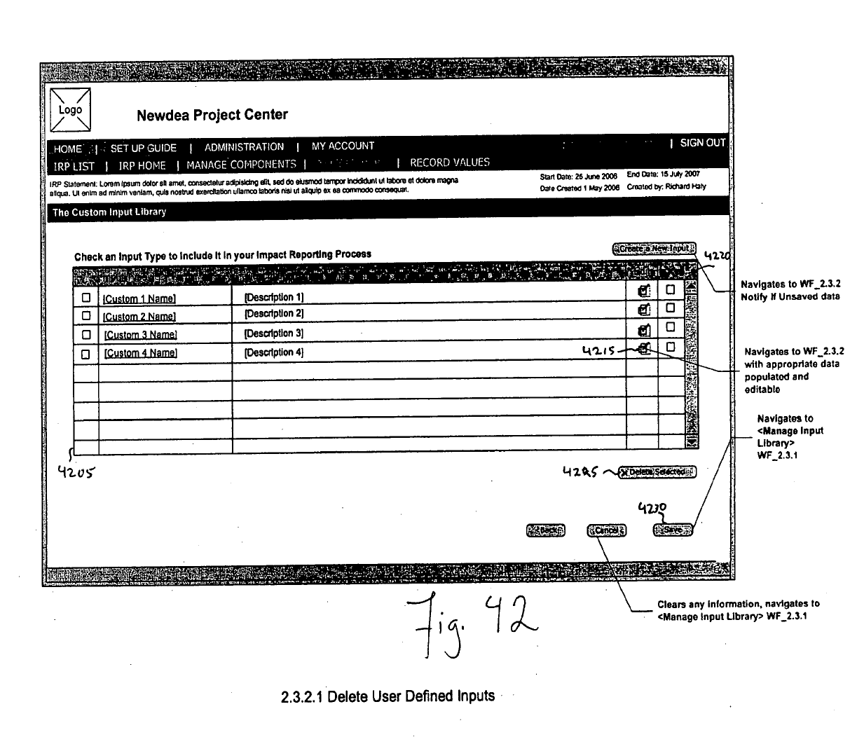

FIG. 42 is an interface screen which can be produced by the donor management system of FIG. 1, to allow a user to add custom input types. This screen can also be used to delete unwanted types. The user can select a custom input type 4205 that can be defined by a name and/or a description. Selecting a “Save” icon 4230, will then save that selected type, and direct the user, in some embodiments, to a library screen, such as the input screen shown at FIG. 40. Selecting the edit icon 4215 can direct the user to an input type screen, such as the input type screen shown with reference to FIG. 41, with any custom fields which have already been defined populated on the screen and editable. Selecting a check box in a deletion column 4220 and then selecting a “Delete Selected” button can cause the chosen input types to be deleted, in the illustrated embodiment. Other embodiments may implement selection and deletion differently.

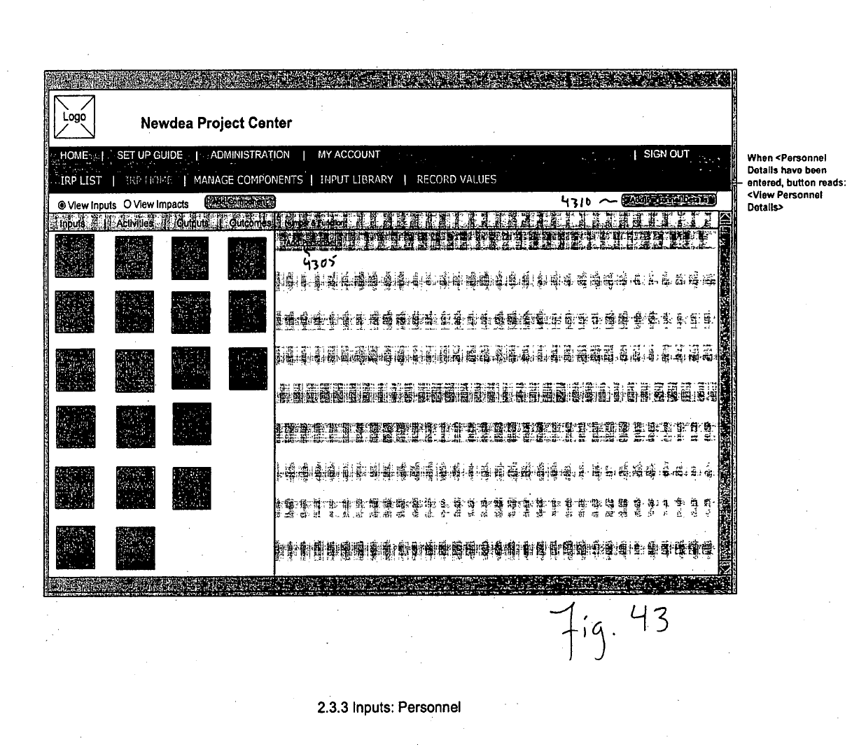

FIG. 43 is an interface screen which allows a user to access an input type, such as those selected by a user using input screen 44. In the illustrated embodiment, a “personnel” input type was previously selected by a user using, for example, input screen 40. A hyperlink 4305 “add <input type>” can be used to access an input screen (such as the input screen shown in FIG. 41) which can allow specific instances of the input type, in this case, “personnel” to be added. Details for the input type can be added, alternatively, using an “add <input type> button, such as the “Add Personnel Details” button 4310 shown in the illustrated embodiment. In the illustrated embodiment, two personnel types are added, “Staff”, and “Volunteers.”

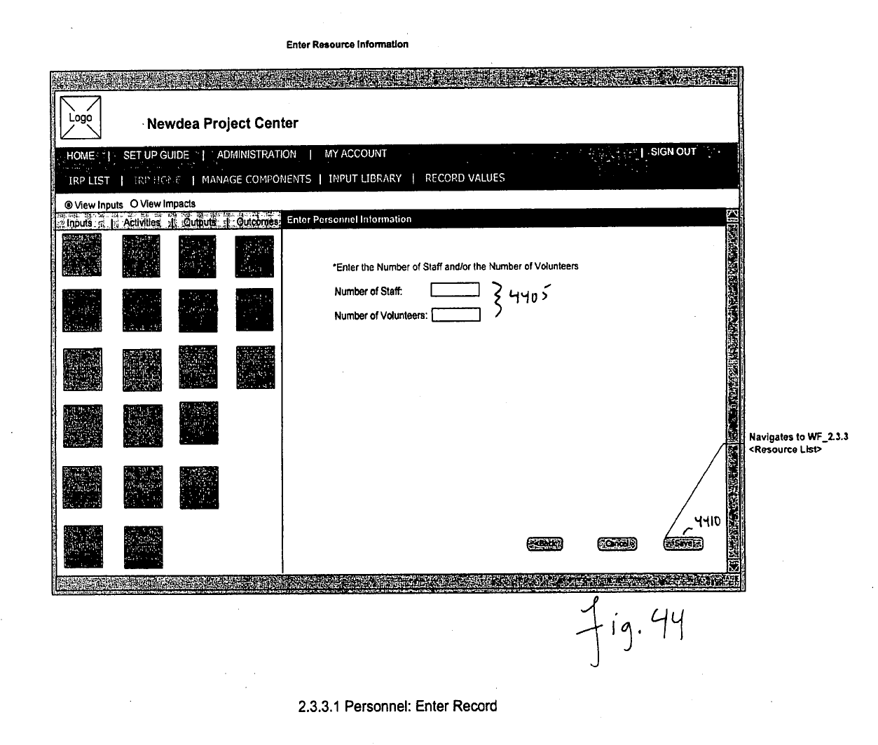

FIG. 44 is an interface screen which allows a user to input instances of an “input type” record previously added, for example, by the input screen of FIG. 44. In the illustrated embodiment, the number “22” has been in the “Number of staff” field, while the number 58 has been placed in the “Number of Volunteers” field. Once appropriate values are entered, selecting a “save” button 4310 (or a similar construct) displays an input screen, such as the input screen of FIG. 43.

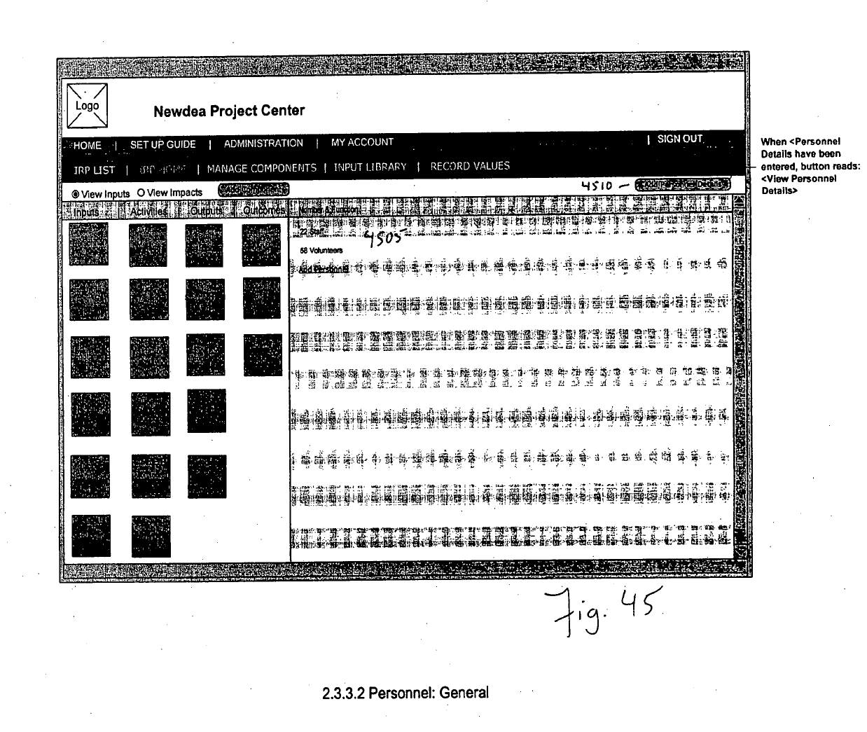

FIG. 45 is an interface screen which shows instances for a defined input type, such as the “Personnel” type which could be entered using the interface screen of FIG. 44. Field names and/or the values entered previously 4505, can be displayed on this interface screen. More details about the input type, such as “Personnel” can be accessed using for example, an “Add Personnel Details” button 4510, which can display a screen which allows more details to be entered, such as the “Enter Personnel Details” screen shown with reference to FIG. 46.

FIG. 46 is an interface screen which allows more input details to be entered. These details may be initially created at 4110 (FIG. 41), or they may previously be defined in a library. This input screen then displays such details for user entry. Some of the details, such as, for example, “Function” 4602, may be required. Others, such as, for example and not limitation, “Max Allocation” and “Cost” 4605 may be optional. A button, which may be a “save” button 4610, saves the information and, optionally, displays a summary input screen, such as the interface screen of FIG. 43.

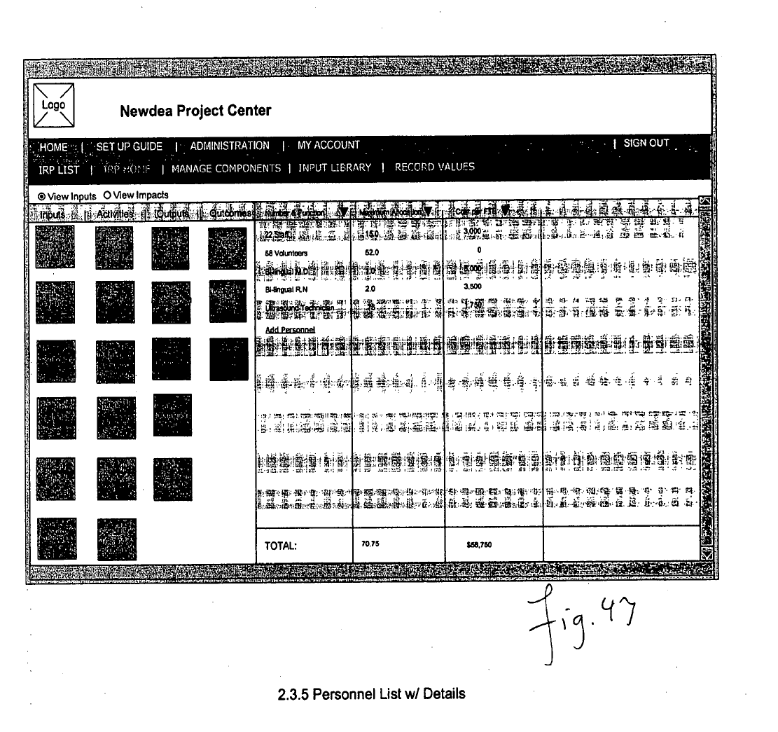

FIG. 47 is an interface screen produced by the donor management system of FIG. 3 allowing a user to view details of a personnel list comprising information about the personnel records input using the interface screens of FIG. 44 and FIG. 46.

### 39—Activity Program Entry Screens

FIG. 48 is an interface screen which can be produced by the donor management system of FIG. 1, to allow a user to add activity programs to a IRP. Activity programs allow activity groups to be themselves grouped. These activity programs can then be used to create reports which gather information about activities associated with each of the included activity groups.

In an embodiment, activity groups previously created 4805, such as the activity groups created using the input screen shown at FIG. 30 and at FIG. 31, are displayed on an input screen 4810. Activity group 4805 optionally includes a listing of the activities in the group 4820. In certain embodiments, view screens associated with the activities, such as the interface screen shown with reference to FIG. 28, can be accessed through hyperlinks (as shown in the illustrated embodiment) buttons, or other methods. The activity groups that are to be part of the activity program that is being defined can be selected, by using check boxes 4830, or by using a different method.

### 40—Indicator Value Entry Screen

FIG. 49 is an interface screen used for recording indicator values. Indicators, such as those created using the input screen of FIG. 35, can have values determined at different dates. Those values can be recorded here. This screen can be accessed by a user selecting the “Record Values” menu tab 4902. At 4905, a result, which may be one of outputs, outcomes, or impacts, can be selected. The selected component then has its defined members displayed 4910, along with the defined indicator(s) 4920 for that member. In some embodiments, the previous value 4925 and/or the as-of date 4930 for the indicator 4920 can be automatically listed by the donor management system 118 (FIG. 1). In other embodiments, the user can be responsible for entering those numbers. A new recorded value 4935, the date the value was recorded 4940, as well as any comments 4945 can all be added. In some embodiments, the comments field can be expanded 4950.

### 41—Summary Budget Screen

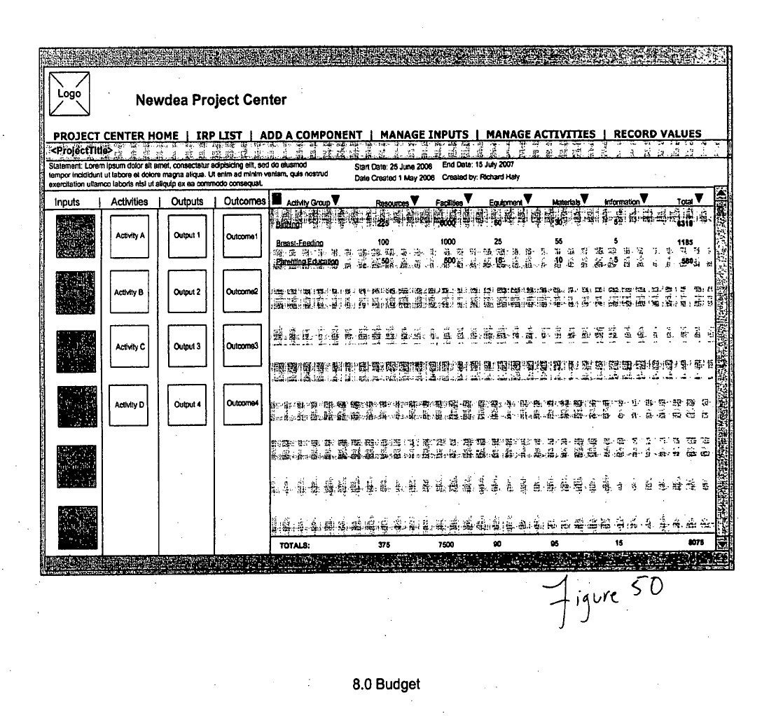

FIG. 50 is an interface summary screen which displays the inputs for a specific IRP grouped by activity group. This is just a sample of one of many summary screens that can be utilized to view or report data.

### 42—Output Screens

FIG. 51 is an interface screen which shows an alternate output entry screen, allowing connection of outputs to activities. At 5105 a name can be entered. This name (or a portion thereof) may be used as text on an icon to identify this output. At 5110, a start and/or an end date can be entered. A calendar may be provided to assist in entering the dates. At 5115, a statement associated with the output can be entered. This statement may appear when mousing over, or otherwise selecting, an icon which represents this output. At 5120, a program type can be selected.

Activities can be established prior to outputs, as outputs can be related to activities. At 5130, activities associated with this IRP (or program, or project, etc.) are listed. A user can check, or otherwise select the activities which will be associated with this output. These related outputs will then appear on associated activity screens, such as the one shown with reference to FIG. 25, where the related output “13 Pre-natal examinations per participant” 2550 is shown in relation to the activity “Medical Care.”

As indicators can be added to outputs, a “Save and Add an Indicator Set” option 5135 can be provided, which takes the user to an add indicator screen, such as the input screen shown at FIG. 35. In some embodiments, activities can be related to outputs by sending a user from an activity screen to this output screen, as is shown at 5130, with reference to FIG. 30.

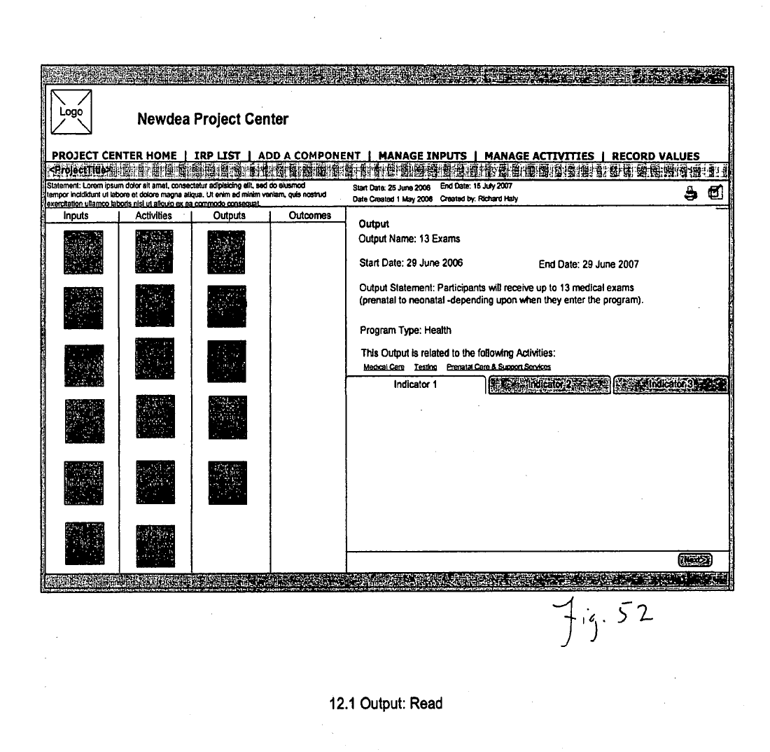

FIG. 52 is an interface screen which allows a user to view but not alter output information, such as the information input using screen FIG. 51.

### 43—Reports

Reports may be generated that provide detailed or summary views of any of the metrics disclosed herein, for example and not limitation, impacts, outcomes, outputs, activities, indicators, and/or inputs. Reports may also be generated using aggregations of any of the defined metrics, such as activity groups and/or activity programs. Other ad hoc aggregations, such as those that aggregate inputs, indicators, and the like may also be used to generate reports. Furthermore, statistics can be generated which are associated with those metrics associated with a particular organization, group, team, or project. Furthermore, organizational units can be grouped, to allow report to be associated with metrics associated with a predefined grouping of organizational units.

In particular implementations, the reports are able to compute totals from sub-metrics, such as activity groups, activity programs, and/or user-defined sub-metrics. In addition to reports based on one or more particular organizational units, reports may be generated based on other criteria, such as a particular project type, time period, metric, or metric component.

Reports may be generated based on donations. For example, a given donor may have linked a specific donation to a specific metric, such as an activity. A report for that donor may report on the donation, the activity, any results generated from that activity, milestones associated with the results, and so on. The activity may also be linked to specific inputs, which may also have report information generated. In some embodiments, a single donor report may include all associated activities 1905 (FIG. 19), inputs 1740 (FIG. 17), indicators 3205 (FIG. 32), and so on associated with the donor.

Reports based on alerts may also be generated. That is, for a given entity, (organization, project, donor, etc.) all projects, activities 1905, or so forth associated with active alerts 3540 (FIG. 35) may be generated. Reports may be generated that provide detailed or summary views of metrics associated with a particular organization, group, team, or project. In particular implementations, the reports are able to compute totals from sub-metrics, such as activities 1905, outputs 1910, outcomes 1915, or impacts 1920 (all of FIG. 19).

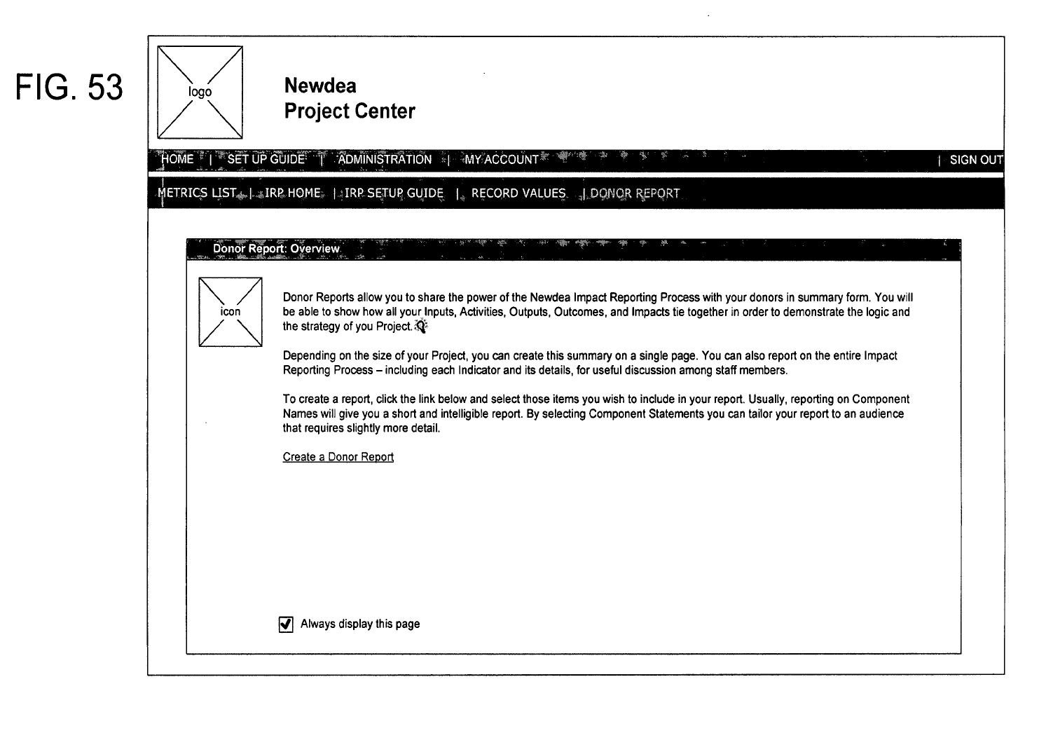

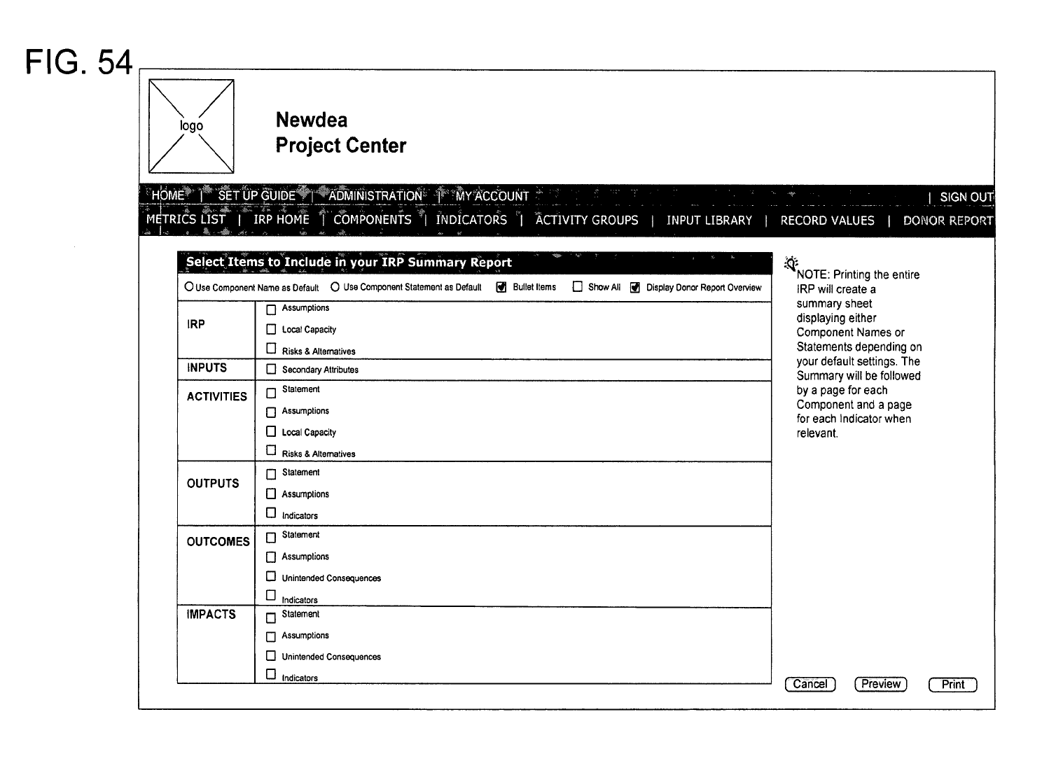

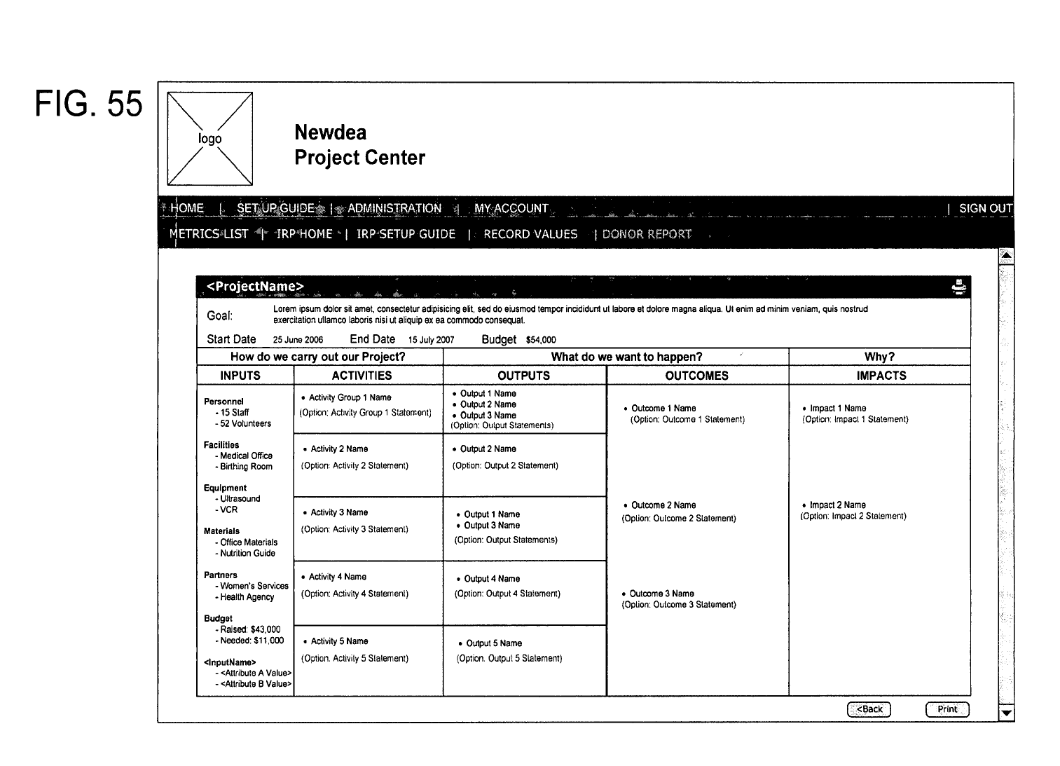

In addition to reports based on one or more particular organizational units, reports may be generated based on other criteria, such as a particular project type, time period, metric, or metric component and/or other trackable detail as described herein. For example, a report may be generated based on activity groups with alert indicators 3610 (FIG. 36), indicating that one or more indicator milestones 3540 (FIG. 35) are not being met. In an embodiment, FIGS. 53, 54, and 55 show input screens that can be used to generate reports used to report on metrics (measurements and/or values) associated with various aspects of projects and/or programs associated with a donor management system such as the donor management system 118 of FIG. 1.

It can thus be seen that the foregoing system may be used to provide donors or potential donors with enhanced ability to create, track, and/or report metrics, and components thereof. The disclosed systems may allow donors to track the effects of their donations and help the donor evaluate potential donees, among other benefits. The disclosed systems may allow charitable organizations to better track their operations, the results of which may be used to improve the operation of the organization and/or to attract increased donations, among other benefits.

### 44—Simple Indicators

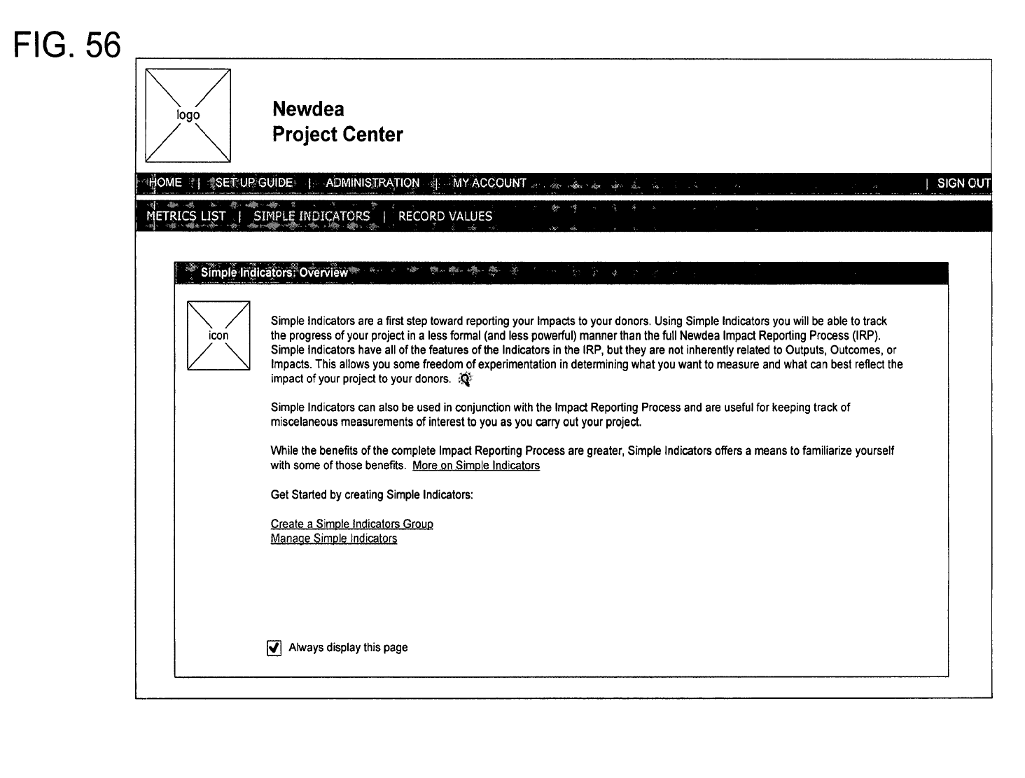

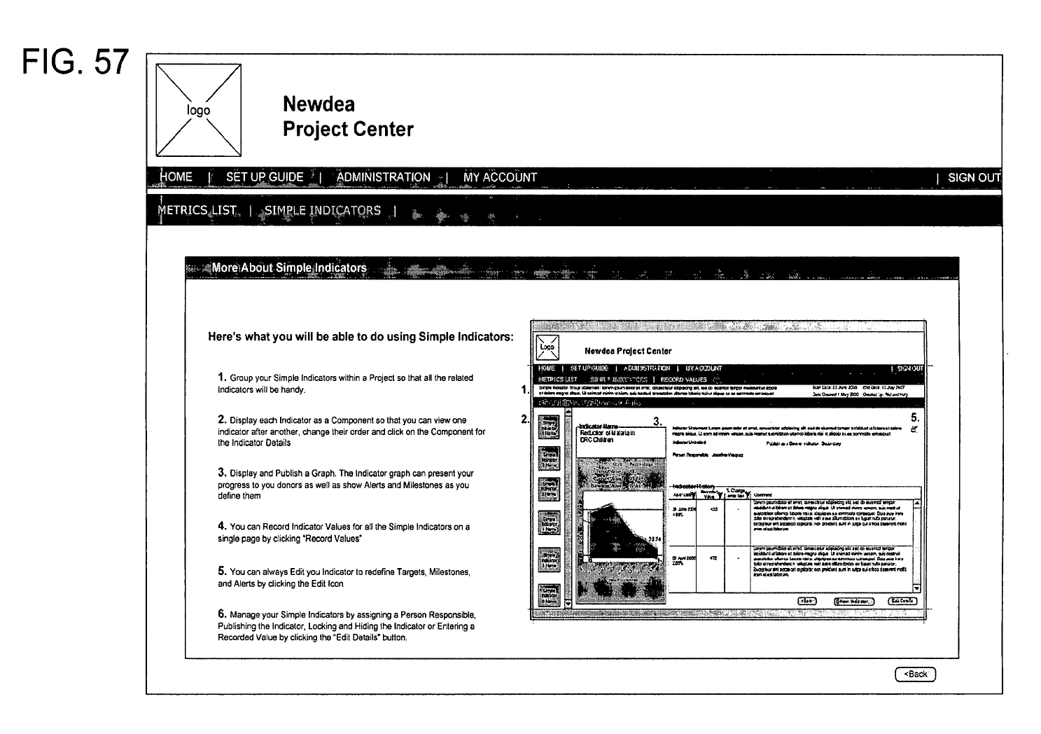

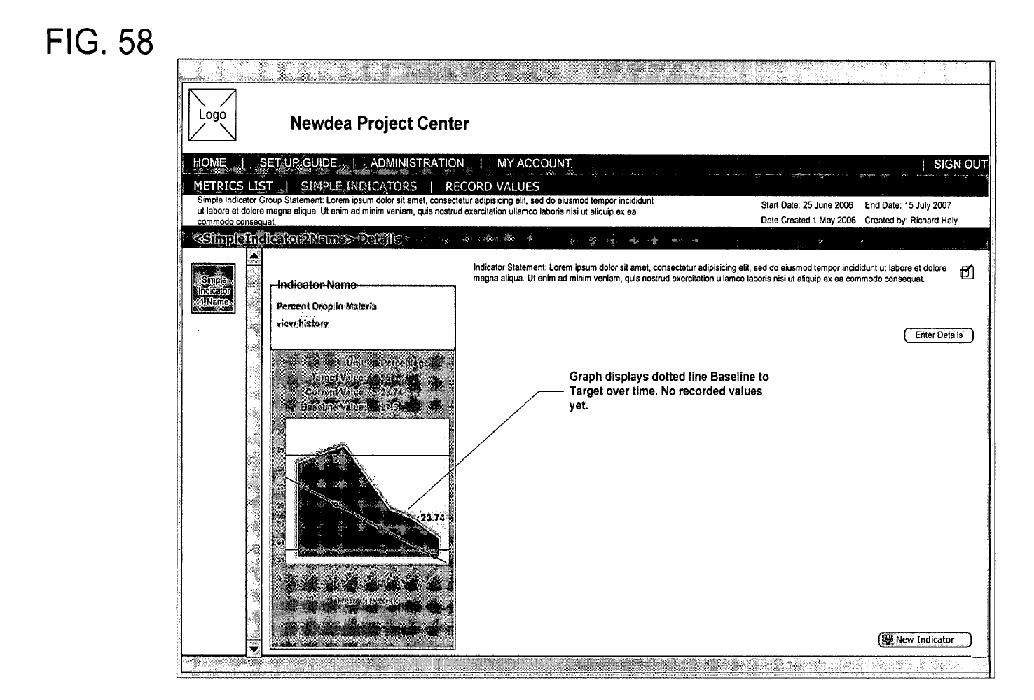

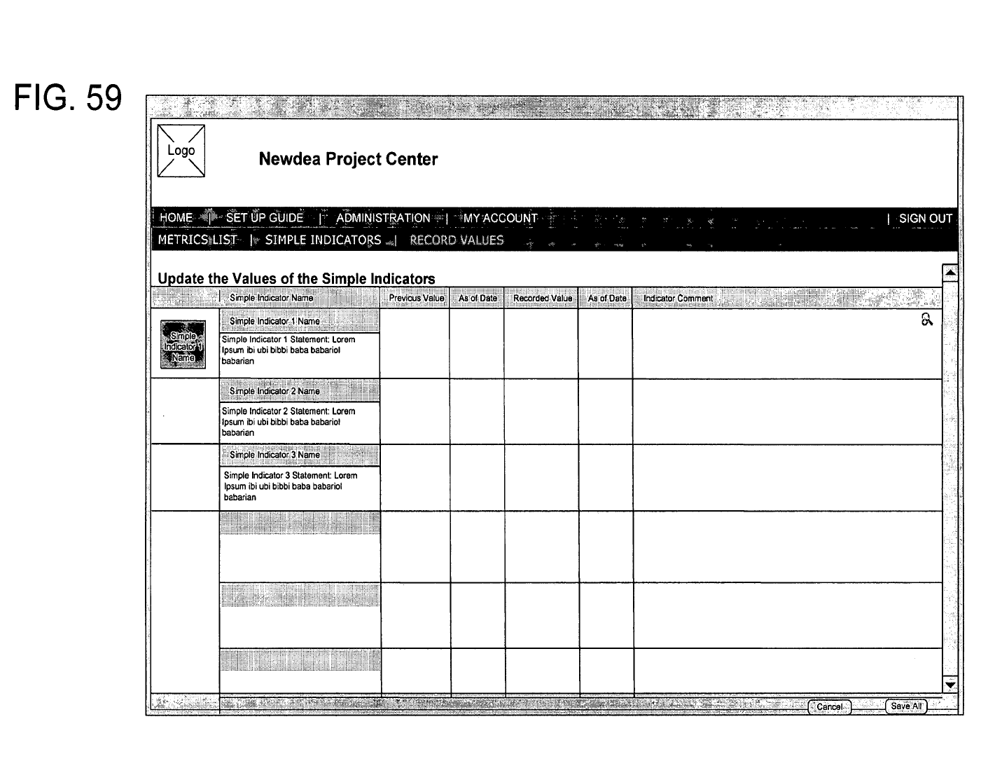

FIGS. 56 through 59 are input screens which assist users to set up, use, and/or report on simple indicators. An illustrated flowchart embodiment of simple indicators is illustrated in FIGS. 8 and 9. As indicated by the simple indicator 1622 (FIG. 16A) which is not connected to the other items, a simple indicator may not be connected to results 1619 (FIG. 16B) or other items associated with an IRP, for example. As such, simple indicators 1622 can be stand-alone metrics which have values entered for them, over time (in some instances) and/or which can have reports generated, can be accessed by interested parties, for example, over the interne, and so forth.

### 45—Alternate Embodiments

It is to be understood that the foregoing is a detailed description of preferred embodiments. Other embodiments will be apparent and yet fall within the scope of the invention. The scope of the invention is not to be limited thereby and is rather to be determined by the scope of the claims and equivalents.

1.-28. (canceled)

29. A computer-implemented method of providing status information related to a philanthropic activity performed by a philanthropic organization, the method comprising:
identifying a goal associated with the philanthropic organization;
identifying one or more activities that satisfy at least a portion of the goal;
compiling resources needed for completing the one or more activities;
providing the resources needed to potential donors;
receiving funds from donors based on the resources needed, the received funds directed at a specific activity of the one or more activities;
applying the received funds to the specific activity;
modifying the needs based in part on the received funds;
tracking the consumption of the received funds by the activity;
monitoring the status of the specific activity to create an activity metric;
monitoring the status of the goal to create a goal milestone;
providing the activity metric; and,
providing the goal milestone.

30. The method of claim 29, wherein the activity metric is calculated by comparing planned activities versus performed activities.

31. The method of claim 29, wherein the goal milestone is selected from the group consisting of: number of children vaccinated, number of people trained to serve as literacy instructors, number of communities able to access literacy materials, and number of literacy materials borrowed.

32. The method of claim 29, wherein the providing an activity metric is provided by a web server.

33. The method of claim 29 wherein the resources is selected from the group comprising of money, supplies, and personnel hours.

34. The method of claim 29, wherein the specific activity occurs in a specific geographic region.

35. The method of claim 29, wherein the resources needed comprise an organized list.

36. A computer storage device storing computer-executable instructions that when executed by a processor perform a method for providing project management information related to a philanthropic activity, the method comprising:
identifying a goal associated with the philanthropic organization;
identifying one or more activities that satisfy at least a portion of the goal;
compiling resources needed for completing the one or more activities;
providing the resources needed to potential donors;
receiving funds from donors based on the resources needed, the received funds directed at a specific activity of the one or more activities;
applying the received funds to the specific activity;
modifying the needs based in part on the received funds;
tracking the consumption of the received funds by the activity;
monitoring the status of the specific activity to create an activity metric;
monitoring the status of the goal to create a goal milestone;
providing the activity metric; and,
providing the goal milestone.

37. The computer storage device of claim 36, wherein the activity metric is calculated by comparing planned activities versus performed activities.

38. The computer storage device of claim 36, wherein the goal milestone is selected from the group consisting of: number of children vaccinated, number of people trained to serve as literacy instructors, number of communities able to access literacy materials, and number of literacy materials borrowed.

39. The computer storage device of claim 36, wherein the providing an activity metric is provided by a web server.

40. The computer storage device of claim 36, wherein the resources is selected from the group comprising of money, supplies, and personnel hours.

41. The computer storage device of claim 36, wherein the activity occurs in a specific geographic region.

42. The computer storage device of claim 36, wherein the resources needed comprise an organized list.

43. A computing system configured to execute a method, the method comprising:
identifying a goal associated with the philanthropic organization;
identifying one or more activities that satisfy at least a portion of the goal;
compiling resources needed for completing the one or more activities;
providing the resources needed to potential donors;
receiving funds from donors based on the resources needed, the received funds directed at a specific activity of the one or more activities;
applying the received funds to the specific activity;
modifying the needs based in part on the received funds;
tracking the consumption of the received funds by the activity;
monitoring the status of the specific activity to create an activity metric;
monitoring the status of the goal to create a goal milestone;
providing the activity metric; and,
providing the goal milestone.

44. The computer system of claim 43, wherein the activity metric is calculated by comparing planned activities versus performed activities.

45. The computer system of claim 43, wherein the goal milestone is selected from the group consisting of: number of children vaccinated, number of people trained to serve as literacy instructors, number of communities able to access literacy materials, and number of literacy materials borrowed.

46. The computer system of claim 43, wherein the providing an activity metric is provided by a web server.

47. The computer system of claim 43, wherein the resources is selected from the group comprising of money, supplies, and personnel hours.

48. The computer system of claim 43, wherein the activity occurs in a specific geographic region.
